(19) United States
(12) Patent Application Publication
(10) Pub. No.: US 2021/0142691 A1
(43) Pub. Date: May 13, 2021

(54) Standard Method and Apparatus for the Design Process of a Learning Experience Curriculum for Facilitating Learning

(71) Applicant: Heather L. Ferguson, Burlington, KY (US)

(72) Inventor: Heather L. Ferguson, Burlington, KY (US)

(21) Appl. No.: 17/095,733

(22) Filed: Nov. 11, 2020

Related U.S. Application Data
(60) Provisional application No. 62/934,383, filed on Nov. 12, 2019.

(51) Int. Cl. G09B 19/00; G09B 7/02; G09B 3/02

(52) U.S. Cl. CPC G09B 19/00; G06Q 50/20; G09B 3/02; G09B 7/02

(57) ABSTRACT

Standard method of a learning experience curriculum for facilitating learning wherein curriculum is designed executing against a design process ensuring consistency among content. Standard method includes the process of layering content by using systematic learning variations to support knowledge building, practical learning based on real-life issues or experiences where learners gain a skill to close their current knowledge gap employing the Learn/Practice/Assess Protocol in a fail-safe environment to reinforce learning, and adhering to the active/passive content ratio rule to achieve the threshold of learning experience. The apparatus includes learning resources to facilitate learning during the course and post-course devices for evaluation, as well as continued learning and development thereafter.

### CROSS-REFERENCE TO RELATED APPLICATIONS

62/934,383

### FEDERALLY SPONSORED RESEARCH

Not applicable

### SEQUENCE LISTING

Not applicable

### BACKGROUND

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CURRENT STATE OF THE ART

While there is no prior art directly on point or germane to the present claimed subject matter, the following disadvantages and shortcomings in current adult learning as well as learning and development programs have failed to meet the need of learners and the need for a solution remains. One or more needs remaining are solved according to an embodiment of the present claimed subject matter.

Adult learners attend learning or development courses for the purpose of learning how to do something for the first time or to learn to do it differently and better. People come into a training to learn, but they are unable to take the teaching received and convert it into a useful framework that can be implemented in their day-to-day lives post-session because they are acquiring sets of disconnected facts that do not enable them to learn with understanding. Educating or training of adult learners fails to drive behavioral change. Studies have shown a mere 10 percent of materials covered at training sessions are retained after only 30 days. Education and trainings of adult learners has been unsuccessful in producing more than short-term or minimal retention and fail to reduce or lessen a knowledge gap. Current flaws in the design, development, execution, and creation of content, concepts, and mechanisms in the education and training of adult learners fail to impart learning or improve a competence. Today in the market, learning or development courses are interchangeably called a training, course, session, class, event, or program; that implies it is a one-time event. Adult learners come to a training and it is a one-time session. Trainings are executed teaching a one size fits all solution to the subject problem area. Attendees come in, sit down, someone talks about a subject, maybe there are a few activities or role playing, and then the attendees are supposed to instinctively do something with that teaching. Trainings do a high-level covering of the subject matter without addressing real issues attendees experience; therefore, attendees leave without actionable solutions. There is a failure in the market to provide on-going tools and resources to adult learners that attendees can implement and utilize in addressing issues and working to achieve a real solution in their relevant environment post-course. I have found the human mind is not being given the tools that are needed to make decisions that will lead to success. People are getting information but are not being taught how to implement it. The limited core learning is insufficient because people learn by doing; systems currently available do not provide coaching and practice. Trainings fail to give people the opportunity to learn, practice, get comfortable so that when they return to their relevant environment employing or implementing the learning is natural. Education and trainings of adult learners that are irrelevant or in which attendees are unable to relate to are unsuccessful in increasing content knowledge. Trainings have failed to solve the problem or meet the need because attendees are not being given the tools with which to bring about meaningful change. Thus, the need remains unmet.

Companies invest upwards of $10 billion per year providing talent and leadership learning and development programs to their business leaders, management members, and talent in an attempt to overcome development deficiencies; however, the return on investment is miniscule. Training sessions people are attending are not set up to produce the outcome adult learners or businesses are wanting or needing. Learning and development trainings provide an understanding of what leadership is and then leave it up to attendees to know how to apply that knowledge to situations they encounter with no guidance as to how to do that. Short-term teaching quickly dissipates when attendees return to their work environments and are unable to implement the training they received to the situation they are faced with in the workplace. Thus, there is an unmet need.

Trainings currently available expect leaders to check their problems, issues, and concerns at the door to take a one-time training created for the masses that provides disjointed and irrelevant content, fails to address attendees' unmet needs, teaches about existing problems but fails to provide answers as to how to fix problems covered during the training session, fails to keep attendees engaged or motivated, fails to provide learning that can be readily implemented post-course, fails to provide learning materials and resources that can be utilized post-course as attendees need to put learning into practice, fails to increase retention; all without providing adequate time, content, and learning materials to facilitate learning. Thus, a need for a solution remains.

Some attempted solutions are teaching extraneous subject matter to the attendees. Content delivered to trainees are based upon scenarios that are not pertinent or applicable to the attendees' relevant or work environment; therefore, attendees spend the entire length of the training working on solving a problem that is unrelated and irrelevant to their business need. Learning resources, such as study guides, have been developed based upon that extraneous subject matter. I have found that content is lacking in relevant content areas and subject matter; therefore, fails to impart learning and development upon attendees. Trainings and study guides address a specific issue or business need. These study guides fail to address underlying cause or to suggest how to arrive at solutions. I have found these study guides fail to add value; therefore, attendees do not use them as a tool post-course. Thus, an unmet need remains.

Learning and development programs currently available in the market are not successful in reducing or lessening a knowledge gap, driving behavioral change, having a positive impact on the business, increasing content knowledge, developing or improving leadership skills, or increasing content knowledge on the part of the attendee utilizing the teaching received. The need for a solution remains.

Some attempted executional or tactical solutions employ algorithms and computer-based resolutions that make determinations based on data inputted, mathematics, and logic. A computer-based system may be able to do the routine and repetitive tactical and executional actions members of management have done for years. This increases the need for learning and development as managers are freed from executional duties and can devote more time to attaining and developing leadership skills to better meet the needs of their business. It is important to understand learning and development is needed to give businesses the tools necessary to develop their leaders, management members, and talent so problems do not arise. Learning and development deals with humans. Circumstances and emotions can come into play. Factors and considerations that influence the situation are not static. There are too many options for a computer-based system to be able to give a solution to a human problem that has infinite possibilities. Thus, this increases the need for a solution that will enable managers to be relevant and advance their careers into leadership roles that benefit the management member, his/her team, and the business as computer systems take over more of the tactical and executional duties.

Major talent development companies are delivering outmoded content. Content developed in the mid-1970s is outdated. Course content, training mechanisms, learning resources, and techniques are antiquated and irrelevant. Desperate for solutions, businesses are continuing to send employees, managers, and business leaders to outdated trainings that have failed to evolve. I have found this persists because there is a lack of competition in the marketplace. An alternative or better method has not been proposed. No one has challenged the existing inadequate method to date; therefore, the need remains unmet.

The Leadership & Organization Development Journal states, “[I]t seems that SLT addresses situations that are rare in organizations,” and concludes, “SLT could probably benefit from a revision which more accurately reflects the current leadership practices of organizations” (Thompson and Glaso, 2018). An earlier Situational leadership theory article written in the Leadership & Organization Development Journal states, “SLT has been tested several times and researchers have identified difficulties in terms of measurement, content, and research design (Thomas and Glaso, 2015; Thomas and Vecchio, 2009). Thus, the need remains unmet.

Some of the best known and most-widely used learning and development trainings utilize a contingency model. Leadership decisions are not as simple as this or that. In order for an attendee to be successful, the trainee must already have the skillset to know how to effectively lead. Therefore, the training fails to satisfy the need or to achieve what should be a course objective. Thus, the need remains unmet.

Tactical and situational leadership training focuses on a single specific area of leadership. A training that only addresses one problem area at a time is segmented, disjointed, expensive, and time consuming. Just to address the basic learning and development needs would take upwards of ten separate training sessions. I have found these fragmentary and deficient methods fail to adequately address the needs of the industry. The teaching imparted does not suggest how to achieve or reach a goal. Thus, the need remains unmet.

“The micro-skills of directive behaviors (e.g. goal setting, showing and telling how, defining methods of evaluation and defining roles) and supportive behaviors (e.g. listening, facilitating problem-solving, building rationale for decisions and asking for input) are often underemphasized in management or leadership training” (Drea Zigarmi and Taylor Peyton, 2017). Assumption is often made that leaders know how to implement the learning covered; as a result, teaching how to implement learning is lacking or nonexistent. This, the need for a solution remains.

Adult learning as well as learning and development for talent, members of management, and leadership fails to impart lasting knowledge or skills that develop people into leaders; therefore, it fails to meet the need. Further, it fails to translate knowledge sharing into driving behavioral change. I have found short-term information sharing does not result in long-term learning that develops talent and future business leaders. It does not develop or improve leadership skills, nor have an impact on the business. Thus, a need remains. A solution is needed in order for organizations to be successful in achieving their long-term goals for growth and sustainability.

### PRIOR ART

Drea Zigarmi, Taylor Peyton, (2017) “A test of three basic assumptions of the Situational Leadership II model and their implications for HRD practitioners,” European Journal of Training and Development, Vol. 41, Iss. 3, pp. 241-260
Geir Thompson, Lars Glaso, (2018) “Situational leadership theory: a test from a leader-follower congruence approach,” Leadership & Organization Development Journal, https://doi.org/10.1108/LODJ-01-2018-0050
Geir Thomson, Lars Glaso, (2015) “Situational leadership theory: a test from three perspectives,” Leadership & Organization Development Journal, Vol. 36 Iss. 5, pp. 527-544

### ADVANCEMENT IN THE ART

A novel process of layering content utilizing a Learn/Practice/Assess Protocol is being presented in the subject disclosure is a method for facilitating learning within an educational or adult learning environment. Layering content is the process of adding depth to a topic by using a systematic method of creating and implementing learning variations to support knowledge building. The curriculum is designed in a way to act as building blocks of knowledge. Learners understand, comprehend, and learn a concept or relevant content before building knowledge upon the next concept or relevant content as they progress through the course via a plurality of mechanisms. Layering on content dissects content or information so it is absorbable for people. In order for a concept to be digestible by learners, the course layers the content so a learner's knowledge builds progressively over the duration of the course. Presenting vital core concepts or content layered on within a curriculum, followed by a learner participating in an action, activity, or practical learning facilitates learning and knowledge transfer by enabling students to learn with understanding. Learners acquire knowledge based on connected facts and skills as learning builds through the layering content process. Once learners understand and comprehend that portion of content, the next block or piece of layered content is presented. The next block of layered content builds upon the new knowledge attained in the previous block or blocks of layered content. Taking small blocks of key learning in, followed by reinforcing the learning facilitates participants becoming more confident. Once confidence in themselves builds, their personal interaction increases. This occurs during the practice and assess portions of the Learn/Practice/Assess Protocol. Layering content occurs throughout a learning experience curriculum to facilitate learning. Layering content is interspersed among content and a plurality of learning resources, including educational tools. Each time layered content is presented, an action or practical learning occurs, which enhances learning and increases retention. As content and knowledge layers, learners become more confident. Layering content is the foundation upon which an educational curriculum or learning experience curriculum is built.

Another novel design process of a learning experience curriculum for facilitating learning is being presented in the subject disclosure is a method and system of a design process from initial design to implementation that provides a foundation upon which to build phases that culminate into a learning experience curriculum for facilitating learning. Phases include design, development, delivery or execution, and creation. The design process provides a methodical way of executing the curriculum and learning resources that support a desired outcome and ensures the learning curriculum achieves course objectives. Following a consistent framework enables the curriculum, learning resources, and educational tools to have a coordinated flow. A unified design process is beneficial, especially for a learning experience curriculum, as the methodology within a learning experience curriculum encompasses theoretical learning but relies more heavily on practical learning. Practical learning is a major part of the learning experience curriculum, which facilitates learning, increases retention, and enables learners to implement learning post-course in their relevant environment. The standard method/process within the design process is crucial to a well-defined curriculum and ensures consistency among content and learning resources. Dissecting learning content by chunking, layering, and segmenting enhances understanding and comprehension by making the learning content and concepts absorbable to a learner. Passive content provides key content and concepts. Developing active content engages learners in their personal learning. Creating beneficial learning resources utilizing a learning experience curriculum design process is conducive to a quality overall learning experience. There is flow and consistency, which enhances learning, knowledge transfer and retention of key learning. The design process enables a learner's understanding, comprehension, and knowledge to build progressively throughout the duration of the course, thereafter extending into continued development post-course. Developing the course per the design process ensures key topics and content facilitates active learning, a learning experience, and an interactive learning experience.

Another novel learning experience curriculum for facilitating learning is being presented in the subject disclosure is a method of educating or training. A learning experience curriculum is a method and system of coaching individual learners to achieve self-determined goals by practical learning of course content in a fail-safe learning environment. Practical learning supplements knowledge building with an activity engaging a learner in his/her own individual learning. The learning experience curriculum adheres to the novel Learn/Practice/Assess Protocol and layers on content. Within the course, active learning advances to a learning experience brought about by increased active learning. The active/passive content ratio ensures active learning occurs throughout the course and validates or confirms the curriculum achieves the threshold of learning experience. Coaching learners to address issues each personally faces in their relevant environment based on curriculum learning enables each learner to develop or discover a resolution based on an educated decision. A learner is able to put his/her theory as to the utilization and implementation of new knowledge into practice, creating solutions to issues or considerations each currently experiences as each builds vital skills with confidence. Learners assessing the outcome or result of their new skills, whether personally assessed or done in collaboration with others, reinforces key learning. Practicing tools specially developed for use post-course in the fail-safe learning environment of the educational setting instill confidence in learners' abilities to implement and apply those tools in their relevant environment post-course. A learning experience is meaningful.

Another novel learning experience is being presented in the subject disclosure is the process and materials presented utilizing the Learn/Practice/Assess Protocol. A learning experience dissects the information in a way that lets the learner absorb it so they understand, but then provides learners the requisite time to practice the skill just learned. So that it becomes comprehendible or second nature. To ensure the curriculum adequately addresses current practices, learners each provide a relevant scenario based upon their actual work environment or other relevant environment upon which to practice new learning in a knowledge-centered environment that facilitates learners reflecting on their own personal learning process with an awareness and understanding of one's own thought process. Learners actively participate in their personal learning, leading to further development. Participants learn a concept or content, they practice recognizing it, analyzing it, using it, and then assess their theories or determinations in a fail-safe learning environment.

Learners come into a course-specific learning environment with problems, issues, and concerns searching for solutions. This learning experience curriculum promotes key learnings by educators facilitating a transfer of knowledge that leads learners into becoming participants actively engaging in discovering their own personal solutions so they each can implement similar actions and skills upon returning to their actual work environment or relevant environment. By the time the course concludes, learners not only know the content needed to know, but have had the opportunity to try it. So that when faced with the same or a similar situation post-course back in the real-life environment, they know what needs to be done and how to handle it. Practical learning within a learning experience is executed in a way that lets people learn, practice, get comfortable so that it is easy for them to implement what they've learned because they have had the opportunity to practice this new skillset. Best practices in facilitating learning is embracing and utilizing learners' real-life experiences is the criteria upon which knowledge is applied. Participants will learn through a series of exercises or simulations that are based on real people in their organizations today. Practical learning ensures learners comprehend the new learning received throughout the course.

Another novel learning experience is being presented in the subject disclosure is learning and development. Learning occurs during the learning experience curriculum; development happens over time, beginning during the course and continuing after learners are back in their relevant or work environment. The “experience” during a learning experience curriculum provides relevant tools that enable learners to continue their development post-course. Specially designed course-specific templates that learners practice during the course are provided for their continued utilization post-course. A download link is provided to aid in easy access to templates.

Another novel learning experience is being presented in the subject disclosure is participants learn what his/her problem is, how to fix it, and have a plan to execute it. Learners exit the learning experience with a solution to a problem(s) or consideration armed with a plan to drive change. Learners come into a training with problems; however, often what is perceived as the problem is an outward symptom. Only getting to the root cause will resolve the symptom. Once we've walked through each concept independently, learners have identified what the problem is each is currently experiencing. They practiced how to solve it. They have instructions for how to execute post-course. Learners are walking out with actionable solutions to a real issue or problem. Content and learning resources are relevant.

Another novel learning experience is participants exit the course with action plans that can be immediately executed. This cumbersome task is broken into absorbable pieces by layering content so that each small piece of new learning gathers to form the whole, which is a complete action plan ready for implementation post-course in each learner's relevant environment. Executing on the deliverables in a learning experience curriculum for facilitating learning enable participants to progress further because each will have a firm foundation to continue to build and grow.

Another novel system and method of a practical learning card game for facilitating or enhancing learning is being presented in the subject disclosure. Participants learn by doing. A practical learning card game compliments and enhances learning.

Despite developments to date, a significant need exists for systems and methods for creating relevant content, learning resources, and processes that are systematic, exhibit a coordinated flow among content and learning resources, facilitate learning, promote continued development post-course in the learner's relevant environment, address and provide learning on issues and concerns learners currently experience, provide adequate practical learning, layers content, employ a Learn/practice/assess Protocol, meet the unmet needs, or validate active learning and learning experience using data and analytics for confirmation. The need remains unmet.

Thus, it would be an advancement in the art to develop systems and methods for development of pertinent educational curriculum, learning resources, and processes that are systematic, methodical, and relevant; that imparts a learning experience; that addresses core content and concepts necessary to comprehend further learning; that students learn by observing and doing with germane subject matter and educational tools; that provides a self-determined solution applicable for each individual participant; that has curriculum that is mandatory, but can be readily adapted to meet the need of learners; that develops the individual learner's knowledge and gives him/her the necessary tools to apply that knowledge in the work environment or relevant environment; and that is delivered by an educator as a facilitator in a group setting that provides a fail-safe learning environment in which learners can find a solution applicable for each individual participant; that provides a design process; that utilizes the Learn/Practice/Assess Protocol; the employs a course-specific evaluation for validating and analyzing content, educator, and outcome; that uses learning resources, including a practical learning card game to facilitate learning; and that utilizes the layering on content process as its foundation.

### SUMMARY

The following presents a simplified summary in order to provide a basic understanding of one or more aspects. This summary is not an extensive overview of the embodiments. It is not intended to identify key or critical elements or to delineate the scope of one or more aspects. The following summary merely presents one or more concepts in a simplified form as a prelude to the more detailed description provided below.

To overcome limitations in the prior art described above, and to overcome other limitations that will be apparent upon reading and understanding the present specification, the present one or more aspects is directed to systems and methods of a layering on content process of a learning experience curriculum for facilitating learning that can achieve one or more of facilitating learning or providing a learning experience. This disclosure also further generally describes novel systems and methods of a Learn/Practice/Assess Protocol.

According to one or more aspects of the present subject matter, this disclosure generally describes novel systems and methods for a design process of a learning experience curriculum for facilitating learning for learners and educators that can achieve course objectives.

According to one or more aspects of the present subject matter the design process of a learning experience curriculum can be implemented utilizing a one or more phases, in whole or in part, that can include a design phase, development phase, execution phase, or creation phase. This disclosure generally describes novel systems and methods for a design phase within the design process that defines scope and designs course including standard method/process considerations or elements and course specific or other classifications. This disclosure generally describes novel systems and methods for a development phase within the design process that includes active content and passive content in a section and chunking, layering, segmenting, drafting and editing in a section. This disclosure generally describes novel systems and methods for an execution or delivery phase within the design process that determines content, content type, and delivery modes that include learn, practice, assess. This disclosure further generally describes novel systems and methods for a creation phase within the design process that outlines processes, steps, and actions including defining course, educational tools, multimedia tools, and agenda.

According to one or more aspects of the present subject matter is directed to systems and methods for a design process of a learning experience curriculum for facilitating learning within learning resources, games, and activities that can be used independently or in conjunction with other curriculum or learning resources to provide a learning experience or facilitate learning.

According to one or more aspects is directed to systems and methods for a design process of a learning experience curriculum course evaluation.

According to one or more aspects is directed to systems and methods for one or more of designing, developing, delivering, or creating an educational curriculum within a learning resource, educational tools, primary educational tool, participant workbook, or participant learning experience workbook that can be used in conjunction with other educational course content and learning resources to provide a learning experience or facilitate learning.

Thus, from the description above, a number of advantages of one or more aspects of my method and apparatus for a design process of a learning experience curriculum for facilitating learning become evident:

Accordingly, it is a primary object of the present subject matter is to provide a layering content process that allows for a complex subject matter to be simplified by providing digestible portions of learning content for learning purposes into absorbable learning.

Another object of the present subject matter is to provide a learning experience, providing a user-friendly learning experience that imparts small pieces of knowledge and information on the subject at hand, breaking down each piece that makes up the whole, building on each piece until learners has the resources to use upon return to the work environment, followed by one or more activities to enhance learning, followed by an activity wherein each participant apply knowledge learned into his/her work environment verifying comprehension and application of the subject content area.

Participants come into a course specific learning environment with problems, issues, and concerns searching for solutions. The learning experience curriculum promotes key leanings by educators facilitating a transfer of knowledge that leads participants to discovering their own solutions so they can implement similar actions upon returning to their actual work environment. Content and concepts are presented facilitating learning. Through a transfer of knowledge and key learning presented within the curriculum they formulate real solutions to their own issues. Participants then choose their own applicable workplace situation or other relevant consideration to apply the key leanings. There are no right or wrong answers. This is a curriculum full of self-assessment and self-discovery. After applying their real-life scenario based on authentic employees in their actual work environment at their real workplace to the subject at hand during the practice mode, participants get to assess what they have done and how they have done it to decide if they have implemented a solution that meets or exceeds their needs. Learning continues and is always followed with practice and assess before moving to the next key topic or content. Participants bring in their own personal work issues and leave with real solutions.

Another object of an embodiment is to provide a design process that serve as the framework consistently employed throughout all aspects of an educational course that results in a consistent, unified learning product that is beneficial for participants. This can facilitate enhanced learning.

Another object of an embodiment is enabling participants to learn through the experience of practicing, collaboration, trial and error, making mistakes, and working through real-life simulations based on curriculum learning in a fail-safe environment that drives behavioral change and leads to a successful personal and business outcome. Educators verify participants accurately receive and process the knowledge being shared by coaching, mentoring, and validation. Coaching and direction assist participants along their journey of personal discovery as they put their personal leadership style, skillset, and work environment under a microscope.

Another object of an embodiment is methodology of training that is based on real-life experiences. Participants will learn a concept and build upon the concept as they progress through the course via a plurality of mechanisms. Participants will learn through a series of exercises or simulations that are based on real people in their organization today.

Another object of an embodiment is imparting learning that leads to development that will have a measurable outcome and positive impact. Learners are challenged to take balanced risks and to utilize every tool in their curriculum learning arsenal to develop themselves or their talent. Knowledge sharing becomes knowledge transfer that leads to learners becoming empowered as they gain confidence in their learning and capability.

Another object of an embodiment through utilization of the design process enables a learner's knowledge, understanding, and comprehension to build progressively throughout the duration of the course and can extend into a learner's development that continues post-course. Participants learn a concept or content, really know it, build on it, all before going to the next.

Another object of an embodiment is to provide a consistent and systematic methodology throughout the course that may serve to motivate participants to adopt a similar approach in developing their talent within their work environment.

Another object of an embodiment is to provide a learning experience curriculum for facilitating learning that is relevant, coordinated, consistent. Following the design process will ensure focused content delivery that will meet the required objectives necessary to reduce a knowledge gap or increase content knowledge. A learning experience curriculum embraces the knowledge that a course doesn't have to have the answer for every participant and welcomes its role providing key learning and learning resources that will empower participants each to discover their own answers or solutions based on the curriculum learning. Practical learning enables participants to learn with understanding in a fail-safe knowledge centered environment that encourages each learner to reflect on his/her personal learning progress. The layering content process, Learn/Practice/Assess Protocol, design process, course evaluation, and Practical Learning card game each find a solution for currently unmet needs. Each can independently standalone and adds value; however, together they culminate into a unified set of tools that provide the foundation for a superior learning curriculum.

Another object of an embodiment is to provide the system and process to provide a set of educational playing cards as a learning resource to facilitate learning. Adhering to the Learn/Practice/Assess Protocol engages a learner in achieving a meaningful self-determined understanding and awareness of the subject of the practical learning card game. The practical learning card game provides active content to build learning on by layering content. Another object of an embodiment provides a method of manufacturing a set of educational game cards.

Another object of an embodiment is to provide a course evaluation that enables constant evaluation of curriculum results against course objectives. The course evaluation can provide justification or clarity as to future initiatives and current success of the educational curriculum being evaluated. This data gathering tool enables curriculum adjustments if needed and enables educators to make adjustments in the way they deliver the court content.

### BRIEF DESCRIPTION OF THE DRAWINGS

The following figures form part of the present specification and are included to further demonstrate certain aspects of the present claimed subject matter, and should not be used to limit or define the present claimed subject matter. In the drawings, closely related figures have the same number but different alphabetic suffixes. The present claimed subject matter and the advantages thereof may be acquired and better understood by reference to one or more of these drawings in combination with the description of embodiments presented herein. Consequently, a more complete understanding of the present subject matter, further features, and advantages thereof may be acquired by referring to the following description in consideration of the accompanying drawings, in which the leftmost significant digit(s) in the reference numerals denotes the first figure in which the respective reference numerals appear, and in which like reference numbers indicate like features. The novel features believed characteristic of the present subject matter are set forth in the appended claims. The present subject matter itself, however, as well as a first mode of use, further objectives and advantages thereof, will best be understood by reference to the following detailed description of an illustrative embodiment when read in conjunction with the accompanying drawings, wherein:

FIG. 1 illustrates a curriculum design phase diagram

FIG. 1A demonstrates a curriculum design phase illustrative diagram exemplifying proper utilization of the curriculum design phase diagram exemplified in FIG. 1

FIG. 2 exemplarily illustrates a curriculum development phase flowchart diagram

FIG. 3 illustrates a curriculum delivery phase diagram

FIG. 3A exemplarily demonstrates a curriculum delivery phase illustrative diagram demonstrating proper utilization of the curriculum delivery phase diagram

FIG. 4 shows a curriculum creation steps design phase outline and form

FIG. 4A exemplarily demonstrates a working example participant workbook creation steps design phase outline and form illustrating proper utilization of the curriculum creation steps outline and form

FIG. 5 shows an illustrative working example of a Participant Learning Experience Workbook cover page

FIG. 6 illustrates a working example of proper layering on content between learning resources, with one part being the facilitator guide excerpt

FIG. 7 exemplarily illustrates a working example of proper layering on content among learning resources, with one part being the Dynamic Leadership presentation excerpt

FIG. 8 illustrates a working example active/passive content ratio diagram and active/passive content ratio apparatus diagram

FIG. 9 illustrates a working example active/passive content ratio diagram

FIG. 10 exemplarily illustrates a first embodiment of an overview of the present subject matter, a design process of a learning experience curriculum for facilitating learning

FIG. 11 exemplarily exemplifies a second embodiment of an overview of the present subject matter, layering on content process and Learn/Practice/Assess Protocol

FIG. 22 illustrates a working example course evaluation form

FIG. 23 exemplarily demonstrates third embodiment of an overview of the present subject matter and working example illustrating the architecture of a practical learning card game

It is to be noted, however, that the appended drawings illustrate only typical embodiments of the present claimed subject matter and are, therefore, not to be considered as limiting the scope of the present claimed subject matter, as said present claimed subject matter may admit to other equally effective embodiments.

### REFERENCE NUMERALS

100 Curriculum design phase diagram
100A Curriculum design phase illustrative diagram
101 Design phase
102 Defining scope
103 Knowledge gap
104 Target audience
105 Learning scope
106 Standard method/process
107 Priority based on impact, priority/impact
108 Course, curriculum, content, & apparatus not available in the market
109 Active learning
110 Active/passive content ratio rule
111 Learn/Practice/Assess Protocol
112 Layering content on, layering on content, layering, layered, layering content
113 Learning experience
114 Interactive learning experience
115 70/30 rule
116 Key topics, critical topics, crucial topics, essential topics, important topics
116A Topic 1 Stop Managing—Start Leading
116B Topic 2 Employee Engagement
116C Topic 3 Trust
116D Topic 4 Key Partnership
116E Topic 5 Talent Management
116F Topic 6 Talent Acquisition
116G Topic 7 Succession Planning, Talent Planning
116H Topic 8 Career Conversations
1161 Topic 9 Development Planning
116J Topic 10 Performance Management
116K Topic 11 Retention and Turnover
117 Key content based on impact
117A Content 1
117B Content 2
118 Designing Course
119 Model(s)
120 Template(s)
122 Course objective(s)
123 Reduce or lessen knowledge gap
124 Relevant environment
125 Issue/real solution
126 Increase content knowledge
127 Drive behavioral change
128 Learn or improve a competence
129 Educational tool(s)
130 Talent management
131 Adult learners
132 Management members
133 Talent, employee, team member, direct report
200 Curriculum development phase diagram
201 Development phase
202 Chunking, dividing, subdividing, sectioning, segmenting
204 Segmenting
204A Segment 1—People
204B Segment 2—Process
205 Active Content
206 Activity, activities
207 Discussion
208 Game
209 Simulation
210 Lecture
211 Reflection
212 Report out
213 Passive content
214 Drafting
214A Draft 1 complete
214B Draft 2 complete
214C Draft 3 “Final” complete
215 Editing
215A Edit 1 complete
215B Edit 2 complete
215C Final edit complete
217 Development Phase II
218 Development Phase I
300 Curriculum delivery phase diagram
300A Curriculum delivery phase illustrative diagram
301 Execution phase, delivery phase
302 Measurable outcomes of closing knowledge gap
303 Content type
304 Delivery mode
305 Learn
306 Practice
307 Assess
308 Class, group, peer-to-peer, self
310 Course specific
312 Classification
312A Classification 1
312B Classification 2
312C Classification 3
312D Classification 4
400 Curriculum creation steps design phase outline and form
401 Creation phase
402 Process
403 Step
404 Action
405 Complete
406 Determine best method/process to close the knowledge gap
407 Define course
408 Identify knowledge gap hindering business performance
409 Determine target audience
410 Define learning scope
411 Determine critical topics that must be addressed to close knowledge gap
412 Define course objectives
413 Choose the delivery method
415 Create a list of potential topics
416 List topics based on priority based on impact
417 Create learning objectives for each topic
418 Define key concepts for each topic
419 Conduct research/benchmarking to identify existing content that may be available in the market
420 Determine the desired length of course
421 Determine the logical order/flow of materials
422 Outline proper chunking of content
423 Implement Learn/Practice/Assess Protocol
424 Draft content outline
425 Create educational tool—Draft 1
426 Determine what support materials are needed to aid learning
427 Create support materials for outlined content
428 Educational tool—Draft 1 complete
429 Edit educational tool—Draft 1
430 Make necessary adjustments to core content including content flow and support materials
431 Educational tool—Draft 2 reviewed by editor
432 Final educational tool complete
433 Multimedia tool
434 Choose multimedia tool
435 Create multimedia tool
436 Multimedia tool—Draft 1
437 Edit multimedia tool—Draft 1
438 Make necessary adjustments to multimedia tool
439 Cross reference educational tool and multimedia tool for consistency
440 Multimedia—Draft 2 reviewed by editor
441 Final multimedia tool complete
442 Calculate estimated delivery time based on finalized content
443 Agenda
444 Draft course agenda
445 Make necessary adjustments to content and/or agenda to fit into the time allotted for course
446 Finalize course agenda fix
447 Participant workbook creation steps outline
448 Adopt and apply appropriate curriculum design phase
449 Implement course development process
450 Apply course delivery/execution process
452 Participant workbook—Draft 1 complete
453 Edit participant workbook—Draft 1
454 Participant workbook—Draft 2 reviewed by editor
455 Final participant workbook complete
456 Implement standard method/process
457 Adopt and regulate active/passive content ratio
500 Dynamic Leadership Participant Workbook
501 Dynamic Leadership Participant Workbook cover page
601 Facilitator guide excerpt
702 Dynamic Leadership Presentation excerpt
702A Dynamic Leadership Presentation Slide 27
702B Dynamic Leadership Presentation Slide 28
702C Dynamic Leadership Presentation Slide 29
702D Dynamic Leadership Presentation Slide 30
1000 Design process of a learning experience curriculum flowchart
1001 Implement
1002 Curriculum design process
1100 Layering on content process diagram
1101 Learn/Practice/Assess Protocol diagram
2200 Course evaluation
2201 Date
2202 Instructor, trainer
2203 Location
2204 Strongly disagree
2205 Disagree
2206 Agree
2207 Strongly agree
2208 Overall
2209 The content was relevant to my role as a leader
2210 I learned skills that will help me in my role as a leader
2211 I would recommend this course to my friends and colleagues
2212 I am happy that I attended this course
2213 How would you rate the instructor in the following areas?
2214 Encouraged participation and interaction
2215 Explained concepts clearly
2216 Managed the time and pace well
2217 Used engaging stories/examples to illustrate course concepts
2218 Was enthusiastic and energetic
2219 Was knowledgeable about the subject matter
2220 Was organized and prepared
2221 I would recommend this instructor to my friends and colleagues
2222 Course
2223 How would you rate the course in the following areas?
2224 Activities, exercises, and discussions were effective
2225 Content was organized and easy to follow
2226 Course materials were helpful
2227 There was a proper mix between lecture, discussion, and activities
2228 As a result of this course, I have improved my capabilities as a leader in the following areas
2229 Based on my holistic learning experience, I would attend another training held by [Company]
2230 I would be interest in attending a future training that covers (select all that apply)
2231 Research study participation question
2232 Interest in being informed of additional classes when released
2233 Instructions
2234 Name
2235 Email
2236 Other topics of interest
2300 Practical learning card game
2301 Practical learning cover
2302 What are you willing to give?
2303 Practical learning game card face, Extra effort
2304 Practical learning game card face, Unsolicited input
2305 Practical learning game card face, Support
2306 Practical learning game card face, Personal sacrifice
2307 Practical learning game card face, Advice
2308 Practical learning game card face, Necessities
2309 Practical learning game card face, Feedback
2310 Practical learning game card face, Trust
2311 Practical learning game card face, Empathy
2312 Practical learning game card face, Suggestions
2313 Practical learning game card face, Respect
2314 Practical learning game card face, Acceptance
2315 Practical learning game card face, Positive attitude
2316 Practical learning game card face, Reply to requests
2317 Practical learning
2318 Improving Lives One Leader at a Time mission statement
2319 DLX game
2320 Set of practical learning game cards
2321 a DLX activity
2322 Copyright

### NOTATION AND NOMENCLATURE

Certain terms are used throughout the following description and claims to refer to particular process or system components. As one skilled in the art having the benefit of the present disclosure will appreciate, companies may refer to a component by different names. This document does not intend to distinguish between components that differ in name but not function.

In the following discussion and in the claims, the terms “including” and “comprising” are used in an open-ended fashion, and, thus, should be interpreted to mean “including, but not limited to.” In the subsequent discussion and in the claims, the terms and phrases in bold and within quotes have the following meaning(s):

### Glossary of Terms

“Active learning” or “actively learning” is the educational method in which participants are actively involved in their personal learning process through regular interaction. Making the course personal to students enables them to engage in active learning, thereby becoming participants. It is a learning method and apparatus that allows participants the opportunity to take in complex ideas or concepts, absorb that, then have the opportunity to practice that learning. Active learning facilitates participants taking ownership of their personal learning and becoming invested in the learning or outcome. Participants being actively involved in their personal learning process expedites active learning in part because engaged students retain more. Increases in active participation correlate to increases in active learning. Active learning enhances participants' ability to find their own answers to questions or to find solutions to real problems, issues, or concerns they have.

Active learning occurs through active content delivery as participants are personally doing an act or activity during that portion of the educational course. Educators facilitate or assist the progress of active learning by executing regular interactions that actively involve a participant in his/her learning process. In a course specific learning environment, participants actively learn what will or will not work in a given subject area. So that when they leave the course, they know the “how.” That is, the how to execute that learning to address an issue with a real solution in their work or relevant environment. Active learning that achieves a 70/30 active/passive content delivery ratio reaches the threshold of being an interactive learning experience.

“Active/passive content ratio rule” is a rule requiring active content delivery must be substantial and passive content delivery must be the minimum possible that still provides the key learning. Active content means participants are personally participating in an act or activity during that portion of the educational curriculum. Passive content is content in which the participant is seeing, hearing, or otherwise receiving learning or information and doing nothing physical in response to that. The active/passive content ratio rule is the base level of adequate content delivery ratios that reaches the threshold of being a learning experience. Adhering to the active/passive content ratio rule ensures the curriculum provides active learning that rises to the level of learning experience.

“Best practices” is a procedure that has been shown by research or experience to produce optimal results, that represent an efficient or prudent course of action in a given business situation, that is established as a standard suitable for widespread adopting, or that is accepted or prescribed as being correct or effective.

“Chunk,” “chunked” or “chunking” is the process of dividing complex topics into smaller digestible sections of learning content to ensure participants are able to absorb and understand key concepts. It is the strategic division of information.

“Class” or “classroom” is a place devoted to instruction or learning; a learning environment. This includes a venue that is conducive to learning, whether it be live, in-person, onsite, instructor-led, virtual, remote, distance learning, pre-recorded, online, tailored learning services, or other setting. It is also referred to as workshop, training, session, event, or other similar terminology.

“Course” is an educational program, curriculum and supporting learning resources, program of study, or progression through educational development via a series of acts, activities, lectures or lessons. It is also commonly referred to as a training, curriculum, instruction, session, learning event, blended learning, eLearning, or other similar terminology.

“Curriculum” is a detailed plan for instruction including content, concepts, and devices; program of study in toto; a learning product including course, content, concepts, and devices. A learning resource is an illustrative example of a device.

“Driving behavioral change” means changing a behavior that produces a negative or less than adequate outcome as to how a person functions under normal circumstances to a new behavior that produces a more effective outcome. In business, this occurs when leaders receive the learning resources by which to learn and develop an appropriate new skillset that drives impact. Advantages of behavioral change in the business world can be higher employee engagement, greater retention, decreased turnover, or other benefit.

“Dynamic” as defined within a learning environment is stimulating change or progress via repeated and productive activities. It is demonstrated by frequent change, activity, or progress occurring throughout the duration of the course. Participants' learning becomes dynamic as their learning progresses and they undergo a major transition or significant change in perspective. This can be seen in their positive or energetic attitude, or new ideas, and can lead to a change in behavioral traits.

“Educator” is a person with a requisite skillset who teaches one or more persons in a learning environment. Educators are commonly referred to as a facilitator, teacher, trainer, coach, lecturer, guide, instructor, or other similar title.

“Interactive learning experience” is active learning that achieves at least 70 percent active content delivery and maximum 30 percent passive content delivery ratio. This is known as the 70/30 rule. It is the base level of adequate content delivery ratios that reaches the threshold of being an interactive learning experience. For learning to be significant enough to enable personal development, course content must be developed and delivered in a manner that provides participants the greatest opportunity for success in decreasing their deficiencies in the topic. Interactive learning experience will produce substantial behavioral changes that will reduce, lessen, or close current knowledge gaps when delivered properly.

“Fail-safe environment” is a learning space where participants are provided the freedom to try new skills where they are protected from judgment as they learn and practice.

“Key” is also referred to as essential, critical, crucial, and important.

“Knowledge transfer” or “transfer of knowledge” is the process by which an expert in the field of the subject content shares professional knowledge, sound ideas, and industry experience and participants learn that shared knowledge. An example is what the problem is and how to fix it. It moves from the source of the knowledge to the recipient of that knowledge. Educators facilitate this knowledge transfer through a plurality of mechanisms, each of which is specially developed for this purpose. It begins as knowledge sharing by the educator and becomes knowledge transfer when participants learn. Practical learning is a positive reinforcement to develop knowledge transfer.

“Layering, layering content, layering content on, layered, layered on content,” or “layering on content” is a novel process. Layering is the act of facilitating learning of a key concept and building upon the knowledge learned to facilitate key learnings or knowledge transfer. Layering content enables participants to gain key leanings via one or more learning resources. Layering can be interspersed among learning resources. Layering on content does not require that it be done during the passive content or lecture portion of the learning. It is possible and often advisable to layer on content within an activity, game, or simulation. This is easy to occur when you layer in activities to another educational tool. This process can facilitate and enhance learning. Layering on content should occur throughout the educational course. Examples of where layering can occur are educational tools, supporting aids, content, or delivery modes, presentation, reflection, multimedia tool, peer to peer, discussion, activities, games, simulations, or other mechanisms.

The method of layering on content is central to the learning experience design. Layering is an approach to facilitating a learning experience in order for a concept to be digestible by participants or enabling participants' knowledge to build over time. A course utilizing layering content is designed in a way to act as building blocks. Participants are introduced to a piece of information based on a key topic that must be addressed to close a student's current knowledge gap. Once learners understand the concept, have practiced it, and comprehend it, then the next layer can be added on.

“Learn/Practice/Assess Protocol” is a novel method of facilitating a learning experience. Content designed, developed, executed, and created utilizing the Learn/Practice/Assess Protocol provides participants opportunity to learn, practice, and assess the learning objective. “Learn” provides participants the knowledge necessary to gain knowledge or learn about a topic, skill, or tool. “Practice” provides participants the opportunity to express a challenge or problem they are experiencing within their work environment or relevant environment as it relates to the topic. Participants then use the learned skill or tool to solve their defined problem or challenge. “Assess” validates that participants have met the learning objectives for the outlined content by providing participants the opportunity to share what learning insights they have gained and develop action items for implementation post-course as part of their ongoing development. The Learn/Practice/Assess Protocol is utilized throughout the course in a plurality of mechanisms. Once participants learn a concept or content, they practice recognizing it, analyzing it, using it. The Learn/Practice/Assess Protocol adheres to the active/passive content ratio rule to ensure it is a learning experience. The Learn/Practice/Assess Protocol is core to the course being an interactive learning experience.

“Learning experience” is defined as learning through experience, which is the process of learning through reflection on doing. Learning experience is the execution of active learning that achieves the active/passive content delivery ratio as set out in the active/passive content ratio rule. Participants come into a course specific learning environment with problems, issues, and concerns searching for solutions. A learning experience promotes key learnings by educators facilitating a transfer of knowledge that leads participants to discovering their own solutions so they can implement similar actions upon returning to their actual work environment or relevant environment. A learning experience dissects the information in a way that provides participants the opportunity to take in complex concepts or content, absorb that content or concept so they understand, then gives participants the requisite opportunity to practice the skill they have just learned. So that it becomes familiar or second nature. By the time participants leave the session each not only knows the content they need to know, but each learner has had the opportunity to try it. So that when participants are faced with the same or a similar situation once the course concludes and they are back in their work environment or relevant environment, they will know what they need to do and they will know how to handle it. Participants get that through a defined learning experience. Participants are given the opportunity to work through ways to resolve a real problem or issue they have in their actual work environment or other environment in a way that is fail-safe. They learn, really know, build on, all before going to next key concept or content. They can often circle back to earlier content learned to reinforce key learning. Games and activities are examples of active content wherein the participant is interactively participating in a personal learning experience.

A course is determined to be a learning experience when learning and development is expected to continue post-course and participants are given practical learning tools to facilitate their future learning and development post-course in their real, relevant, or work environment. Learners must understand or comprehend the subject matter. Educators execute content, educational tools, and learning resources through a series of actions to guide, direct, or provide a pathway for participants to be able to digest and process information presented. Executing layered on content achieves this. Participants must be given an opportunity to practice the learnings. Practicing in the fail-safe environment of the learning course is the appropriate venue for each participant to try what each has conceptualized as the key learning being practiced. Learning through reflection on what each participant has practiced is where learning occurs. These learning opportunities and techniques enhance learning or facilitate the course being a learning experience or interactive learning experience. A learning experience is designed in a way that allows participants the opportunity to take in complex ideas or concepts, absorb that, then have the opportunity to practice that learning. A learning experience is executed in a way that lets people learn, practice, get comfortable so that when they go back to their work or relevant environment it is natural; it is possible for them to implement what they have learned during the course because they have had the opportunity to practice the new skillset. An educational course supports interactive learning by doing some sort of an activity that allows participants to practice what they've just learned. Interactive participation brings about participants taking ownership of their individual learning experience throughout the development process. Activities, games, or simulations can enhance a learning experience wherein an active participant becomes emotionally invested or takes ownership of his/her learning and development. Following learning with one or more activities can enhance active learning, that can be followed by an activity wherein each participant applies knowledge learned to his/her actual work environment or relevant environment. Learning and development are often referred to as though it is one process. These are two separate and distinct processes. Learning occurs during the learning experience; development happens over time, beginning during the course and continuing after participants are back in their actual work environment or relevant environment. That is also the experience piece.

“Learning resource” is any tool that enhances or supports learning or educating. It is any tool, including print and non-print materials, that helps educators teach or participants learn. Learning resources can include one or more activities, activity books, animations, apparatus, apps, audio representations, audiovisual aids, blackboards, books, card games, cards, charts, CDs, computers, content, courses, curriculum, cycle diagrams, cycle schematic, data compilations, devices, diagrams, digital downloads, digital materials, discussion forums, documents, DVDs, educational aids, educational assets, educational materials, educational tools, facilitator guides, flashcards, flowcharts, games, graphics, guides, illustrations, images, information, inputs, instructional material, instructional manuals, instructional support, interactive modules, interactive participation or program, Internet, knowledge sharing, learning aids, learning courses, learning materials, learning tools, manuals, maps, materials, media aids, media tools, methods, models, multimedia tools, online courses or tutorials, online flashcards, online interactive modules, online resources, participant workbooks, pictures, podcasts, PowerPoint, presentations, processes, process maps, program materials, projectors, reading materials, recordings, schematics, simulations, software, study aids, study guides, supplemental resources, supporting aids and materials, supporting tools, teacher edition books, teacher edition guides, teacher guides, teacher instructional support, teaching materials, templates, textbooks, texts, tools, videos, visual representations, web applications, webcasts, websites, whiteboards, workbooks, worksheets, workshops, or any other format, virtual or real.

“Learning type(s)” include learning, knowledge transfer, active learning, practical learning, learning experience, interactive learning experience, and practical learning experience. Interactive learning experience and practical learning experience are synonymous.

“Participant” is a person who actively participates or takes an active part in his/her personal learning. Participants use the tools they are being provided to actively formulate their own academic progress. This is possible when the course is purposefully designed in a manner that develops active learning. Participants actively engage in their personal learning as they progress through the course content and learning resources via a plurality of mechanisms and apparatus. Participants are also known as attendee, contributor, learner, member, partaker, student, trainee, or other comparable terminology.

“Practical learning” is a method of enabling one or more participants to practice a newly acquired skill using real situations that are currently relevant for each of them. Practical learning is active content and active learning. Practical learning is the “practice” portion of the Learn/Practice/Assess Protocol.

“Seventy/Thirty rule” or “70/30 rule” is a content delivery rule that requires all content contain a minimum of 70 percent active content and no more than 30 percent passive content. This is a higher standard than the active/passive content ratio rule. 70/30 ratio is the threshold active/passive content delivery ratio required to qualify as an interactive learning experience. Utilizing a 70/30 rule as part of the standard method/process strengthens making a learning course one or more of active learning, a learning experience, or an interactive learning experience. Active content is learning in which the participant is learning by actively doing a physical act or action. Active content can include activities, discussions, games, simulations, or other similar active content that can be a class, group, peer-to-peer, instructor-led, or independently delivered exercise, live or virtual. Passive content is content delivery in which the participant is seeing, hearing, or otherwise receiving learning or information and doing nothing physical in response to that. Passive content can include lecture, reflection, report outs, or other passive content that can be a class, group, peer-to-peer, instructor-led, or independently delivered exercise, live or virtual.

For learning to be significant enough to enable personal development, curriculum content must be developed and delivered in a manner that provides participants the greatest chance for success in decreasing their deficiencies or increasing their skillset in the topic. An interactive learning experience will produce one or more substantial behavioral changes that will close current knowledge gaps when delivered properly. Because an interactive learning experience is critical to delivering a meaningful impact to participants, courses should follow the 70/30 rule. The 70/30 Ratio can also be referred to as the 70/30 Model, 70/30 Principle, or other similar titles.

“Standard method/process” is the process of incorporating best practices techniques and devices within the design process of a learning curriculum or learning experience curriculum.

“Talent” is the human element within an organization; the people. It is commonly referred to as one or more employees, team members, direct reports.

“Template” is a device created for continued utilization post-course that is first used during the course as a learning resource to ensure learners comprehend the subject content within a template and are confident or comfortable performing the same actions utilizing the template in their relevant environment.

### DETAILED DESCRIPTION

The following description of the present subject matter is provided as an enabling teaching of the present subject matter and its present embodiment. Those skilled in the art will recognize that many changes can be made to the embodiments described herein while still obtaining the beneficial results of the present subject matter. It will also be apparent that for some embodiments some of the desired benefits of the present subject matter can be obtained by selecting some of the features of the present subject matter without utilizing other features. Accordingly, those skilled in the art will recognize that many modifications and adaptations of the present subject matter are possible and may even be desirable in certain circumstances that are part of the present subject matter. Those of ordinary skill in the art will recognize that other elements are desirable and/or required in order to implement the present subject matter. Thus, the following description is provided as illustrative of the principles of the present subject matter, and not in limitation therefore and may include modification thereto and permutations hereof. While the following exemplary discussion of the present subject matter may be directed towards or reference specific embodiments, it is to be understood that the discussion is not intended to limit the scope of those embodiments.

Those skilled in the art will further appreciate that many modifications to the exemplary embodiments described herein are possible without departing from the spirit and scope of the present subject matter. Thus, the description is not intended and should not be construed to be limited to the examples given but should be granted the full breadth of protection afforded by the appended claims and equivalents. Illustrative embodiments of the present claimed subject matter are described in detail below. In the interest of clarity, not all features of an actual implementation are described in this specification. It is to be understood by those skilled in the art that the figures and descriptions of the present subject matter have been simplified to illustrate elements that are relevant for a clear understanding of the present subject matter, while eliminating, for purpose of clarity, other elements that may be well known. Those of ordinary skill in the art will recognize that other elements are desirable and/or required in order to implement the present subject matter. However, because such elements are well known in the art, and because they do not facilitate a better understanding of the present subject matter, a discussion of such elements is not provided herein. It will be appreciated that in the development of any such actual embodiment, numerous implementation-specific decisions must be made to achieve the developers' specific goals, such as compliance with business-related constraints, which may vary from one implementation to another. Moreover, it will be appreciated that such a development effort might be complex and time-consuming, but would nevertheless be a routine undertaking for those of ordinary skill in the art having the benefit of the present disclosure. The detailed description will be provided herein below with reference to the attached drawings.

### DETAILED DESCRIPTION—FIGS. 1-23—FIRST EMBODIMENT

With attention drawn to FIG. 11, an exemplary architecture and demonstrative illustration of the process of layering on content that forms the basis of the present embodiment is presented according to the first embodiment of the present subject matter. The layering on content process diagram as exemplified in FIG. 11 shows an exemplary illustration within the present application.

With attention drawn to FIGS. 1A-23 show exemplary examples of the proper utilization and implementation of the layering on content process within the present application.

Layering content, layering content on, layering, layered, layered content, layering on content 112 are variations of the process of layering content 1100 or layering on content process 1100. See the Glossary of terms for a more complete definition of “layering content.” The layering on content process 1100 as exemplarily illustrated in FIG. 11 is the process of presenting layered content 112 within the curriculum that should be followed by an activity, active content, or practical learning. Once learners understand or comprehend that portion of content 117, the next block or piece of layered content 112 can be presented. The next piece of layered content should build upon the new knowledge attained in the previous block of layered content 112. The layering on content process 1100 as exemplarity illustrated in FIG. 11 demonstrates learn 305, practice 306, learn 305 learn 305, practice 306, learn 305 learn 305 learn 305, practice 306, assess 307. The layering on content process 1100 as exemplarity illustrated in FIG. 11 further demonstrates a digestible learn 305 block or section being followed by practice 306. Practice 306 between blocks, pieces, or sections of layered content 112 is not mandatory; however, practice 306 enhances learning or retention and should be incorporated when feasible. A new layer of content 112 or information can be added once learners understand the concept presented and comprehend the new learning from the previous layered content 112. The next absorbable learn 305 block can be added. The layering on content process 1100 diagram illustrates two learn blocks. This is because the second block is building on the first. After the second block of learn 305, students will practice 306 the new learning that includes the first and second blocks of learning. Once learners understand the information to this point, a new section of learn 305 can be added, which is displayed as three sections of learning on the illustrative Layering on Content process 1100 diagram. This learn 305 block is followed by practice 306. At the end of each topic, chapter, or section, the learn 305 and practice 306 should be followed by assess 307, which is illustrated as the last figure or image on the Layering on Content Process 1100 diagram as exemplified in FIG. 11. There is no limit to the number or amount of learn 305 mode blocks or sections within a curriculum, section, segment, or topic. There is no limit to the number or amount of learn 305, practice 306, and assess 307 delivery modes within a curriculum, section, segment, or topic when the Learn/Practice/Assess Protocol as exemplarily illustrated in FIG. 8 is adopted. Concluding each subject area, topic, section, chapter, or other segment, the culmination of layered content 112 within that portion should be reviewed with students to ensure one or more learners comprehend how the pieces fit together and why that knowledge is important. The curriculum can build on that new knowledge advancing to the next subject or content area, wherein the layering content process 1100 as exemplified in FIG. 11 can repeat and should be followed until the course concludes. As the curriculum is being developed, this foundation should be core to its design. Layering content 112 should support knowledge building by utilizing a systematic method of creating and executing learning variations. Layering 112 should occur throughout the educational curriculum and can occur within a plurality of mechanisms. Grouping content 117 can enable a coordinated and consist flow. Layering 112 is the process of determining appropriate pieces or blocks of information to be presented to learners based on adoption of predefined or predetermined subject areas or pieces of information. The process of layering content 1100 should be within the standard method/process 106 of an educational curriculum. Considerations within a curriculum design process 1002 include course specific 310 elements, subject area, predetermined requisites, target audience 104, course objectives 129, learning best practices, or other applicable determinants. Layering content 112 acts as building blocks of learning utilizing the process of dividing a key concept or content into digestible or absorbable learning sections. Implementation 1001 of an educational curriculum built on the foundation of the process of layering content 1100, imparts small or absorbable pieces of relevant information that can enable a learner's knowledge to build over time with understanding and comprehension.

Incorporating the Learn/Practice/Assess Protocol 111 as exemplarily illustrated in FIG. 11 enhances learning and reinforces knowledge transfer. Following the Learn/Practice/Assess Protocol 111, students learn specific content 117 on a subject, practice skills or complete an action based on new knowledge before additional information or more complexity is added with the new layered content 112. Practical learning within the Learn/Practice/Assess Protocol 111 reinforce learning. Layered on content 112 within a curriculum should be followed by an activity 206, active content 109, or practical learning. Practical learning is the practice 306 portion of the Learn/Practice/Assess Protocol 111. Layering content should occur during learn 305, practice 306, and assess 307 modes. Layering content 112 can reinforce key leanings during practical learning as students are given a learning opportunity in a fail-safe learning environment. The layering on content process 1100 as exemplified in FIG. 11 is a standalone, independent process. Utilization of the layering on content process 1100 should occur throughout the design process of an educational curriculum. The process of layering content 1100 is beneficial and provides value for all age and intelligence levels. This can include elementary, high school, college, or adult courses. It includes courses, sessions, trainings, or seminars or other educational setting. Private, public, governmental, or nonprofit organizations can benefit by utilizing the process herein.

The detailed description of the first embodiment within the present subject matter appears within the balance this specification. The entire contents within this specification are equally applicable to this section, these figures, or elsewhere throughout the present subject matter without being repeatedly duplicated throughout this present application. The entire contents of each figure, drawing, number, and content identified and referred to herein are attached and incorporated by reference just as if these figures, drawing numbers, and content were set forth in full where the reference thereto is made within FIGS. 1-23.

FIGS. 1-23 are illustrative examples of the proper utilization of the Layering on Content Process as exemplified in FIG. 11.

The object of an embodiment is to provide an apparatus and process for layering on content in the creation, construction, build, or design process of an educational curriculum to facilitate learning. The process of layering on content is the foundation upon which all educational curriculum should be built. Executing layered content enables educators to execute content, educational tools, and learning resources through a series of actions to guide, direct, or provide a pathway for learners to be able to digest and process information presented with understanding and comprehension of the subject matter. Successful implementation of layered content drives behavioral change. As layering content and practice progress, learners gain self-awareness of one or more deficiency areas in his/her skillset, leadership style, or other pertinent area followed by gaining confidence in one's ability to take action for impact as layering and learning progress.

### DETAILED DESCRIPTION—FIGS. 10, 1, 1A, 2, 3, 3A, 4, 4A, 5, 6, 7, 8, 9, 22 and 23—SECOND EMBODIMENT

With attention drawn to FIG. 10 an exemplary architecture and demonstrative illustration of a standard method and apparatus for the design process of a learning experience curriculum for facilitating learning is presented according to an embodiment of the present subject matter. With attention drawn to 1-4A an exemplary architecture and demonstrative illustration of a standard method and apparatus for one or more phases within the design process of a learning experience curriculum for facilitating learning that is presented according to an embodiment of the present subject matter. In this embodiment, the method and apparatus for creating an educational curriculum is delineated. With attention drawn to FIGS. 1-9 and 22-23 show exemplary examples of the proper utilization and implementation of a design process of a learning experience curriculum facilitating learning within the present application. The process of the embodiment as exhibited in FIGS. 10, 1-9 and 22-23 comprise one or more segments or stages that culminate into a curriculum design process 1002. Stages or phases can be the designing phase 101 as exemplarily illustrated in FIG. 1, the development phase 201 as exemplarily illustrated in FIG. 2, the delivery or execution Phase 301 as exemplarily illustrated in FIG. 3, the creation phase 401 as exemplarily illustrated in FIG. 4, or other appropriate phase as deemed appropriate. Fewer or more stages or phases can be deemed appropriate.

With attention drawn to FIG. 10, an exemplary design process of a learning experience curriculum 1000 diagram is presented according to an embodiment of the present subject matter. In this particular embodiment, with attention drawn to FIG. 10, the exemplary illustrative design process of a learning experience curriculum illustrating the apparatus and method of a design process for devising or building an educational curriculum, content or content, concepts and learning resources for facilitating learning is delineated.

The design process of a learning experience curriculum 1000 for facilitating learning can be comprised of one or more phases or stages. The phases within our illustrated design process of a learning experience curriculum 1000 as exemplified in FIG. 10 can include the design phase 101 as exemplarily illustrated in the curriculum design phase diagram 100 as exemplified in FIG. 1, development phase 201 as exemplarily illustrated in the curriculum development phase diagram 200 as exemplified in FIG. 2, delivery design phase 301 as exemplarily illustrated in the curriculum delivery phase 300 diagram as exemplified in FIG. 3, creation phase 401 as exemplarily illustrated in the curriculum creation steps design phase outline and form 400 as exemplified in FIG. 4, or other applicable phase, in whole or in part, as deemed appropriate. The following one or more phases within the design process of a learning experience curriculum 1000 culminates into a coordinated and consistent educational product that is ready for implementation 1002 or to be deployed.

The content creator should own all stages of content development or should be actively involved in all aspects of the subject curriculum, which includes process and devices. Content creator should be determined based upon the requirements and responsibilities for the subject curriculum or learning area. As architect of curriculum development, the content creator should have the requisite expertise, capabilities, and skillset to competently and capably construct and implement 1002 a curriculum that facilitates learning. There are many types of learning. As illustrative examples within the present subject matter, learning types can include learning, knowledge transfer, active learning 109, practical learning, learning experience 113, practical learning experience, and interactive learning experience 114. More than one type of learning can be achieved within a learning session or section. Responsibilities of the content creator can include one or more of collaborating with counterparts, educators, team members, or others who have expertise in the subject matter or who have a vested interest in the final educational product; developing programs for adult learners 131, employees 133, supervisors, members of management 132, leaders, or other appropriate group; identifying and implementing adult-learn best practices for developing learners to increase content knowledge 126, learn or improve a competence 128, drive behavioral change 127, reduce or lessen knowledge gaps 123, or other benefit; identifying skills benchmarks; standardizing learning or training prerequisites; developing assessments or evaluations to determine requirements for curriculum development; developing gap analysis to determine requirements and opportunities for curriculum development; evaluating delivered solutions versus success metrics; evaluating delivered solutions versus knowledge gaps within the scope of content, revise or make curriculum adjustments if or as needed or deemed appropriate, or other appropriate responsibilities. See the Glossary of terms for a definition of “best practices.”

With attention drawn to FIG. 1, an exemplary overall curriculum design phase diagram is presented according to an embodiment of the present subject matter. In this particular embodiment, the curriculum design phase 100 diagram illustrating the method of designing an educational curriculum that employs a standard method and devices for the design phase within a design process of a learning experience that can achieve one or more course objectives or facilitate learning is delineated.

The curriculum design phase 100 diagram as illustrated in FIG. 1 provides an outline map that can aid in the design phase 101 of a learning course. The curriculum design phase 100 diagram can serve as the blueprint for designing a learning curriculum. The curriculum design phase 100 diagram as exemplified in FIG. 1 can incorporate systems to facilitate or enhance learning. FIG. 1 is a curriculum design phase 100 diagram illustrating designing an educational curriculum or facilitating a learning experience and further illustrating how the design phase 101 can be subdivided into defining scope 102 and designing course 118. Defining scope 102 can be subdivided into knowledge gap 103, target audience 104, learning scope 105, and standard method/process 106, priority/impact 107. Designing course 118 can be subdivided into course objectives 122, key, essential, critical topics 116, key content 117, templates 120, and educational tools 129. At the outset of the curriculum design phase 100, acquire an understanding as to the knowledge gap 103 that the final educational product is to overcome, lessen or reduce 123. Determining what the measurable outcomes of closing a knowledge gap are early in the curriculum design phase 100 will assist in determining key topics or avoid wasting time and expense on an outcome that provides little to no measurable benefit. Exercise due diligence to ensure the course, curriculum, content and/or apparatus is not already available in the market 108. This ensures there is need for a new course and directs time, money, and resources to where the course can have greatest impact. Once that determination is made, an informed decision can be made as to the need for a new learning product. If commissioned by an organization to create a curriculum, that organization has already made the decision the learning is needed; therefore, accept its determination. The step of searching for like educational products is unnecessary.

The future educational product can be based upon one or more surveys, research, data, analytics, requests, commissions, or other methodology. The curriculum should be course specific. Once the subject of the curriculum is decided upon and applicable research has been done, the design phase 101 can begin. Determinations made during the design phase 101 as exemplarily illustrated in the curriculum design phase 100 diagram exemplified in FIG. 1 direct the development of the curriculum to be implemented. A learning curriculum should introduce and present new or innovative key content 117, concepts, or approaches from initiation to completion when practicable. Challenges as to what and how much information to include or what not to include must be overcome. This curriculum design phase 100 diagram is the blueprint for the curriculum, including learning resources. The curriculum design phase 100 diagram delineates the core parts of the curriculum design phase 101.

The design phase 101 should begin with notes, synopsizes, ideas, questions, or other relevant topics being memorialized on a writing material or within a word or text program within an electronic device. Determine how to structure, organize, and implement the curriculum to facilitate learning or increase content knowledge 126. Utilizing a standard method/process 106 throughout the design phase 101 of the curriculum design process 1002 can ensure a concise, coordinated flow of learning, knowledge sharing, and resources that can enhance learning, reduce a knowledge gap, achieve a course objective, or other benefit. The curriculum should have learning standards, practical learning standards, and assessment standards within the course and post-course to evaluate the quality of the educational program. Utilizing the curriculum design phase 100 diagram, the design phase 101 of the learning curriculum can be sectioned into defining scope 102 and designing course 118 or other appropriate segments. Defining scope 102 should be determined as the first step in the curriculum design phase 101 to keep focus on the subject matter to be developed. This step aids in achieving a course learning objective 122 or an efficacy outcome. The factors that define the scope 102 will be dependent on the needs and goals of the subject matter to be developed. Development can stay on task when scope is at the forefront of the curriculum design phase 101. Design phase 101 can define scope 102 by determining the knowledge gap 103, target audience 104, learning scope 105, standard method/process 106, priority based on impact 107, or other criteria as deemed appropriate. Learning scope 105 should consider course, curriculum, content, and apparatus not available in the market 108 as a determinant. When defining scope 102, there should be a knowledge gap 103 to warrant developing a new curriculum. The curriculum should be built based on the wants, needs, and capabilities of the target audience 104. Knowledge and application of adult learning principles or best practices results in a better learning product.

The apparatus and process of designing an educational curriculum that makes use of a standard method/process that can achieve one or more course objectives or facilitate learning is delineated. The standard method/process 106 is a framework upon which an educational product can be built; it should be determined and clearly delineated at an early stage of the design phase 101. Once decided upon, the standard method/process 106 should be followed throughout applicable each stage or phase of the curriculum design process 1002. The standard method/process 106 should include one or more of active learning 109, active/passive content ratio rule 110, Learn/Practice/Assess Protocol 111, layering content 112, learning experience 113, interactive learning experience 114, 70/30 rule 115, relevant environment 124, and issue/real solution 125. Following the active/passive content ratio rule 110 ensures the curriculum provides active learning 109. Adhere to the active/passive content ratio rule 110 for the curriculum to achieve being a learning experience 113. Abide by the 70/30 rule 115 to reach the threshold of being an interactive learning experience 114. Applying the standard method/process 106 augments the curriculum design phase 100 diagram in achieving one or more course objectives 122 of reducing or lessening a knowledge gap 123, increasing content knowledge 126, driving behavioral change 127, learning or improving a competence 128, or other benefit. The program of study should be designed to promote active learning 109. Increases in active participation correlate to increases in active learning 109. The curriculum should intentionally be designed, developed, delivered, and created so when implemented the course is personal to participants in every aspect possible. Making the learning course personal to students enables them to engage in active learning 109, thereby becoming participants. Learners, students, and participants are one and the same person and can be referred as such interchangeably. Providing a relevant environment 124 that learners can relate to enhances interest, engagement, participation, and retention. Engaged students retain more. Facilitating learning on issues learners are experiencing in their personal environment whereby the learners are able to learn 305, practice 306, assess 307 and then come to their own solution 125 to address that issue drives behavioral change 127 that can be taken back and implemented in their relevant environment 124 as they build on the course leanings.

The Learn/Practice/Assess Protocol 111 is a method of facilitating learning that should be central to the core design as it is being developed and should be implemented throughout the curriculum. Designing the course 118 using the Learn/Practice/Assess Protocol 111 system and method of learning will achieve one or more of the course objectives 122. Students who learn using the Learn/Practice/Assess Protocol 111 as the keystone of learning gain confidence in their abilities and capabilities, which leads to greater retention and the ability to implement lessons learned upon returning to their relevant environment 124. Issues that have real solutions 125 are no longer problems. Priority based on impact 107 is the mechanism that can be utilized to decide which key topics 116 and key content 117 should be included or executed during a learning course based upon the impact the key topics 116 or key content 117 has on course objectives 122. List potential topics. Relist based on the impact each will have, listing greatest impact first, next greatest impact next, and so on for all key topics 116. Early in the process, mark out topics that are too large to undertake during the timeframe the course session will allow. Narrow in on topics and subject matter that is important. Exclude topics that are not as important. Determine key topics 116. It is possible that as the course is being built out key topics 116 originally envisioned as being covered within the course will have to be eliminated due to time constraints or because another key topic 116 or key content 117 within that key topic 116 becomes more important or can have a greater impact.

Do not assume learners already know necessary or core content and concepts. Decide what core content and concepts must be presented to ensure learners have a firm foundation of knowledge to build upon throughout the course. Topics and content 117 that have impact should be given priority 107 because without the core concepts participants will be unable to fully learn the key content 117. Once scope factors are defined 102, designing the course 118 begins. Designing course 118 can include one or more course learning objectives 122, key topics 116, templates 120, educational tools 129, or other considerations as deemed appropriate. By design, the curriculum should be dynamic or should stimulate change via frequent and productive activities. Learning resources should be intentionally chosen to support learning. Course objectives 122 should include reducing or lessening a knowledge gap 120 or other benefit. Ensure key content based on impact 117 that is included within the curriculum is at least the minimum necessary to facilitate learning. Key content 117 can be determined by choosing one or more key topics 116 based on impact, which should be then listed from greatest to lesser importance based on priority/impact 107. Once the key topics 116 and key concepts 117 based on impact that will be the subject matter of the learning course have been chosen, continue to follow the curriculum design phase 100 diagram as exemplified in FIG. 1.

An educational course and learning resources therein can be designed in a way in which key content 117 is executed in a format that acts as building blocks of learning by layering on content 112. The learning resources and the way the course is executed are not independent of one another. Because learning occurs in a plurality of phases, it should also be addressed in the design phase 101. A methodical way of executing the course and learning resources therein that support a desired outcome should be designed to ensure the curriculum can achieve one or more course objectives 119. A purpose of the design phase 101 is to recognize failures before proceeding to the developing, executing, or creating phases. Challenges make it hard for educators to facilitate that learning area and for learners to successfully execute said learning. As an educator, it is difficult to facilitate learning on key content 117 that presents challenges. Remove barriers in the way of educators facilitating learning. If the learning is important enough to be part of the curriculum, design another way to teach the concept.

In this particular embodiment, the curriculum design phase 100 diagram as exemplified in FIG. 1 illustrating the apparatus and method of a design process of a learning experience curriculum for facilitating learning within the design phase of the curriculum is delineated.

In this particular embodiment, the curriculum design phase diagram as exemplified in FIG. 1 illustrating the design phase of a design process of a learning experience curriculum for facilitating learning is delineated.

The curriculum design phase diagram as exemplarily illustrated in FIG. 1 can be implemented 1001, in full or in part, in one or more phases of the overall curriculum design process 1002. Subject matter or contents within the design phase 101 of the curriculum design phase diagram 100 can be integrated or put into practice in the development phase 201, execution phase 301, creation phase 401, or other phase of a design process.

FIGS. 1A, 2, 3, 4 are illustrative examples and FIGS. 3A, 4A, 6, 7, and 23 are illustrative working examples of the proper utilization of the curriculum design phase diagram within the design process of a learning experience curriculum for facilitating learning as exemplified in FIG. 1. Following the initial design phase as exemplified in FIG. 1, which can include a two-part curriculum design phase of defining scope and designing course as illustrated within the curriculum design phase diagram, the standard method for a design process of a learning experience curriculum or the phases for designing, developing, executing, or creating educational curriculum that can utilize a standard method and process continues within the development phase in FIG. 2.

With attention drawn to FIG. 2, an exemplary overall curriculum development phase diagram is presented according to an embodiment of the present subject matter. In this particular embodiment, the curriculum development phase diagram, illustrating the method of developing an educational curriculum that can employ a standard method and devices for the delivery phase within a design process of a learning experience curriculum for facilitating learning that can achieve one or more course objectives or facilitate learning is delineated.

The curriculum development phase 200 diagram as illustrated in FIG. 2 provides a flowchart diagram that can aid in the development phase 201 of a learning curriculum. The curriculum development phase 200 diagram can serve as the framework for developing a learning curriculum. The curriculum development phase 200 diagram as exemplified in FIG. 2 can incorporate systems to facilitate or enhance learning.

FIG. 2 is a curriculum development phase 200 flowchart diagram illustrating developing an educational curriculum or facilitating a learning experience and further illustrating how the development phase 201 can be subdivided into Development Phase I 218 and Development Phase II 217. Development Phase I 218 can be divided into active content that can be subdivided into activities 206, discussion 207, games 208, and simulations 209 and passive content 210 that can be subdivided into lecture 210, reflection 211, and report out 212. Development Phase II 217 can be subdivided into chunking 202 by key topic 1 116A and key topic 2 116B, layering key content 117A and key content 117B, segmenting 204 that can be subdivided into Segment 1 204A and Segment 2 204B, drafting 214 that can be subdivided into draft 1 complete 214A, draft 2 complete 214B, and draft 3 final complete, and editing 215 that can be subdivided into edit 1 complete 215A, edit 2 complete 215B, and final edit complete 215C. The development phase 201 can implement design phase 101 contents or elements as illustrated in the curriculum design phase 100 diagram, in full or in part, as deemed appropriate. Determinations made during the design phase 101 as exemplified in FIG. 1 can aid in directing development of the learning curriculum and supporting educational tools 129. Utilizing the curriculum design phase 100 diagram as exemplified in FIG. 1 can support Course Development Phase I 201 and Development Phase II 217. Incorporating contents within the curriculum design phase 100 diagram as exemplified in FIG. 1 can ensure educational processes and devices are coordinated or provide a smooth flow throughout the curriculum. This can save time and be cost effective.

The development phase 201 within the design process of a learning experience curriculum for facilitating learning 1000 can be comprised of one or more development phase 201 sections. For illustration within the curriculum development phase 200 diagram as exemplified in FIG. 2, the development phase 201 can be chunked into two phases. Development Phase I 218 can encompass active content 205, passive content 213, or other considerations as deemed appropriate. Determining active content 205 delivery and passive content 213 delivery within a course should be an important consideration. Active content 205 means participants are personally participating or doing an act or activity during that portion of the educational curriculum. A few examples of active content 205 are activities 206, discussion 207, games 208, simulations 209, or other content in which the learner actively participates. Active content actively involves learners in each individual's personal learning experience and can facilitate learning. Passive content 213 is content in which the learner does not actively participate or play an active role in. A few examples of passive content 213 are lecture 210, reflection 211, report out 212, or other content in which the participant does not actively participate. Development Phase II 217 can comprise one or more sections or parts to aid in ensuring the key topics 116 and key content 117 encompass the relevant subject matter within the curriculum. For illustrative purposes in my curriculum development phase 200 diagram as exemplified in FIG. 2, the Development Phase II 217 shows five parts, which are chunking 202, layering or layering on content 112, segmenting 204, drafting 214, and editing 215. These parts can have other considerations or elements as deemed appropriate, including substitutions, deletions, or additions. The subject matter can be developed in sections. Key topics based on priority/impact 116 can be chunked 202 into key content based upon priority/impact 117 that is then presented by layering content on 112 as participants learn.

Chunk, chunked, chunking 202 is the method by which the coursework is divided up. It is the strategic division of information. Chunking 202 out a course is based on the awareness that some topics are entirely too large to be able to absorb at one feat. Determinations will be made as to how information should be chunked to facilitate learning. It is known how long adults generally can sit and listen to information before they have to do something. How long can an educator talk at someone or how much time can participants spend doing something before that becomes boring is the question. Chunking 202 includes conversation, presentation, talking to you, activities 206, games 208, and the different ways people can learn. It can be a partner experience, a report out 212, a group discussion 207, as examples. Chunking 202 is based on a key topic 116. What is the topic or the challenge? Participants complete that subject area learning. Then move on to the next key topic 116 or content 117 area. As lessons advance, each subject area is connected to the previous learning. Chunking is methodical in its approach. At the conclusion of the program of study or course, participants have a whole view based on all the chunked 202 information they have now learned how to piece together. The Glossary of terms contains a more complete definition of “chunking.” Chunking 202 divides key topics 116 into absorbable learning sections. Development Phase II 217 within the curriculum development phase 200 diagram in FIG. 2 exemplarily illustrates chunking 202 key topics into Topic 1 116A and Topic 2 116B as demonstrated in Part 1 of the Development Phase II 217.

Layering content, layered on content, layered content, layered, layering content, or layering on content 112 is the act of facilitating learning and building upon the knowledge learned. The novel layering on content process 1100 as exemplarily illustrated in FIG. 11 should be critical, as all other learning methods should be dependent on it. Layering on content is a strategy for how to teach different or new concepts, content, or behaviors that is fundamental to how people learn. Layering content on is intrinsic in the design process of a learning experience; however, it is invisible to the learner. It is a technique where students learn specific topic or content, practice skills based on new knowledge before more complexity is added. Layering on content 112 enables a coordinated flow from one topic 116 to another or from one content 117 area to the next. Layering content 112 is the foundational process upon which a learning experience should stand. Practical learning should utilize layering content 112 as the foundational process upon which it is created. Layering content 112 is key to driving behavioral change. Standard method/processes within a learning experience should be dependent upon the successful implementation of layering on content 112. A curriculum can be developed in a way in which key content 117 is presented in a format that acts as building blocks by layering on content 112. Participants progress through the course content and learning resources via a plurality of mechanisms and apparatus. Utilizing the curriculum development phase 200 diagram as a building tool can ensure content and mechanisms are consistent, relevant, or follow the standard method/process 106. The curriculum developed will be educational. Layering content on 112 is the process of adding depth to a key topic 116, key content 117, concept, or activity 206 by using a systematic method of creating and executing learning variations to support knowledge building. The Course Development Phase 200 should layer on content 112 throughout the course. Examples of where layering on content 112 can occur are one or more learning resources, content, delivery modes, presentation, reflection 211, peer to peer and open discussions 207, activities 206, games 208, simulations 209, or other mechanisms. Layering on content 112 is the act of facilitating learning of a key concept 117 and building upon the knowledge learned to facilitate knowledge transfer or key learnings. As the curriculum is being developed, the foundation is being laid and then you add on next layer of subject content and so on. A participant can be introduced to a piece of information that needs to be addressed to close a current knowledge gap 103 based on a key topic 116. Developing the curriculum to have layered content 112 interspersed in or among learning resources can support a methodical facilitation of key learning. Limiting the passive content 213 aids in keeping content engaging and participants interested. Engaged learners will retain more of what they have learned than those who are not engaged or who become bored. The Glossary of terms contains a more complete definition of “layering content.” Layering 112 divides key content 117 into absorbable learning sections. Development Phase II 217 within the curriculum development phase 200 diagram in FIG. 2 exemplarily illustrates layering content 112 within Topic 1 116A into Content 1 117A and within Topic 2 116B into Content 1 117B as demonstrated in Part 2 of the Development Phase II 217. Key content 117 can be comprised of one or more content sections. Some topics 116 will require more content 117 components based upon the novelty, complexity, or amount of learning within the given subject matter. Depending on the subject or size of the curriculum, segmenting 204 the course into main sections or portions may be helpful. For illustrative purposes in our curriculum development phase 200 diagram as exemplified in FIG. 2, the curriculum is segmented 204 into two pieces, Segment 1 204A and Segment 2 204B as demonstrated in Part 3 of the Development Phase II 217.

The curriculum development phase 200 diagram delineates the core parts of the curriculum development phase. The curriculum development phase 200 diagram as exemplified in FIG. 2 can be utilized to hone in on the relevant subject matter and key content 117. Making use of the curriculum development phase 200 diagram helps to choose a next course of action during the development phase 201. Deciding, for example, when there has been enough talk and it is time for action, developing games 208 that engage participants while serving its purpose, creating activities 206 that get participants thinking outside the box or understanding key concepts and key content 117 can occur when following a curriculum development phase 200 diagram as exemplified in FIG. 2 that outlines a framework that allows content to segue from one subject or action to the next smoothly. The most challenging piece of the curriculum development process can be ensuring it is not overloaded with too much information. Making sure the curriculum is giving learners the right amount of information is key. The curriculum development phase 200 diagram is a tool that can keep the development process on task. People learn more when they can relate to the subject, when it is personal to them, when they have a problem or issue and they are personally working to resolve it. Making the course personal to learners enables them to engage in active learning 109. Participants retain more when they are engaged or the information is novel, interesting, relatable, memorable, or different from the norm. Develop a curriculum with these considerations in mind.

As developing a key topic 116 begins in Development Phase II 217, it is beneficial to start with the end result in mind. Determine what the end result is you are trying to drive within that key topic 116. Each key topic 116 should independently stands on its own. Remember, key topics 116 are building blocks of layered content 112. Decide what is important for learners to really understand. Decide what the keys are that at the end of the day, if they do not remember anything else, you want them to remember that. That can be the starting point of the development phase 201 subject matter. The learning resources and the way the curriculum is executed should be mutually supporting or inter-reliant. The curriculum and learning resources should be developed in a methodical way of executing the learning and developing the educational tools 129 or learning resources that support that desired outcome in order for the course to be effective. Learning mechanisms that support the desired outcome or that provide a methodical way of executing the educational curriculum should be developed. Learning mechanisms that provide a methodical way of executing the curriculum ensures the course can achieve one or more of its course objectives 119. The more systematic, coherent, structured, analytic, or disciplined the curriculum is the better the learning product it will be. Using one framework consistently throughout all aspects of an educational curriculum results in a coherent, unified learning product that is beneficial for participants. This can facilitate enhanced learning. The curriculum development phase 200 diagram can provide the foundation upon which to build an educational curriculum or devices that result in a consistent and unified educational product. Create a learning product that engages learners in active learning or has consistency and smooth flow. Once the key topics 116 and key concepts that will be the subject matter of the course have been chosen, stick with the curriculum development phase 200 diagram plan. Reviewing the curriculum from the mindset of participants may lead to changes, adaptations, additions, or deletions. That leads to a better educational product and is part of the development phase 201. Do not hesitate to delete content, even good content, if it does not meet the intended goals or does not add value. As the educational curriculum is being developed, it may come together in a topic by topic manner. Throughout the development phase 201, there is a need to frequently revert back to make sure the curriculum is still building on the core message. Key topics 116 and concepts need to connect in the right way. You may think the order you have key content 117 in works only to find things are in the wrong order. This is easy to occur when you layer in 112 activities 206, for example, to another learning resource. If key content 112 is in the wrong order, it will seem odd or off to learners. That is a stumbling block for them. Stumbling blocks reduce absorption or retention of learning content 117. These challenges make it hard to facilitate the learning. Sometimes you come up with a great idea, for a game 208 or activity 206, as an example. The initial design looks great. As the development continues you may find that in order for it to be a successful activity 206 or for learners to truly comprehend, there are challenges that cannot be overcome. It may still be a great activity. The challenge may be as simple as the number of participants needed to make it work. Overcome or remove the challenge or delete the activity 206. Remove barriers. If the learning is important enough to be part of the curriculum, devise another way to teach the concept.

Considerable time is invested in developing a curriculum with participants in mind. Step back before getting too far into the development phase 201 and determine what can be done to give educators the necessary tools to provide a beneficial learning experience 113 or facilitate learning. Educators can only work with the learning resources given them; so, give them your best. Educators act as facilitators, discussing subject content, defining content terminology, providing context, and empowering participants through observing and doing action within the learning experience 113 or curriculum that are then used post-course in participants' actual environment, as an example, work environment or other relevant environment 124. In Part 4 of Development Phase II 217, drafting 214 occurs. Drafting can include as many or as few versions and revisions as necessary. Drafting can include drafting content outline of an educational tool 129 or learning resource, initial draft or Draft 1 214A as illustrated in Part 4. Once the curriculum is in written form, it may be necessary to change the flow in places or to add or delete sections so the materials smoothly segue from one area, subject, content, or learning resource to the next. The first draft 214A will enable you to put all the pieces in place. Editing 215 appears as a separate part, Part 5, which is accurate; however, as the arrows demonstrate within the Drafting 214 and Editing 215 portion of curriculum development phase 200 flowchart diagram after each draft version is completed, that draft should be edited. As an illustrated example in the curriculum development phase 200 diagram as exemplified in FIG. 2, following Draft 1 214A editing Edit 1 215A will occur; if revisions, corrections, or other changes are deemed necessary the course content 117 will flow to Draft 2 214B. Each updated draft 214B will likely undergo some editing 215B. Each revision should see a decrease in rewrites and edits. There can be multiple drafts and edits of those drafts. Multiple drafts or edits are not mandatory. Once the updated draft is considered complete, it will flow to Edit 2 215B. This procedure will continue until the curriculum or educational tool 129 is complete, which is illustrated in FIG. 2 as Draft 3 “Final” 214C followed by Final Edit Complete 215C. Once the final complete draft 214C and final edit 215C are complete, the learning curriculum is ready to be implemented, 1002 deployed, launched, or presented.

Proper utilization of the curriculum development phase 200 diagram provides participants with learning opportunities that enable each individual to acquire a self-awareness of key issues or deficiency areas. Developing the curriculum in accordance with the curriculum development phase 200 flowchart diagram can ensure new experiences or extended learning takes place in a fail-safe learning environment. In this particular embodiment, the curriculum development phase 200 flowchart diagram as exemplified in FIG. 2 illustrating the development phase 201 of a learning experience curriculum or the development phase 201 of a curriculum that facilitates learning is delineated.

The curriculum development phase 200 flowchart diagram as exemplarily illustrated in FIG. 2 can be implemented, in full or in part, in one or more phases of the overall design process. Subject matter or contents within the development phase 201 of the curriculum development phase 200 diagram as exemplified in FIG. 2 can be integrated or put into practice in the execution phase 301, creation phase 401, or other design process of a learning experience curriculum.

FIGS. 3-10 and 22-23 are illustrative examples of the proper utilization of the curriculum development phase flowchart diagram as exemplified in FIG. 2.

Following the development phase as exemplified in FIG. 2, which can include a two-step curriculum development phase of active content and passive content comprising the first step and chunking, layering, segmenting, drafting, and editing comprising the second step as illustrated within the curriculum development phase diagram, the standard method for a design process of a learning experience curriculum or the phases for designing, developing, executing, or creating educational curriculum that can exercise a standard method and process continues within the curriculum delivery phase diagram in FIG. 3.

With attention drawn to FIG. 3, an exemplary curriculum delivery phase diagram is presented according to an embodiment of the present subject matter. In this particular embodiment, the curriculum delivery phase diagram illustrating the method of delivering or executing an educational curriculum that employs a standard method and devices for the execution phase within a design process of a learning experience curriculum for facilitating learning that can achieve one or more course objectives or facilitate learning is delineated. The curriculum delivery phase as illustrated in FIG. 3 provides an outline process that can aid in the execution phase of a learning curriculum or can serve as the process or framework for delivering or executing a learning curriculum. The curriculum delivery phase can incorporate systems to facilitate or enhance learning.

FIG. 3 is a curriculum delivery phase illustrating developing or executing an educational curriculum or facilitating a learning experience. It further illustrates how the execution phase 301 can divide elements within predetermined or course specific 310 like or similar classifications and can consider a current knowledge gap 103 hindering performance, who the target audience 104 is, what measurable outcomes of closing a knowledge gap 302 are, and key topics 116 that should be addressed to close the current knowledge gap 103. Key topics 116 can be divided into Topic 1 116A and Topic 2 116B. Each key topic 116 will have a content type 303 component and delivery mode component 304. Key topic 116 content type 303 can be active 205 or passive 213. Active content 205 may be an activity 206, discussion 207, game 208, or simulation 209. Passive content 213 may be a lecture 210, reflection 211, or report out 212. Delivery mode 304 can be learn 305, practice 306, or assess 307. Content mode 303 and delivery mode 304 be can class, group, peer-to-peer, or self-based 308. The content mode 303 and delivery mode 304 can vary throughout the curriculum or learning resources to enhance the target audience 104 measurable outcomes 302 or to lessen the current knowledge gap 103. The curriculum delivery phase 300 is the execution phase 301 in the design process of creating an educational course, content, concepts, or learning resources. Regardless of the key topic 116 or the subject of an educational curriculum, a determination should be made as to the type of learning that will be utilized for the course, content, concepts, and learning resources. First hurdle will be deciding if the course will be a class, training, teaching, seminar, or other event wherein attendees are provided information and possibly learning aids or if it will be a learning wherein pertinent or relevant content on one or more key topics 116 is presented in a format that facilitates learning on the part of students. This curriculum delivery phase 300 provides a learning format. The way the educational curriculum is executed 301 can have a major impact on learning. The curriculum delivery phase 300 should have a defined scope 102 and course design 118 elements as demonstrated in the design phase 101 or adopt a predetermined design phase as exemplarily illustrated in the curriculum design phase 100 diagram as exemplified in FIG. 1. Within our illustrated example curriculum delivery phase 300 exemplified in FIG. 3, the curriculum design phase 100 diagram is adopted in its entirety. This includes the defining scope 102 elements of knowledge gap 103, target audience 104, learning scope 105, standard method/process 106, priority/impact 107, and designing course 118 elements of course objectives 122, key content 117, templates 120, and learning resources. Adoption of predetermined design phases, such as the design and development phases, can include adopting the phase in its entirety or adopting portions determined relevant. Once knowledge gap 103, target audience 104, and learning scope 105 are determined during a design phase 101, those determinations are applicable throughout the design process.

Within our illustrated example curriculum delivery phase 300 exemplified in FIG. 3, the curriculum development phase 200 diagram as exemplified in FIG. 2 is adopted in its entirety. Content 117 is separated into active content 205 or passive content 213; active content 205 is broken into activities 206, discussion 207, games 208, simulations 209; passive content is broken into lecture 210, reflection 211, report out 212. Key topics 116 are chunked into priority based on impact 107, key content is layered by priority based on impact 107, and segments are determined when content is deemed too large for one unit of learning during the development phase 201. The curriculum delivery phase 300 as exemplified in FIG. 3 adopts the pre-determined factors or follows the curriculum design phase 100 diagram exemplified in FIG. 1 and curriculum development phase 200 diagram exemplified in FIG. 2 in building the execution phase 301. Constructing the curriculum delivery phase 300 will entail providing a framework in which one or more elements within the design phase 101 or the development phase 201 are put in perspective as to how to apply or incorporate elements within the execution phase 301. Standard method/process 106 elements should be grouped into a format that allows a methodical utilization or inclusion of said elements in order for classification choices to be made. This can be accomplished by separating similar or like elements into classifications. Those classifications can be placed in separate boxes within the curriculum delivery phase 300 device. As exemplified in the curriculum delivery phase 300 device demonstrated in FIG. 3, a box can include learning types active learning 109, learning experience 113, and interactive learning experience 114; content ratio rules can be within their own box that can include active/passive content ratio rule and 70/30 rule. The Learn/Practice/Assess Protocol should have its own box because it is a mandatory element within a learning experience curriculum for facilitating learning. Choose one or more for each classification within the learning, content ratio rule, and Learn/Practice/Assess Protocol. As the only available option within a box, the Learn/Practice/Assess Protocol will be included in the execution phase 301. A box should be included for course specific 310 elements or other as deemed appropriate. Course specific 310 aspects and Other should always be included within an educational curriculum delivery phase 1002. Items added within this box will be included in choosing one or more for each classification. It is expected those items added during this execution phase 301 will be added if deemed relevant or necessary for inclusion within the curriculum delivery phase 300, although elements thought to be necessary or important may later be determined not to be included. Utilizing the standard method/process 106, one or more of active learning 109, learning experience 113, or interactive learning experience 114 should be chosen; one or more of the active/passive content ratio rule 110 or 70/30 rule 115 should be chosen; the Learning/practice/assess Protocol should be applied; and other criteria as deemed appropriate should be chosen or added. See the Glossary of terms for further definitions for “standard method/process 106, “active learning 109, learning experience 113, interactive learning experience 114, active/passive content ratio rule 110, and 70/30 rule 115.” Defining scope 102 areas can be ascertained or decided. Determining what the current knowledge gap hindering performance 103 is important. An educational curriculum should be designed for delivery to provide learning on key topics 116 and key content 117 that lessen or reduce a knowledge gap 120. Recognizing there is a knowledge gap 103 is often the first step in recognizing key leanings are necessary or that an educational curriculum can be beneficial. There should always be a knowledge gap that needs to be overcome as a basis for every educational curriculum developed. If there is no knowledge gap, there is no need for a course. These considerations will occur early in the contemplation of an educational curriculum and at each stage or phase thereafter. The target audience 104 plays a key role in the course or curriculum delivery phase 300. Determining what are the measurable outcomes of closing the now-known knowledge gap occurs before proceeding in the curriculum delivery phase 300.

Built into the design of an educational curriculum are choices as to the type of learning the curriculum will entail. Choices can be active learning 109, learning experience 113, or interactive learning experience 114. These choices are because the fundamental decision has already been made that this educational curriculum will provide more than a lecture, seminar, training, or the norm. Theoretical learning plays an important part in learning, but practical learning is the fundamental learning tool that provides a learning experience for learners. Theoretical learning is largely comprised of passive content. Theoretical learning content should be sufficient to facilitate learning or ensure learners have the base knowledge upon which to build learning upon. Theoretical learning should be minimal but still facilitate key learning and practical learning should be maximal. Develop learning content and concepts that enable a student to learn with understanding. Ensure the course is not teaching disconnected facts, knowledge, or skills. The learning may achieve one or more learning types. As learning and active participation increase, so does the learning type. Active/passive content plays a major role in how knowledge is received, interpreted, and retained. Active content 205 should be substantial or passive content should be the minimum possible that still facilitates learning. Executing minimal passive content 213 and substantial active content 205 facilitates learning and increases retention. Substantial active content/minimum passive content is referred to as “active/passive content ratio rule.” This is the base level of adequate content ratios that reaches the level of being a learning experience. Practical learning increases active content 205. Increases in passive content 213 lessens knowledge retention. The 70/30 rule 115 should be the target goal of every educational course. Confirmation or validation of achievement of the 70/30 rule should be accomplished by employing a mathematical tool, such as a spreadsheet or other appropriate program or device. In our illustrative working example active/passive content ratio 801 diagram as exemplified in FIG. 8, curriculum or essential topics are entered, corresponding total minutes, active minutes and passive minutes should be entered into the spreadsheet. Using an applicable formula as illustrated in the active/passive content ratio apparatus 802 as exemplified in FIG. 8, total minutes, total active minutes and total passive minutes will be calculated. Applying another formula will calculate the percentage of active content 205 and the percentage of passive content 213 based on the previously entered data. Using a spreadsheet or other tool can ensure the data is correct and validation is accurate. An active/passive content ratio diagram 900 as exemplified in FIG. 9 provides a visualization of the content ratios for each topic or category. Active minutes 901 are displayed in the darker color and passive minutes are displayed in the lighter color. The visualization is an aid to stay on target with content ratios.

For learning to be significant enough to enable personal development, course content should be delivered in a manner that provides participants the greatest chance for success in decreasing their deficiencies in the topic 116. Interactive learning experiences 114 will produce substantial behavioral changes that will lessen, reduce, or close current knowledge gaps 123 when delivered properly. Executing an educational curriculum that meets or exceeds the 70/30 rule 115 as illustrated in the active/passive content ratio 801 diagram as exemplified in FIG. 8 attains or exceeds the threshold of interactive learning experience 114. Look at the big picture first. The execution phase 301 should start with the core classifications that will be applicable regardless of later considerations. Decisions should be made as to what type of learning will be presented to participants. “How” can be the key question. How key concepts will be presented, how key content will be delivered, and how key learning will be executed, validated, or assessed. These are all execution facets that fall within the execution phase 301 of the curriculum delivery phase 300. Executing the educational curriculum key content 117 and learning resources based upon the curriculum delivery phase 300 can elevate the key learning from being a traditional educational course or theoretical learning to active learning 109. A learning experience 113 provides a knowledge-centered environment that encourages learners to reflect on their own learning progress. Participants being actively involved in their personal learning process expedites active learning 109 or enables each participant to find his/her own personal solution to an issue 125 he/she is experiencing. Employing the standard method/process 106 can enable educators to facilitate or assist the progress of active learning 109 by executing regular interactions that actively involve a student in his/her learning process.

Proper execution of developed key content 117 is a major consideration. The Learn/Practice/Assess Protocol 111 can be central to a successful learning environment. It can be the cornerstone of all learning products. See Glossary for “Learn/Practice/Assess Protocol.” Learning experience 113 is the process of learning through experience, which is the process of learning through reflection on doing. Metacognition takes place through a series of actions. Participants must understand or comprehend the subject matter. Educators execute content and tools to guide, direct, or provide a pathway for participants to be able to digest and process information presented. Executing layered on content 112 achieves this. Participants should be given an opportunity to practice the leanings. Practical learning achieves this, enabling learners to achieve self-determined goals and solutions that are relevant or that reduce a knowledge gap hindering performance. Practicing in a fail-safe knowledge centered environment is the appropriate venue to try what each has conceptualized as the key learning being practiced. Providing learners with a sound foundation of relevant learning leads to a learner's awareness and understanding of his/her own thought processes. Learning through reflection on what each learner or participant has practiced is where learning occurs. Interactive learning experience 114 is the highest level of learning that can be achieved. Educators execute series of actions using varying mechanisms to assist participants in learning as knowledge builds. An interactive learning experience 114 should be progressive and cumulative. Interactive participation expedites learners taking ownership of their individual learning experience 113 throughout the development process. This occurs during the educational curriculum but is intended to continue post-course upon returning to their work environment. Practical learning is the mechanism that facilitates curriculum learning and post-course continued learning and development. To be of value, practical learning should be relevant to the student and applicable in the learners' relevant environment 124. In addition to the high-level who, what, when, why factors, how must be addressed. Curriculum delivery phase 300 considers who the target audience 104 is. Adults generally have short attention spans. The curriculum should be designed and developed around best practices for learners so that it is executed or implemented 1002 for maximum benefit. A course or theoretical learning that just talks to or at participants is not appropriate or sufficient. People remember activities 206, relevant examples, or real-life stories. Recognize that learners will not remember everything they are told, but they will remember the activity 206. Activities 206 participants do should be developed so that when executed they are memorable. Activities 206 are where the true learning occurs. Practical leanings are activities 206. Deliver an educational curriculum with these considerations in mind. Curriculum delivery phase 300 considers the current knowledge gap hindering performance 103A. Identify the knowledge gap 103 based on experience, personal interactions, benchmarking, evaluating, or other appropriate mechanisms. Questions that should be contemplated are, “What does this mean? What does that encompass? What all is included”? Determining hindering performance works in reverse. Determine what is going to drive the greatest results and develop accordingly. The educational curriculum must be delivered over a finite time period. It often takes place out of the work or relevant environment 124. Ensure it is developed so that participants have time to receive the educational curriculum as envisioned and developed. The flow should be smooth or segue from one key content 117 to the next. Content should serve as building blocks as learning and layering on content 112 continues.

After lecture 210 and knowledge sharing there is an activity 206. Something of value that must come from that. The educational curriculum supports interactive learning 114 by doing an activity 206 that allows participants to practice 306 what they've just learned 305, making this curriculum is one or more of active learning 109, a learning experience 113, or interactive learning experience. Devise an action or activity 206 for participants to do that they can then take with them after the course has concluded and use post-course upon returning to their relevant environment 124. These are key topics 116. Practicing 306 a concept is not enough. There should be something for participants to do post-course that allows them to continue their development. People learn more when they can relate to it, when it is personal to them, when they have a problem or issue and they are personally working to resolve it. They retain more when they are engaged or the information is interesting, memorable, or different from the norm. Design and develop one or more course objectives 122 with these considerations in mind.

Learning and development are often referred to as though it's one process. These are actually two separate and distinct processes. Learning 305 occurs during active learning 109 or learning experience 113; development happens over time, beginning during the course and continuing after participants are back in their relevant environment 124. That is the experience piece. It is not a one-time fix. Develop learning tools that can accomplish this and ensure participants understand. Curriculum delivery phase 300 considers what measurable outcomes 302 of reducing, lessening, or closing a knowledge gap 120 are. Each piece of the educational curriculum should be methodically designed with the end result always top of mind. You should determine how the participants can have an impact, how to change behavior in a positive way, or other appropriate determinant. Every activity 206, game 208, discussion 207 conversation point, slide, multimedia tool, or learning resource should be developed to drive that outcome.

Curriculum delivery phase 300 considers key topics 116 that should be addressed to reduce, lessen, or close the current knowledge gap 103. Key topics 116 can include one or more topic areas. Each key topic 116 will have the content type 303 component and delivery mode component 304. Delivery mode 304 and content type 303 intersect and interrelate. Key topic 116 content type 303 can be active 205 or passive 213. Active content 205 can be content type 303 that is activity content 206, discussion content 207, game content 208, simulation content 209, or other content that requires an act or action by the participant. Passive content 213 can be lecture content 210, reflection content 211, report out content 212, or other content that does not require an act or action by the participant. Delivery mode 304 can be learn 305, practice 306, or assess 307. Content type 303 and delivery mode 304 can be class, group, peer-to-peer, or self-based 308. Content type 303 and delivery mode 304 should vary throughout the learning to enhance the target audience 104 measurable outcomes 302 or to lessen the current knowledge gap 120 hindering performance 103A. Every word or image within the course can be in the learn mode 305, content type 303, or delivery mode 304. Following learning 305 with one or more activities 206 can enhance active learning 109, that can be followed by an activity 206 wherein each participant applies knowledge learned to his/her relevant environment 124. They learn 305, really know, build on, all before going to next key concept or key content 117. The curriculum can often circle back to earlier key content 117 learned to reinforce key learning. Layering 112 can facilitate learnings on key topics 116, key content 117, or issues. Layering on content 112 can reinforce key learnings during practical learning where a participant can be given a learning opportunity in a fail-safe learning environment. As layering on of content 112 and practice 306 progresses, a learner who is an active participant can gain self-awareness of one or more deficiency areas in his/her skillset or leadership style and take action for impact. Layering on content 112 can continue into reflection 211, where the key learnings become real for a participant. A human mind can only handle so much information at a time. Too much information is a waste of everyone's time because the key content 117 retained is unmeasurable. Layering on content 112 during learn 305, practice 306, and assess 307 modes leading up to a participant's personal reflection 211 and can bring about measurable outcomes 302. The process of layering on content 112 to bring about key learning, as outlined above, can be repeated as many times as necessary to adequately address each relevant concept or key content 117 within a given key topic 116 using applicable modes. Applicable modes can include the lecture 210, discussion 207, learn 305, practice 306, assess 307, reflect 211, as illustrative examples. Lecture 210, which is passive content 213, can address a key concept, key content 117, key topic 116, or subject. Activities 206, games 208, or simulations 209 can facilitate active learning 109, a learning experience 113, or interactive learning experience 114 wherein an active participant becomes emotionally invested or takes ownership of his/her learning and development.

In this particular embodiment, with attention drawn to FIG. 3, the exemplary illustrative curriculum delivery phase illustrating the apparatus and method of delivery of educational curriculum for facilitating learning in the execution phase of the learning product is delineated.

FIGS. 3A, 4, 4A, and 23 are illustrative examples of the proper utilization of the curriculum delivery phase exemplified in FIG. 3.

Following the execution phase as exemplified in FIG. 3, which can include a multi-step curriculum execution phase device, the standard method and apparatus for a design process of a learning experience curriculum for facilitating learning or the phases for designing, developing, executing, or creating educational curriculum continues within the curriculum creation steps outline and form device in FIG. 4. After following the execution phase 301 within the curriculum delivery phase 300, the systems and methods for designing, developing and executing an educational curriculum that can utilize a standard method and process continues in FIG. 4.

With attention drawn to FIG. 4, an exemplary curriculum creation steps outline and form device is presented according to an embodiment of the present subject matter. In this particular embodiment, the curriculum creation steps outline and form and apparatus for executing an educational curriculum that can make use of a standard method and process or a standard method and apparatus for a design process of a curriculum that can achieve one or more course objectives or facilitate learning is delineated. The curriculum creation steps outline and form can incorporate systems to facilitate or enhance learning.

The curriculum creation steps outline and form 400 is the creation phase 401 in the process of creating an educational curriculum. The curriculum creation steps outline and form 400 utilizes the one or more processes 402 and steps 403 that correspond to actions 404 in the process of defining and creating an educational curriculum. The process defining the course 407 upon which the curriculum is to be created can include the steps 403 followed by actions 404 of Step 1a Identify knowledge gap hindering business performance 408 or identify knowledge gap hindering performance, Step 1b Determine target audience 409, Step 1c Define learning scope 410, Step 2a Determine critical topics that must be addressed to close knowledge gap 411, Step 2b Determine best method/process to close the knowledge gap 406, Step 2c Define course objectives 412, Step 2d Choose the delivery method 413, or other steps as deemed appropriate. The steps 403 and actions 404 of creating an educational tool 129 can include Step 3a Create a list of potential topics 415, Step 3b List topics based on priority based on impact 416, Step 3c Create learning objectives for each topic 417, Step 3d Define key concepts for each topic 418, Step 3e Conduct research/benchmarking to identify existing content that may be available in the market 419, Step 3f Determine the desired length of course 420, Step 4a Determine the logical order/flow of materials 421, Step 4b Outline proper chunking of content 422; Step 4c Draft content outline 423, Step 4d Create educational tool draft one 424, Step 4e Determine what support materials are needed to aid learning 425, Step 4f Create support materials for outlined content 426, Step 4g Create support materials for outlined content 427, Step 5a Educational tool draft one complete 428, Step 5b Edit educational tool draft one 429, Step 5c Make necessary adjustments to core content including content flow and support materials 430, Step 5d Educational tool draft two reviewed by editor 431, Step 5e Final educational tool complete 432, or other steps as deemed appropriate. There is no limit to the number of drafts 214 or edits 215, it will be as many or as few as needed to create a finished educational product. The agenda 443 should be finalized after this process 402. The steps 403 and actions 404 of creating a multimedia tool 433 can include Step 6a Choose facilitator multimedia tool 434, Step 6b Create facilitator multimedia tool 435, Step 7a Multimedia tool draft one complete 436, Step 7b Edit multimedia tool draft one 437, Step 7c Make necessary adjustments to multimedia tool 438, Step 7d Cross reference educational tool and multimedia tool for consistency 439, Step 8a Multimedia tool draft two reviewed by editor 440, Step 8b Final multimedia tool complete 441, Step 8c Calculate estimated delivery time based on finalized content 442. The agenda 443 should be finalized after this process.

Learning resources include one or more educational tools 129, multimedia tools 433, supporting aids, or supporting materials, as illustrative examples. See Glossary of terms for a more detailed definition of “learning resources.” All support materials should be created one at a time, not simultaneously. This will create conformity in the overall learning product. Support materials should all align with the primary educational tool 129, which will typically be coursework, textbook or workbook that learners receive. Factoring in the format and key contents 117 within the primary educational tool 129 from the initial creation of support tools or learning resources will save time and be a cost savings. The steps 403 and actions 404 of creating an agenda 420 can include Step 9a Draft course agenda 444, Step 9b Make necessary adjustments to content and/or agenda to fit into the time allotted for course 445 Step 9c Finalize course agenda 446, or other steps as deemed appropriate. Making necessary adjustments to content and/or agenda to fit into the time allotted for the course 430 is important. If content 117 or agenda 443 does not fit into the time allotted for the course, make necessary adjustments during the creation phase 401. The course has an allotted time and if there is too much content 117 or the agenda 454 is too big, the course will conclude without potentially vital learning being provided. Calculate estimated delivery time based on the finalized content 442 and adjust as necessary to fit within the timeline. In coordinating educational tools 129 and learning resources, ensure the educator has an estimate of how long each portion of the learning is expected to take. This will keep the course on schedule and enable the content 117 and/or agenda 443 to fit within the allotted time for the course. The agenda 454 steps 403 and actions 404 are of importance and should not be overlooked or minimized. Adjustments to content and/or agenda must be done with careful attention. The curriculum, including the primary educational tool 129 and all supporting materials or learning resources, must be able to be executed from beginning to conclusion in the time allotted. If timing, flow, or other considerations in executing the agenda 443 are overlooked or not adequately addressed, time could run short and there not be sufficient time to facilitate learning for the entire course in its final form. Making necessary adjustments before the course is executed enables making revisions in content 117 that will have a lesser impact than simply running out of time and participants have a hard stop wherein key content 117 with a greater impact or the most important learning yet to come cannot be delivered. It is the content creator's duty to exercise due diligence to ensure that does not occur.

The curriculum creation steps outline and form 400 as exemplified in FIG. 4 can apply, in whole or in part, one or more of the design phase 101 as laid out in the curriculum design phase 100 diagram as illustrated in FIG. 1, the development phase 201 as laid out in the curriculum development phase 200 diagram as illustrated in FIG. 2, the execution phase 301 as laid out in the curriculum delivery phase 300 diagram as illustrated in FIG. 3, or other design, development, or delivery process or tool as deemed appropriate when creating the curriculum. Utilizing relevant tools already created may avoid rework of work that has already been completed. The curriculum includes learning resources, such as educational tools 129 and multimedia tools 433. The curriculum creation steps outline and form 400 device adopts the design phase 101 as laid out in the curriculum design phase 100 diagram as illustrated in FIG. 1, the development phase 201 as laid out in the curriculum development phase 200 diagram as illustrated in FIG. 2, the execution phase 301 as laid out in the curriculum delivery phase 300 diagram as illustrated in FIG. 3 in our illustrated example as exemplified in FIG. 4. Paying close attention to the primary educational tool 129 during the creation of learning resources or study aids will ensure the fit of the support materials for the purpose for which they are being created. Creating support materials or learning resources for outlined content by chunking 202, layering on content 112, and segmenting 204 can facilitate active learning 109, a learning experience 113, an interactive learning experience, or create a cohesive learning device that segues from one key topic 116 to the next for ease of understanding and comprehension. The creation phase 401 can include making necessary adjustments to core content including content flow or support materials. When creating the curriculum, the standard method/process 106 should serve as the guide when creating the curriculum. The standard method/process 106 can assist in providing consistency or aid in achieving curriculum objectives or course goals. Segmenting 204 course curriculum and tools into digestible pieces, chunking 202 course learning and learning resources into key topics 109 based on impact, or the process of layering on content 1100 as exemplified as FIG. 11 into building blocks of learning 305 can be the framework to facilitate one or more efficacy, desired, or effective outcomes. Effective, efficacy or desired outcomes should be the course objectives 122. Course objectives 122 include one or more of reducing or lessening a knowledge gap 123, increase content knowledge 126, learn or improve a competence 128, drive behavioral change 127, a course specific 310 desired outcome, or other benefit.

The curriculum creation steps outline and form 400 as exemplified in FIG. 4 is device that provides a text outline that explains the step-by-step guide for the curriculum creation phase 401 in a word format and provides a check the box form within the outline to indicate when steps 422 within the process 424 are complete 405 that can be used to ensure all steps and elements in the creation of curriculum and supporting tools are addressed. In this particular embodiment, with attention drawn to FIG. 4, the exemplary illustrative curriculum creation steps outline and form illustrating the apparatus and method of creation of educational course, content, and learning resources for facilitating learning in the creation phase of the learning product is delineated.

FIGS. 1-9 and 22-23 are illustrative examples of the proper utilization of the design process of a learning experience curriculum as exemplified in FIG. 10.

FIGS. 4A, and 23 are illustrative examples of the proper utilization of the curriculum creation steps outline and form exemplified in FIG. 3.

FIGS. 1A-23 are illustrative examples of the proper utilization of the layering on content process as exemplified in FIG. 11.

### ILLUSTRATIVE EXAMPLES

By way of example and not limitation, the following paragraphs provide an illustrative example of a curriculum design phase within a design process.

With attention drawn to FIG. 1A, an exemplary illustrative example of the proper utilization of the curriculum design phase exemplified in FIG. 1 is presented according to an embodiment of the present claimed subject matter. In this particular embodiment, the curriculum design phase illustrative diagram illustrating the method of designing an educational curriculum that utilizes a standard method and devices for the design phase within a design process of a learning experience for facilitating learning that can achieve one or more course objectives or facilitate learning is delineated.

The curriculum design phase 100A illustrative diagram as exemplified in our illustrative example in FIG. 1A adopts the design phase 101 of the curriculum design phase 100 as exemplified in FIG. 1. Based on the criteria within the curriculum design phase 100, course specific 310 determinations are made based on the subject matter to be developed. Following a standard method/process 106 built as the foundation of the design phase 101 within the design process of a curriculum or the design process of a learning experience curriculum 1000 ensures a cohesive learning environment throughout all facets of a curriculum. Within our illustrative example as demonstrated in the curriculum design phase 100A illustrative diagram exemplified in FIG. 1A, an element within defining scope 102 is the standard method/process 106. Applying the standard method/process 106 guidelines, factors within the design phase 101 as exemplarily illustrated in FIG. 1A are active learning 109, active/passive content ratio rule 110, Learn/Practice/Assess Protocol 111, layering content 112, learning experience 113, interactive learning experience 114, 70/30 rule 115, relevant environment 124, and issue/real solution 125. Within our illustrative example as demonstrated in the curriculum design phase 100A illustrative diagram exemplified in FIG. 1A, an element within designing course 118 is one or more course objectives 122, which can include one or more of increase content knowledge 126, drive behavioral change 127, learn or improve a competence 128, or other benefit.

In this particular embodiment, with attention drawn to FIG. 1A, the exemplary illustrative curriculum design phase 100A illustrative diagram demonstrating the apparatus and method of delivery of educational curriculum for facilitating learning in the design phase of a curriculum or curriculum design process is delineated.

FIG. 1A is a demonstrative example of the proper utilization of the curriculum design phase 100A illustrative diagram exemplified in FIG. 1A.

By way of example and not limitation, the following paragraphs provide an illustrative example of an execution phase within a curriculum delivery design process.

With attention drawn to FIG. 3A, an exemplary illustrative example of the proper utilization of the curriculum delivery phase exemplified in FIG. 3 is presented according to an embodiment of the present claimed subject matter. In this particular embodiment, the curriculum delivery phase illustrative diagram following the apparatus and method of the curriculum delivery phase of the educational course, content, concepts, and supporting learning resources or curriculum that can utilize a standard method and process that can achieve one or more course objectives or facilitate learning in the curriculum delivery phase of a learning product is delineated.

The curriculum delivery phase 300A illustrative diagram as exemplified in our example in FIG. 3A adopts the execution phase 301 of the curriculum delivery phase 300 as exemplified in FIG. 3. Based on the criteria within the curriculum delivery phase 300A, course specific 310 determinations are made based on the subject matter to be developed. The execution phase 301 can adopt the standard method/process 106. Following a standard method/process 106 built as the framework of this development process 300 can ensure a cohesive learning environment throughout all facets of a curriculum. The standard method/process 106 determines the relevant environment 124 and presents classification elements. Classifications should be separated into like or similar elements. In our illustrative example as exemplified in FIG. 3A, a classification includes active learning 109, learning experience, 113, and interactive learning 114; another classification includes active/passive content ratio rule 110 and 70/30 rule 115; another classification includes Learn/Practice/Assess Protocol 111; and yet another classification includes course specific 310, issue/real solution 125, relevant environment 124, and other. Choose one or more from each classification. Changing content, delivery, and practical learning variations keep the curriculum more interesting or can prevent boredom. In this particular embodiment, with attention drawn to FIG. 3A, the exemplary illustrative curriculum delivery phase 300 illustrating the apparatus and method of delivery of educational course, content, and learning resources for facilitating learning in the execution phase a design process of a learning experience curriculum for facilitating learning is delineated.

FIGS. 4, 4A, 22, and 23 are illustrative examples of the proper utilization of the curriculum delivery phase as exemplified in FIG. 3A.

FIG. 4A is an illustrative example of the proper utilization of the curriculum creation steps outline and form exemplified in FIG. 4

After following the curriculum creation steps outline and form, the systems and methods for designing, developing, executing and creating an educational curriculum that can utilizes a standard method and process continues as an illustrative example in FIG. 4A.

With attention drawn to FIG. 4A, an exemplary illustrative working example of the proper utilization of the curriculum creation steps outline and form exemplified in FIG. 4 is presented according to an embodiment of the present claimed subject matter. In this particular embodiment, the participant workbook creation steps outline 447 illustrating the apparatus and method of creating an educational curriculum for facilitating learning in the creation phase 401 of a participant workbook learning product or primary educational tool 129 is delineated. The participant workbook creation steps outline 447 as exemplified in FIG. 4A can implement a course specific 310 curriculum creation phase utilizing the creation phase 401 within the curriculum creation steps outline and form 400 as exemplified in FIG. 4. The participant workbook creation steps outline 447 applies the creation phase 401 educational tool 129 steps 403 and actions 404 in creating a participant workbook creation steps outline 447. The course creator has discretion to use any, all, or none of the actions 404 within the creation phase 401 in whole or in part. The participant workbook creation steps outline 447 can adopt, implement, or apply design phase 101 as exemplified in FIG. 1, the development phase 201 as exemplified in FIG. 2, the execution phase 301 as exemplified in FIG. 3, or other design phase as deemed appropriate, in whole or in part. Determine appropriate actions 404 for the creation of the educational tool 129. The participant workbook that is being created is determined to be the primary educational tool 129 for purposes of illustrative example as exemplified in FIG. 4A in this particular embodiment.

The participant workbook creation steps outline 447 steps 403 and actions 404 takes the steps 403 and actions 404 of 1 Adopt and apply appropriate curriculum design phase 448, 2 Implement course development process 449, 3 Apply course delivery/execution process 450, 3a Create a list of potential topics 415, 3b List topics based on priority based on impact 416, 3c Create course learning objectives for each topic 417, 3d Define key concepts for each topic 418, 3e Conduct research/benchmarking to identify existing content that may be available in the market 419, 3f Determine the desired length of course 420, 3g Implement standard method/process 456, 3h Adopt and regulate active/passive content ratio 457, 4a Determine the logical order/flow of materials 421, 4b Outline proper chunking of content 422, 4c Implement Learn/Practice/Assess Protocol 422, 4d Draft content outline 424, 4e Create participant workbook Draft 1 214A 451, 4f Determine what support materials are needed to aid learning 426, 4g Create support materials for outlined content 427, 5a Participant workbook Draft 1 complete 452, 5b Edit participant workbook Draft 1 453, 5c Make necessary adjustments to core content including content flow and support materials 430, 5d Participant workbook Draft 2 reviewed by editor 454, and 5e Final participant workbook complete 455.

FIGS. 1, 1A, 2, 3, 3A, 4, 4A and 10 are illustrative examples and FIGS. 3A, 5, 6, 7, 22, and 23 are illustrative working examples of the proper utilization of the Design process of a learning experience curriculum within the design process of a learning experience curriculum for facilitating learning as exemplified in FIG. 10.

With attention drawn to FIG. 22, an exemplary course evaluation device is presented according to an embodiment of the present subject matter. In this particular embodiment, the apparatus for creating a course evaluation is delineated.

Once the learning program has been implemented, evaluations and feedback should be collected. Chronicle information obtained. If a given subject area or content receives substantial poor or less than satisfactory ratings, re-evaluate the curriculum starting at the design phase 101. Refine, improve, or adapt learning lessons as necessary. The course evaluation 2200 is an evaluation tool specifically devised, developed, built, and created for implementation of a post-course evaluation form. Designing the course evaluation 2200 form entails determining an appropriate efficacy outcome for the learning experience curriculum. Determine an applicable mechanism for the course evaluation 2200 based on the appropriate efficacy outcome. The evaluation form should be contained within the confines of a single page when possible. It should have a coordinated flow that is easy to follow. The evaluation form 2200 should be clear, concise, and relevant. A check the box answer is appropriate. Choices can be one or more. The answers can be a numbering system, an agree/disagree system, written answers, or other appropriate system. Written answers have been found to have the lowest completion or return rate. As illustrated in the Course Evaluation 2200 as exemplified in FIG. 22, the system utilized contains four choices, with the choices being strongly disagree, disagree, agree, strongly agree. General information that should be within in the course evaluation 2201 include educator or trainer's 2202 name, class location 2203, and date 2201 of course. Evaluation criteria can be statements, questions, or other criteria deemed appropriate. For ease in reviewing the evaluation form, subject areas can be separated into smaller sections. Overall 2208 considerations can include the following, as exemplified in our working example course evaluation 2200 as illustrated in FIG. 22. The content was relevant to my role as a leader 2209, I learned skills that will help me in my role as a leader 2210, I would recommend this course to my friends and colleagues 2211, I am happy that I attended this course 2212. Response choices in our illustrated example include strongly disagree 2204, disagree 2205, agree 2206, strongly agree 2207. Instructor 2202 related questions in our illustrated example include How would you rate the instructor in the following areas? 2213, Encouraged participation and interaction 2214, Explained concepts clearly 2215, Managed the time and pace well 2216, Used engaging stories/examples to illustrate course concepts 2217, Was enthusiastic and energetic 2218, Was knowledgeable about the subject matter 2219, Was organized and prepared 2220, I would recommend this instructor to my friends and colleagues 2221. Course 2222 related questions in our illustrated example include How would you rate the course in the following areas? 2223 Activities, exercises, and discussions were effective 2224, Content was organized and easy to follow 2225, Course materials were helpful 2226, There was a proper mix between lecture, discussion, and activities 2227; As a result of this course, I have improved my capabilities as a leader in the following areas 2228: Career Conversations 116H, Development Planning 1161, Employee Engagement 116B, Partnership(s) 116D, People Leadership 116A, Performance Management 116J, Retention and Turnover 116K, Succession Planning 116G, Talent Acquisition 116F, Talent Management 116E, and Trust and Respect 116C; Based on my holistic learning experience, I would attend another training held by (company name).

It would be appropriate to ask a few relevant questions as to future courses 2230, other topics of interest 2236, or other areas deemed appropriate. Interest in future training and content areas should be ascertained. If you have additional trainings under consideration or in development, ask participants if they would be interested in attending a future training that covers subjects such as [list]. It may be beneficial to include “(select all that apply)” before listing potential future courses. Boxes to check if a participant has an interest in attending additional trainings or courses is appropriate. So as not to unduly bother participants after course completion, their input should be sought as to if they would like to be informed when additional courses are released. If participants' continued feedback and assistance is requested, a question that first states the specifics and then requests their participation should be included in the course evaluation. In our illustrative example as exemplified in FIG. 22, there was a question as to a participant's interest in participating in a research study 2231, if the learner would like to be informed when additional courses are released 2232, a request for pertinent information if the learner responded “yes” to an above question, and a line to insert name 2234 and email 2235. If a participant responds “yes” to the research question or additional questions, his/her name should be requested. Note: These inputs have a specific purpose. Utilize information and feedback for those purposes and not to create a contact list. Create the first draft of the course evaluation 2200 form. Edit the first draft. Complete additional drafts and edits until the final draft and edit are complete. The course evaluation 2200 is ready to be implemented. Cross-reference the course evaluation 2200 form against course content and learning resources to ensure relevant aspects of the course deserving evaluation are included therein. Advise the educator as to how and when the course evaluation 2200 is to be presented to learners. Provide adequate or appropriate instructions in the course evaluation 2200 delivery. Instruct the educator on the proper method of receiving completed course evaluation 2200 forms back from a learner. Implement the course evaluation. Analyze and interpret course evaluation data obtained post-course. Course evaluation may lead you to determine adjustments, revisions, corrections, or other appropriate action is necessary based on course evaluations 2200 returned. Evaluations can provide input for future curriculum development. Conduct a post-course feedback session with the educator to discuss feedback, concerns, and pertinent information. This post-course feedback session with the educator should discuss course evaluation results. Provide positive feedback when deserved. Address opportunity areas with the educator should one or more exist. Review the analytics as course evaluations continue to be returned to ensure the course achieves one or more of its goals or that the educator is facilitating learning. Promptly address any less than satisfactory evaluation deemed accurate or appropriate to correct the less than satisfactory element.

The object of an embodiment is to provide an apparatus and process for a novel design process of a learning experience curriculum facilitating learning. Learners come into a course specific learning environment with problems, issues, concerns, and experiences searching for solutions. The Design process of a learning experience curriculum promotes key learnings by educators facilitating a transfer of knowledge that leads learners to discovering their own solutions so they can implement similar actions upon returning to their relevant environment or work environment. Content and concepts are presented facilitating learning. Through a transfer of knowledge and key learning presented within the curriculum learners formulate real solutions to their own issues. Learners then choose their own applicable issue, experience, or other relevant consideration to apply the key leanings. There are no right or wrong answers. As an illustrative example, after applying their real-life scenario based on an employee in their actual work environment at their real workplace to the subject at hand during the practice mode, learners assess what they have done and how they have done it to decide if they have implemented a real solution. Learning continues following the layering on content process followed with practice and assess before moving to the next key topic or content. Participants bring in their own personal work or relevant issues and leave with real solutions. Learning resources are valuable tools that present a visual representation of an involved concept or considerable concept in a medium that learners comprehend and process. The educational curriculum created implementing the Design process of a learning experience curriculum 1000 creates a relevant educational program of study full of introspection, reflection, and self-discovery.

Another object of an embodiment is to provide relevant templates developed for post-course use by learners as they continue their learning and development in their real-life environment. Building a curriculum that incorporates relevant lessons in which learners perform the work within the templates in a fail-safe environment during the course builds confidence in their capability and provides comprehension as to the appropriate course of action needed. Online download links to the templates make them readily available for learners continued use and enhance the probability that course participants will continue utilizing them. This curriculum design process provides a firm foundation upon which to build a relevant, coordinated, consistent educational curriculum. Layering in content, adhering to the Learn/Practice/Assess Protocol, and applying appropriate content ratio rules within the design process of a learning experience curriculum facilitating learning enhance learning, increase retention, overcome formerly unmet needs, and heighten learning to the threshold of learning experience.

### DETAILED DESCRIPTION—FIG. 23—THIRD EMBODIMENT

With attention drawn to FIG. 23, an exemplary architecture and demonstrative working illustration of a practical learning card game that forms the basis of the third present embodiment utilizing the method of designing, developing, executing, and creating an educational tool 129 or learning resource following the method and steps as illustrated in FIG. 4 as adopted from FIGS. 1-4 is presented according to a first working example of a third embodiment of the present subject matter. The first working illustration as demonstrated in the Dynamic Leadership Practical Learning “What are you willing to give?” card game shows an exemplary example implementation within the present application.

A game 208 is a learning resource, active content, and an activity. It should exhibit a coordinated flow with other learning resources within the course. Ensuring a concise, coordinated flow of learning and resources will enhance the type of learning each participant receives. Dynamic Leadership Practical Learning 2300 “What are you willing to give?” 2301 card game will hereinafter be referred to as “practical learning card game 2300.” A practical learning card game 2300 aids in making a curriculum one or more of active learning 109, a learning experience 113, or an interactive learning experience 114, as this is active content 205. It is an activity 206 in which participants are applying real-world practice to formulate their own key learning and takeaways. The determination as to the type of active learning is proportionate to the level of active participation a student imparts into such learning. The practical learning card game 2300 is one component that will be included in the active/passive content ratio upon which a final determination will be made as to active learning 109, learning experience 113, or interactive learning 114. An illustrative determination or validation as to active/passive content ratios is demonstrated in the active/passive content ratio diagram 801 as exemplified in FIG. 8 and a visual representation of the active/passive content ratios is illustrated in the active/passive content ratio diagram 901 as exemplified in FIG. 9. The practical learning card game 2300 is included within the applicable topic section.

A practical learning card game 2300 as exemplified in FIG. 23 that is utilized for the purpose of supplementing learning or as a learning resource can utilize the design process of a learning experience curriculum 1000 for facilitating learning, in whole or in part, to ensure consistency and flow among content and learning resources. This will cut down on rework since key determinations have already been made that are applicable to this Practical Learning card game 2300. Course specific considerations may be predetermined when a supplemental learning resource, such as the practical learning card game 2300 as exemplified in FIG. 23, utilizes a relevant curriculum design process. Take advantage of work already done to save time and expense. The standard method/process 106 should be followed through all phases of the design phase 101 in devising the practical learning card game 2300. The Practical Learning card game 2300 should be developed with substantial consideration given to the active/passive content ratio rule 110. The practical learning card game 2300 as exemplified in FIG. 23 adheres to the Learn/Practice/Assess Protocol 111 as practical learning is the “practice 306” portion of the Learn/Practice/Assess Protocol 111. The practical learning card game 2300 layers content within the card game and learning is layered on 112 among a plurality of learning resources, including the practical learning card game 2300.

The practical learning card game 2300 of the present embodiment as shown in FIG. 23 is comprised of one set of cards 2323 per participant. For ease of understanding in this specification, the side of the card on which the word or phrase appears in the midsection of the card shall be regarded as the face side 2302 of the card and the opposite side shall be regarded as the back cover 2301. The cards can be comprised of any suitable material, including card stock paper. Cards should be uniform in size and shape. Due to the amount of information contained on each card, a small card is sufficient. In our illustrated example as exemplified in FIG. 23, each card is 3×3 inches in size. A square card presents well. Each set of cards 2323 has a variety of cards wherein each card has a back cover 2301 and a face side 2302. The back cover 2301 should exhibit the artwork displaying on the primary educational tool 129. The title of the practical learning card game 2300 should be presented in the same font, colors, and design as the primary educational tool 129. The primary educational tool 129 artwork should be incorporated into the practical learning card game 2300 back cover 2301 in its entirety if feasible. This will reduce rework and provide a consistent look and feel. Modifications from the primary educational tool 129 should complement the artwork. In our working illustration as exemplified in FIG. 23, the cover exhibits the primary educational tool 129 Participant Learning Experience Workbook 500 cover that is modified to display the topic of the card game, which is Practical Learning 2317 further chunked into “DLX game” 2319 to advise participants what is contained therein. DLX 2320 is the acronym for Dynamic Learning Experience. The subtitle and company's mission of “Improving Lives One Leader at a Time” 2318 appears on each card as it appears on the cover of the primary educational tool 129 as exemplarily demonstrated in the Participant Learning Experience Workbook cover page 501 as exemplified in FIG. 5. The face side of each card should include a copyright notice 2322 at the bottom if applicable. Above the copyright notice further information to add activity title or other relevant content to provide participant context should appear. In our working illustration practical learning card game 2300 as exemplified in FIG. 23, a DLX activity 2321 appears above the copyright notice. This puts context in the activity 206 that is about to take place. The educational tool 129 is course specific 310. Each card within the set 2323 will bear a word or phrase in the midsection of the card. This word or phrase should be relevant and appropriate to the subject matter participants are being instructed to base their determinations upon. As working examples exemplified in the Practical Learning card game in FIG. 23, Extra Effort 2303, Unsolicited Input 2304, Support 2305, Personal Sacrifice 2306, Advice 2307, Necessities 2308, Feedback 2309, Trust 2310, Empathy 2311, Suggestions, 2312, Respect 2313, Acceptance 2314, Positive Attitude 2315, and Reply to Request 2316 are illustrative examples. The quantity of cards per set can be any number deemed appropriate. Quantity should be determined by the complexity of learning being conveyed and the time allotted to complete the activity 206. Each participant will receive a set of cards 2323. No card within a set of cards 2323 is duplicated.

A practical learning card game 2300 within a curriculum or learning experience 113 is designed, developed, executed, and created to be a counterpart or an accompaniment to the educational curriculum. Its purpose is to facilitate active learning 109 through an activity 206. The participant's initial thoughts and plans can evolve as learning builds through practical learning activities 206 such as the practical learning card game 2300. Introducing a practical learning card game 2300 that is repetitive yet changeable or that provides opportunity for participants to apply new learning can facilitate enhanced learning. Appropriate instructions commensurate with one or more course objectives 122 should be given. Determine the time to be allotted for each portion of the activity.

Each learner should receive a set of cards 2323. The educator or facilitator should instruct learners on how the practical learning card game 2300 is played. The educator should follow the guidelines within the multimedia tool 433. The educator should facilitate participants carrying out the activity 206 by asking a question or making a statement upon which the participants are to respond by utilizing the set of cards. The educator should be mindful of time allotted for each section of the practical learning card game 2300 and the amount of time each round of the practical learning card game 2300 is taking.

The practical learning card game 2300 portion of the curriculum should be included within the multimedia tool 433. This practical learning card game 2300 is a learning resource specifically created to facilitate learning on the subject of Employee Engagement within our exemplary illustrative working example as exemplified in FIG. 23. Employing process of layering content 1100 as exemplified in FIG. 11, the practical learning card game 2300 should appear within the facilitator guide, as illustrated in the facilitator guide excerpt 601 on Slides 28-32. The facilitator guide excerpt 601 should include this practical learning card game 2300 activity 206 with a correlation to the multimedia tool 433, time allotted for the activity 206, and instructions. Per instructions within the facilitator guide excerpt 601 as exemplarily illustrated in our working facilitator guide excerpt 601 in FIG. 6, at Page 19, the educator should advise that, “Each participant has a small stack of cards at his/her table that contain a word or a statement.” Participants should also learn what the cards represent or what they are expected to do with the set of cards 2323.

In a learning curriculum for leaders and members of management, as exemplarily illustrated in our working example, the Dynamic Leadership Presentation in FIG. 7, on Slide 27 702A the educator will advise participants that, “These cards represent something that you are willing to do or provide based on how you feel about your leader. (How engaged you currently are)” Approximately one minute should be sufficient time for this portion of the activity 206 as exemplified within the facilitator guide excerpt 601 in FIG. 6. The multimedia tool 433 slide should advance to Slide 28 702B and the educator should instruct participants to, “Sort through the cards and pull out each of the cards that represent what you are willing to give when you never feel valued, appreciated, and empowered.” The method of enabling students to see and hear key learning can accommodate two of the three preferred methods of learning, which are seeing and hearing. The third preferred method of learning, which is doing, should also be included. Doing should occur as the next action. Participants should be given time to sort through the cards and make their choices. Each should make a mental or physical note of the size of their stack or the number of cards they chose. This portion of the activity should take approximately two minutes, as indicated on Page 20 of the facilitator guide excerpt 601 as exemplified in FIG. 6. The multimedia tool 433 slide should again advance, now to Slide 29 702C. The educator should instruct participants, “Now pull out all the cards that represent what you are willing to give when you feel that you are sometimes valued, appreciated, and empowered.” Learners should be given time to sort through the cards and make their choices. Each should make mental or physical note of the size of their stack or the number of cards they chose. This portion of the activity should be allotted approximately two minutes to complete, as illustrated on Page 21 of the facilitator guide excerpt 601 as exemplified in FIG. 6.

Participants should then play yet another round within the practical learning card game 2300. In conjunction with the applicable slide within the illustrative working example within the facilitator guide excerpt 601 as exemplified in FIG. 6, Slide 30 702D within the multimedia tool 433, the educator should ask participants, “Now, which cards represent what you are willing to give when you feel fully valued, appreciated, and empowered? Participants should be given time to sort through the cards and make their choices. Each learner should make mental or physical note of the size of their stack or the number of cards they chose. This portion of the activity should be allotted approximately two minutes to complete, as illustrated on Page 21 of the facilitator guide excerpt 601 as exemplified in FIG. 6. In our illustrative example as exemplified in FIG. 23, participants completed three rounds of cards. The number of rounds could be more or less. Three was deemed appropriate in our illustrative example Practical Learning card game 2300 as exemplified in FIG. 23 because the learning was based on never, sometimes, or fully feeling valued, appreciated, and empowered. The number of rounds will depend on the complexity of the subject matter and the learning being conveyed. While there could be many more rounds, the purpose is to supplement learning with an activity 206 that engages participants in their own individual learning. Time is limited, so only include an activity for the minimal time needed to facilitate learning.

It is possible to play more than one Practical Learning card game 2300 during a course; however, it is not advisable. The initial time participants complete the practical learning card game 2300 is it new and novel, which can pique their interest. Once they have completed that activity 206, it is wise to impart an activity 206 that presents ideas or challenges in a new or different way. This practical learning card game 2300 is intended to be played by individual learners. Participants can make their choices in the practical learning card game 2300 based on each participant's leaders to enhance learning or make learning personal. Now that participants have learned 305 key content 117 within the key topic 116, practiced 306 the practical learning card game 2300 activities 208, and assessed 307 the differences in their valuations of the given subject matter, it is time to layer on content 112 with new or additional key leanings. Segueing from the practical learning card game 2300 to the next layered content 112, the facilitator and coordinated learning resources transfer knowledge highlighting the key leanings from the activity 206. The activity 206 should be followed by shared knowledge as to its relevance. As illustrated in the facilitator guide excerpt 601 working example as exemplified in FIG. 6 at Page 21 that, “Your employees will give more of themselves when they feel that you value them, appreciate their contribution, and empower them to make a difference.” This practical learning card game 2300 has no right or wrong answers. The seemingly innocuous game of cards as exemplarily illustrated in FIG. 23 engages participants in determining how a leader's actions affect Employee Engagement. An activity 206 such as these rounds of cards is memorable because participants are able to relate to the subject matter and form decisions based on their real-life, relevant 124, or work environment.

The practical learning card game 2300 should take less than 10 minutes to complete. Design, develop, execute, and create content 117 and activities 206 that can be completed within the time allotted. This fast-paced activity can be memorable versus passive content 213. In coordination with the multimedia tool 433 as illustrated in the Dynamic Leadership presentation 701 as exemplified in FIG. 7, at Slide 32 702E, the facilitator shares knowledge also presented in a visual medium within the multimedia tool 433 that, “Your employees will give you more of themselves when they feel that you value them, appreciate their contribution, and empower them to make a difference.”

Within a learning experience curriculum for facilitating learning, the practical learning card game 2300 would not appear within the primary educational tool 129 or participant workbook. This practical learning card game 2300 serves the purpose of educators facilitating participants learning relevant content and concepts. Once learners have acquired that core knowledge, learning continues. Participants will not need to refer back to the learning just acquired during the practical learning card game 2300; therefore, it does not belong in the primary educational tool 129 for post-course use. Once the creation phase 401 of the practical learning card game 2300 is done, it should be cross referenced it against all other learning resources to ensure all aspects of the curriculum follow the same flow. The more cohesive the curriculum process and apparatus are, the better the learning product will be. If the flow does not work, go backward, making adjustments as needed so all learning resources or educational tools flow.

FIG. 23 is an illustrative example of the proper utilization of the design process as exemplified in FIGS. 1, 1A, 2, 3, 3A, 4, 4A, and 10. Further FIG. 23 is an illustrative example of the proper utilization of the process of layering content as exemplified in FIG. 11.

### ILLUSTRATIVE EXAMPLE

In this particular embodiment, with attention drawn to FIG. 5, the exemplary illustrative working example of the proper utilization of the Participant Learning Experience Workbook cover page illustrating its incorporation into the practical learning card game is delineated.

The apparatus for a practical learning card game 2300 as illustrated in FIG. 23 determined the back cover 2301 of the set of practical learning game cards 2323 should exhibit the artwork displaying on the primary educational tool 129. Our illustrative working example Participant Learning Experience Workbook cover page 501 as exemplified in FIG. 5 is the primary educational tool 129 within our illustrative curriculum. The primary educational tool 129 artwork should be incorporated into the practical learning card game 2300 back cover 2301 in its entirety, reducing rework and providing a consistent look and feel. In this particular embodiment, with attention drawn to FIG. 5, the exemplary illustrative working example Participant Learning Experience Workbook cover page 501 illustrating its proper incorporation into the practical learning card game 2300 is delineated.

FIG. 6 is an illustrative example of the proper incorporation of a learning resource facilitator guide excerpt into the method and apparatus of a Practical Learning card game as exemplified in FIG. 23.

In this particular embodiment, with attention drawn to FIG. 6, the exemplary illustrative working example of the proper incorporation of the process of layering of content 1100 between multimedia tool 433 and the practical learning card game 2300 as demonstrated in the facilitator guide excerpt 601 as exemplified in FIG. 6 and the practical learning card game 2300 as illustrated in FIG. 23. Images within the facilitator guide excerpt 601 at images representing Pages 18, 19, 20, and 21 provide a visual representation of the coordination and unity of a coordinated and consistent educational product, practical learning, and layering content 112 between the learning resources herein. With attention drawn to FIG. 6, the exemplary illustrative working example facilitator guide excerpt 601 exemplifies the proper incorporation of content, active learning 109, and a plurality of learning resources into the curriculum of a learning experience curriculum for facilitating learning by layering content 112 within and among multiple educational tools within the Practical Learning card game 2300 is delineated.

FIG. 6 is an illustrative example of the proper incorporation of the process of layering on content among learning resources. FIG. 6 is an illustrative example of the proper incorporation of a multimedia tool learning resource as exemplified in the Dynamic Leadership Presentation excerpt into a curriculum that includes an activity, layering content, and active learning as the curriculum segues among content and a plurality of learning resources during the practical learning card game as exemplified in FIG. 23.

In this particular embodiment, with attention drawn to FIG. 6, the exemplary illustrative working example of the proper layering of content between multimedia tool 433 and the practical learning card game 2300 as demonstrated in the facilitator guide excerpt 601 as exemplified in FIG. 6, as demonstrated in the Dynamic Leadership Presentation excerpt 701 as exemplified in FIG. 7, and the practical learning card game 2300 as illustrated in FIG. 23. Images within the Dynamic Leadership excerpt 702 at Slides 27 702A, 28 702B, 29 702C and 30 702D provide a visual representation of the coordination and unity of a coordinated and consistent educational product, practical learning, and layering content 112 among the learning resources herein.

With attention drawn to FIG. 7, the exemplary illustrative working example Dynamic Leadership Presentation excerpt exemplifies the proper incorporation of content, active learning, and a plurality of learning resources into the curriculum by layering content within and among multiple educational tools within the Practical Learning card game is delineated.

FIG. 7 is an illustrative example of the proper incorporation of the process of layering on content 1000 among learning resources.

The object of the present embodiment is to provide an apparatus for a novel practical learning card game that provides active content to build learning upon. Layering on the card game after learning key content builds knowledge. The practical learning card game engages a learner in achieving self-determined understanding and awareness. Thus, the card game is an educational tool or learning resource. Another object of the present embodiment provides a method of manufacturing a set of educational game cards. All game cards are the same size and shape, contain relevant information on two or more cards, and each differ in content or are not duplicated.

The further object of the present embodiment is to provide a set of educational playing cards as a learning resource to facilitate learning. The current embodiment of the present subject matter includes a set of at least two cards, wherein each card contains a word, phrase, or statement relevant to the subject matter that is placed in one or more stacks in response to one or more questions within the activity within a learning curriculum. In accordance with the present embodiment, the object is to provide a method utilizing a What are you willing to give? or other relevant card game to build upon practical learning with understanding and awareness of the affect actions can have on learners, layering on content leading to comprehension, awareness, and knowledge of the affect the learner's actions can have on others. Through game play, learners are asked a question and instructed to stack cards applicable to the given question. The topic or questions can relate to a never, sometimes, or always scenario pertaining to the learner's willingness to act based upon his/her boss, manager, one-up, or leader's actions or other pertinent factors. A further objective of the present embodiment is to spend minimal time facilitating learning on a key topic or key content that is memorable and in which the learner is actively participating.

The entire contents within this specification are equally applicable to other sections, figures, or elsewhere throughout the present subject matter without being repeatedly duplicated throughout this present application. The entire contents of each figure, drawing, number, and content identified and referred to herein are attached and incorporated by reference just as if these figures, drawing numbers, and content were set forth in full where the reference thereto is made within FIGS. 1-23.

### CONCLUSIONS, RAMIFICATIONS, AND SCOPE

From the description above, a number of advantages of some embodiments of the present subject matter become evident. Herein are systems and methods for creating relevant content and learning resources that are systematic, exhibit a coordinated flow among content and learning resources, facilitate learning, promote continued development post-course in the learner's relevant environment, address and provide learning on issues and concerns students currently experience, provide adequate practical learning, present the process of layering content, employ a Learn/Practice/Assess Protocol to facilitate a knowledge transfer and enhance retention, enable self-discovery and self-assessment, meet unmet needs, validate active learning or a learning experience using data and analytics for confirmation, provide a design process of a learning experience curriculum, introduce learning resource games to enhance learning and save valuable time, and enable learners to develop their own determinations or solutions based on educated decisions in a fail-safe learning environment.

From the description above, a number of advantages of some embodiments of my process of layering content become evident. The process of layering content will revolutionize educational curriculums to be meaningful and learning to be memorable. Teaching core content at the minimal level necessary to facilitate learning and building on that base foundation of knowledge by applying small blocks of learning that are absorbable before adding more information enables a learner to understand, comprehend, and embrace new learning. As learning continues to build on that firm foundation of knowledge plus new information, learners achieve a meaningful self-determined understanding and awareness of the subject or content to continue building learning. As knowledge builds, learners gain self-awareness of deficiency areas in skillset, leadership style, or other relevant area and embrace this opportunity to take action for impact as confidence builds. Layering on content provides learners with a sound foundation of relevant learning. Providing quality relevant learning and adequate time to absorb the new knowledge leads students to introspection, reflection, and cognition. Participants become competent, capable, and engaged individuals who are able to meet the challenges they experience utilizing the arsenal of learning tools and knowledge received during the course. Once students learn a concept or content, they practice recognizing it, analyzing it, using it. This is referred to as the Learn/Practice/Assess Protocol. This curriculum provides a course full of self-assessment and self-discovery for learners.

From the description above, a number of advantages of some embodiments of the present subject matter become evident. Learners come into a course-specific learning environment with problems, issues, and concerns searching for solutions. This learning experience curriculum promotes key learnings by educators facilitating a transfer of knowledge that leads learners into becoming participants actively engaging in discovering their own personal solutions so they each can implement similar actions and skills upon returning to their actual work environment or relevant environment. By the time the course concludes, learners not only have a strong understanding of the content they needed to know, but have had the opportunity to practice utilizing their new skills. So that when faced with the same or a similar situation post-course back in the real-life environment, they know what needs to be done and how to handle it. Practical learning within a learning experience is executed in a way that lets people learn, practice, get comfortable so that it is possible for them to implement what they've learned because they have had time to practice this new skillset. I have found best practices in facilitating learning is embracing and utilizing learners' real-life experiences as the criteria upon which knowledge is applied. Participants will learn through a series of exercises or simulations that are based on real people in their organizations today. Practical learning ensures learners comprehend the new learning received throughout the course. Learners are walking out with actionable solutions to a real issue or problem. Each participant is writing their own story within the participant workbook; therefore, no two learners will have the same takeaways. Each will have a unique element because each learner applies factors relative to their reason, common sense, and needs to formulate a solution.

From the description above, a number of advantages of some embodiments of my practical learning card game become evident. A practical learning card game addressing the learner and the learner's relevant environment enables participants to learn with understanding, awareness, and comprehension that encourages participants to reflect on each's self-determined learning progress and engages learners in their own individual learning. Rounds of cards within this practical learning card game are memorable because learners are able to relate to relevant subject matter and form their own decisions based on their real-life, relevant, or work environment. Introducing a practical learning card game that is repetitive yet changeable provides an opportunity for learners to apply new knowledge that can facilitate enhanced learning. The practical learning card game is new and novel, which can pique learners' interest. It is a fast-paced activity that can be memorable. This card game is an accompaniment to the educational course utilized to facilitate active learning through an activity.

From the description above, a number of advantages of some embodiments of my design process of a learning experience curriculum for facilitating learning become evident. The curriculum design phase includes the design phase, development phase, execution phase, and creation phase, all of which culminate into implementation of a superior educational product. Learning and knowledge transfer occur; however, applying content ratio rules enable active learning, learning experience, and interactive learning experience. Educational curriculum and learning resources are systematic, methodical, and adaptive. Content and learning resources are relevant. Scenarios are pertinent. Curriculum design processes are novel, cutting edge, and meet an unmet need. The curriculum design process formulates learning criteria and educational curriculum based on determinations of what the needs and goals of the target audience are. Students learn as knowledge builds. Educators facilitate learning by asking thought-provoking questions that each learner needs to address in order to find personal answers based on an educated decision. The curriculum will reduce a knowledge gap, improve a competency, and increase content knowledge. Applying factors within the standard method/process drives behavioral change. Learning is enhanced within the course; additionally, learning and development continue post-course as participants apply their new knowledge as their confidence builds. Relevant tools are provided during the course and are made available online via a download link that ensures the templates they have learned to use are readily available for their continued use post-course.

The learning experience curriculum implemented utilizing the curriculum design process promotes key leanings by educators facilitating a transfer of knowledge that leads learners to discovering their own personal solutions so they can implement similar actions upon returning to their actual work environment. Learners choose their own applicable workplace situation or other relevant consideration to apply the key leanings. There are no right or wrong answers. After applying their real-life scenario based on employees in their actual work environment at their workplace to the subject at hand during the practice mode, learners get to assess what they have done and how they have done it to decide if they have implemented a solution that meets or exceeds their needs. Learners address personal real-life situations or simulations upon which they will apply new learning based on lessons in the curriculum to build their own conclusions, results, and best-case scenario or solution. By immersing learners in actively evaluating themselves, their employees, and their leaders in a controlled fail-safe environment, learners become participants in their own personal development and exhibit leader behavioral traits. Learners walk in with problems or concerns and walk out with actionable solutions. That is memorable and not likely to be quickly forgotten.

While my above description contains many specificities, these should not be construed as limitations on the scope, but rather as merely providing illustrations of some of several embodiments. Many other variations are possible.

There are many alternative ways my layering content process can be implemented.

Layering content must occur between or among a plurality of activities, content, or other learning. Layering on content must occur throughout the course. Alternatively, layering on content can occur as deemed appropriate or on limited or specific sections of the curriculum or learning resources. Learning resources and educational tools must be incorporated to facilitate learning. Careful attention must be put into ensuring the flow of each topic corresponds to the content learning built upon from one section to another. Activities are the “practice” portion of the Learn/Practice/Assess Protocol. Learn/Practice/Assess Protocol can be the foundation of a learning experience and is the cornerstone of all content developed within the curriculum. Alternatively, active participation of a learner within the learning process need not be mandatory.

The layering content process has additional advantages in that it can be used for all content areas within any educational product as it can encompass different questions, answers, or statements. The Learn/Practice/Assess Protocol has the additional advantages that it can be incorporated into a learning curriculum in conjunction with the layering content process or it can be utilized independently. The Learn/Practice/Assess Protocol presents learning and development in a fail-safe learning environment that produces measurable results. As an alternative embodiment, the building blocks of learning can use different terminology, or can be structured comparably with minor modifications in various sections of learning within the building blocks.

There are many alternative ways that my course evaluation device can be implemented. The course evaluation can provide the analytical research upon which decisions as to the need for additional learning curriculum or courses can be made. The course evaluation can provide the analytical research upon which validation of the curriculum content, educator, and other relevant factors can be made. The course evaluation can serve as the basic level of analysis, evaluation, and interpretation of relevant curriculum and course factors in the development of a metric-driven curriculum. Research and validation over a period of time is warranted before declaring it is a metrics-driven curriculum; however, once its validity is confirmed and has proven to be a metrics-driven curriculum, it will revolutionize learner development, accountability, business outcomes, talent development, HR processes, just to name a few examples. Furthermore, the course evaluation form is modifiable and can be used for a wide range of evaluation areas and can encompass different criteria and formats. Alternatively, validation or analyzing the course, curriculum, or educator could be deemed unnecessary.

There are many ways my practical learning card game can be implemented, modified, or presented. A practical learning card game can be used in many areas of learning content. Accordingly, the reader will see that the practical learning card game of one or more embodiments is a fast-paced learning resource that enhances learning and supplements active learning. It facilitates learning and enables the curriculum to be defined as one or more of active learning, a learning experience, or an interactive learning experience. Furthermore, the practical learning card game is modifiable and can be used for a wide-range of content areas and it can encompass different questions, answers, or statements.

There are many alternative ways that my learning experience curriculum can be implemented. Curriculum must address key topics and develop that into key learning. Utilization of theoretical and practical learning within the curriculum can be apportioned different significance. Proportions of active content versus passive content can be deemed to be unnecessary. Students can be taught without applying key learnings to their actual real-life environment or to address problems, issues, or concerns the learner is experiencing. Scenarios and conditions can be developed in the curriculum that learners apply to key learning. Absorbable chunks of learning can be replaced with another teaching technique. Learning can be deemed sufficient. Learning experience or interactive learning experience can be deemed unnecessary. Information or questions can be provided to guide learners in making assessments and formulating actions. Relevant content must be provided upon which students will apply learning. Furthermore, the design process of a learning experience curriculum for facilitating learning has advantages in that it is modifiable and leaves curriculum determinations to the content creator. The design process illustrates the proper use of the process of layering content. When incorporating new or novel teaching techniques, a design process that is relevant and well-defined can ensure consistency and proper utilization of the new learning tools, such as layering content and the Learn/Practice Assess Protocol. The design process can be used for any or all educational curriculum. The design process core contents enable its use to provide the same level of pertinent and coordinated content in a multitude of varying educational products for all age groups and educational levels.

There are numerous ways learning resources or educational tools can be constructed. It may include fewer or more segments, sections, layout, or contents within the learning resource. Content may be changed, added, deleted, or titled differently. Terminology can be different, changed, or customized. Defining scope and designing course may include fewer or more factors. Segments may be unnecessary. Chunking may be replaced with dividing, sectioning, subdividing, segmenting, or removed entirely. Layering may be added, reduced, or removed. The priority, impact, order, and content may be added to, deleted from, removed, modified, or changed. Key topics may include more, fewer, or different subject matter. The educational tool or learning resource can be termed differently. The educational tool or learning resource can be titled differently. Content and learning resources can be termed differently. As examples, course could be curriculum, educational tools, module, lesson, program, educational materials, study materials, or other similar terminology; creation could be development; workbook could be guide, text, schoolbook, manual, course book, or other comparable terminology.

Learning resources are study aids that assist the curriculum, primary educational tool, or other educational tools in serving the needs of the participant during and after the course. A learning resource can utilize all or part of the design process, or other appropriate criteria as deemed appropriate. The curriculum creation steps outline and form was specifically developed for the creation of learning resources. Alternatives include core content necessary to learn the subject content and course specific factors or elements are mandatory. All learning resources and educational tools must have consistency and flow. To implement a learning resource or educational tool, a decision must be made as to scope. Scope can include knowledge gap, target audience, learning scope, standard method/process, priority/impact, or other elements. To determine the key topic to be addressed to accommodate the target audience, varying modes and combinations must be utilized. The learning resource must provide enough information to make the concept understandable, but not enough to become information overload. Learners must receive the necessary learning resources or tools to overcome knowledge gaps. Layering on content must occur within a learning resource, accompanying content, additional learning resources, or a combination thereof.

A learning resource must apply features designing, developing, executing, or creating phases within a design process, in whole or in part. Adopting and implementing phases within the design process of a learning experience curriculum for facilitating learning is appropriate and beneficial. Development phase must include segmenting, chunking, layering, or other content sections or divisions. Drafting and editing can be completed and finalized at a different time. Layering content should be utilized throughout the curriculum, including learning resources. Layering should occur within the learning resource and among the curriculum, content, and other learning resources. The Learn/Practice/Assess Protocol should be adhered to when practical. These considerations are applicable for all learning resources, regardless of the type of learning resource.

A template is a novel dual-purpose learning resource and post-course development tool. A form or tracking form is a template. A template is utilized by learners, both during the course and post-course, to support their learning and ongoing development as they practice the skills learned. Participants will only use a template in their work environment if it makes their job easier or brings about a better outcome. A template should assist learners in gathering critical data upon which an educated and informed decision can be made, or action implemented to reduce a competency gap, improve performance, or other benefit. The template should be developed with the intent to get the learners thinking freely. Once developed, the template should be executed to exhibit a coordinated flow within one or more educational tools or learning resources. It should raise relevant possibilities or concerns, encourage meaningful action or interaction, help the learner reduce a knowledge gap or increase content knowledge, or other benefit regarding an issue the learner experiences that aids in forming an educated decision to come to a solution. Questions or content that elicit meaningful information should be presented. Creativity is encouraged when creating templates. Select the topics and subject areas deemed to generate the best results. Challenge learners to step outside their comfort zones to learn. As an example, a development planning data collection template is a form that those learners who are leaders can use to create development plans, that develop their talent or employees upon returning to their work environment. The template can follow the design process, in part or in full, or could be created as a standalone learning resource and master form. A template is a form that should be routine, and its use should be a fairly simple process. A one-page form should be sufficient and should be utilized when feasible. It should be concise. The standard method/process, including course specific considerations, should be followed. A template should begin with generic or basic information, such as name, date, and other applicable information. The template should be course specific. A section can address challenges or barriers, ask questions or make statements, address a development goal or area of focus, include actionable elements and activities, address key resources or desired outcome, address progress or review, record status, address expanded learning, and other considerations as learners continue using the templates post-course in their work environment. A well laid out ready-made template helps participants focus on the tasks they should be completing. A streamlined process within a single page document, when feasible, reinforces consistent practice and encourages ongoing application of learning post-course. The Learn/Practice/Assess Protocol should be utilized when facilitating learning using a template. When implemented properly, following a structured and standard format will save time and improve quality or efficiency.

A participant workbook is a learning resource or educational tool that can be the primary educational tool. It should combine the textbook and course work into one workbook. The standard information and work for the field of study is presented in concert with instruction and exercises to facilitate or enhance learning in the subject field.

A worksheet is a learning resource or educational tool that can facilitate learners' ability to understand and comprehend concepts and key content. A worksheet is presented to learners during the learn mode and will be completed during the practice mode per the Learn/Practice/Assess Protocol. Layering on content must be interspersed in the worksheet, coordinating content, and learning resources. A worksheet can make a complex topic or concept comprehendible, in a format that enables a learner to determine how to use key learning to increase skill or be relevant to his/her real-life environment. The content creator needs to pack as much knowledge and key learning within the developed curriculum as possible; however, it will be limited and must remain relevant. A worksheet can succinctly accomplish the goal of this section. A worksheet should clearly state the subject or relevant title that accurately describes the subject. In the design process of implementing a worksheet, determine what the needs or goals are and formulate questions and criteria that provide learners with the questions they need address to find their personal answers. Decide if and how participants will answer questions. By immersing learners in actively evaluating real-life situations and experiences, in a controlled fail-safe environment, they are already exhibiting a change in behavioral traits. The learners' knowledge and confidence builds while practicing and completing the worksheet. The worksheet can be a standalone worksheet, part of a participant workbook or primary educational tool, or within another learning resource. A worksheet is an educational tool used to support the student learning content by providing the opportunity for practicing their content knowledge. Using real-life relevant examples that the learner provides in making educated decisions, based on new learning, and finding solutions to the situations, concerns, and issues of each learner's experience is beneficial but not mandatory. A worksheet facilitates comprehension and makes implementation by learners attainable. Alternatively, real-life examples need not be used.

A multimedia tool, presentation, visual representation, audiovisual aid, learning aid, interactive program, software, media aid, or other educational tool is a learning resource. Diagrams, charts, models, templates, images, or other audio or visual representations are tremendous assets that can be within a presentation or multimedia tool. The multimedia tool can direct learners to act or to complete an activity that is within another learning resource or is not within another learning resource. Whiteboard activities and games are two examples of actions or activities that often are not memorialized in another learning resource. Audio and video content may be utilized within a multimedia tool. The chosen multimedia tool can utilize the curriculum creation steps outline and form as illustrated in FIG. 4 as it has a section specially developed for multimedia tools, or can utilize other tools as the framework for multimedia tool curriculum design. Careful attention should be paid to the specific multimedia tool section to ensure all factors are adequately considered. The multimedia tool can be a standalone resource. The multimedia tool should not be the starting point of a learning curriculum, even though traditionally most courses designed start with a presentation of some sort that walks through everything presented. Alternatively, the multimedia tool can be the starting point of a curriculum. The multimedia tool can be constructed to coordinate with other learning resources or tools within the curriculum. As an example, the multimedia tool can base content within the multimedia tool primary educational tool or participant workbook. This will produce a better educational product that has a smooth flow. From there, it can evolve into the building blocks that lay out the process. The multimedia tool enables building on key concepts, providing examples, or adding dialogue that you cannot get through reading or lecturing. Everything that is in the multimedia tool is there as a support piece of the curriculum learning. The multimedia tool can present active content or passive content. It plays an important role in determining how time within the course is being utilized, and where it falls in the active/passive content ratio rule or 70/30 rule, if a content ratio rule is applied. Tallying time allotted within the multimedia tool can provide the statistics needed to formulate the active/passive content delivery ratio. The multimedia tool should adhere to the standard method/process. Alternatively, utilizing the standard method/process within a multimedia tool can be mandatory.

The multimedia tool can facilitate learning and development. Support slides may ask a question or it may have a statement on it. The multimedia tool is guiding the conversation of the people in the room. An educator is expected to retain a lot of information and remember when to include it. When you add in one or more slides, it naturally walks them through the educational course in a more effective way. Support slides are there to guide the educator through what it is that he/she needs to teach. The number of slides or images in the multimedia tool can vary depending on the curriculum. Some of it comes down to subject matter and some of it comes down to personal preference. More support slides may need to be added, given the learning content of the subject course to be delivered by educators who have differing experience levels. An educator or trained facilitator who has years of experience, or who has been in a leadership position or HR position, can have significantly fewer support slides or images in a multimedia tool that has a visual aid component than someone who has less time executing, presenting, or delivering the learning curriculum. An educator who has less experience will need more support slides to deliver the same course. The curriculum design process should ensure the multimedia tool provides the newest educator sufficient tools to provide a learning environment equal to that of a senior educator with years of experience in learning and development or the subject at hand. A learning course that has a meaningful impact will have considerable content. Every participant deserves the same level of learning. The multimedia tool can be designed in a way that anyone with an appropriate amount of experience in the field of study, or within the industry, can execute that training. Requisite training and education must be provided to an educator to enable this execution. A multimedia tool can have additional slides or images added to ensure each key concept or key learning is adequately addressed. Ensure the multimedia tool uses an established framework or roadmap to guide the flow and direction of educational content. A consistent flow aids knowledge transfer or learning. A few extra images can ensure an educator does not get caught up in the moment, or sidetracked by discussion or interruption, and accidentally skip forward, possibly missing the learning opportunity that should have been delved into. Time allotted advises estimated time to complete that learning section. It helps the educator stay on task. Break time can be a welcome slide. Animation within the multimedia tool can be used in moderation but should not be used to excess. * can indicate there is animation on that slide. Agenda can include one or more segments, but segments are not always required. Dividing key concepts and key content so they can be absorbable can lead to an increase in content knowledge. The multimedia tool can actively involve a student in his/her learning. Learn, practice, assess, or other appropriate content delivery components can result in learning or knowledge transfer that learners can use post-course or upon returning to their real-life environment.

The multimedia tool serves a dual purpose of accommodating the personal learning preference of learners who prefer visual learning. One or more multimedia tools can coincide. Having the appropriate balance between a multimedia tool learning experience aspect, facilitator-based learning experience aspect, individual learning experience aspect, a peer-to-peer aspect of the learning experience, or the group participation learning experience aspect of a course facilitates a greater understanding of key concepts and key topics and retainment of these. The multimedia tool can aid in limiting the lecture time, so learners do not become bored or disengaged. Varying content delivery via a plurality of learning resources and mechanisms, such as via an educator, a multimedia tool, or within the participant workbook, can keep learners actively engaged in the learning or learning experience. The multimedia tool can ask an open-ended question or present a conversation starter. A brief lecture with one or more slides or images within the multimedia tool can be the introduction into content. Starting a topic with a question or an intriguing thought-provoking intro into the concept or content can grab a participant's attention. Multimedia tool practical learning can instruct on an activity. This activity may be in the participant workbook but will not always be therein. An activity can give a learning opportunity to practice a knowledge transfer or reinforce key learnings in response to layered content. The learn mode sets a participant up to commit to an answer; the practice mode segues into the reasoning behind that answer. The multimedia tool segues content from facilitator-led dialogue to an activity within the participant workbook. The multimedia tool can direct learners to content that does not appear within written materials, such as whiteboard activities, games, an activity, or learning resources. The multimedia tool can enable learners to visualize concepts that would be hard to conceptualize with words alone. The learning resource can alternatively be a separate and distinct learning aid, or it can be with another learning resource, such as the participant workbook. A table discussion or group activity can be introduced via the multimedia tool. Layering content among varying learning resources is illustrated in the multimedia tool. An important self-reflection and accompanying discussion as the learning experience finalizes and learners determine what they will strive for going forward. As individual learners choose their personal development path forward it should be well laid out in a multimedia tool.

The multimedia tool can advise as to upcoming learning or learning mechanisms, such as collaborating with a learning partner to foster individual and team skills, reflection, personal assessment, or other appropriate elements. Practical learning within a multimedia tool can guide participants along a path of increasing content knowledge as activities build in content, concept, personal reflection, assessment, or as they proceed through an activity or multi-part activity. As the course nears conclusion, the multimedia tool can subtly challenge a participant with a thought-provoking question. Asking such a question within a multimedia tool is nonconfrontational. Reflection time within the multimedia tool can be based on that or another stimulating, inspiring, or challenging question or statement. The goal is for a learner to commit to a personal action plan. The participant workbook can be the perfect writing material to memorialize this personal commitment. Actions for impact is a call to action. Participants now have the learning resources, apparatus, and knowledge. The question that can be posed within the multimedia tool as the course nears conclusion can be, “What are three actions you need to take and when will you take them?” A learner leaves the course or learning experience with an action plan that can be immediately executed. A learner can memorialize his/her commitment within the participant workbook for later reflection. The multimedia tool can assist the educator in asking a key question, seamlessly answering that question, or layering the next content with knowledge sharing, as examples. A multimedia tool can provide new or additional ideas, or can use subtle reinforcement, to ensure participants are on the right track. The multimedia tool is used by the educator to drive learning while disseminating curriculum content. A multimedia tool is a support aid that imparts small pieces of knowledge or information on the subject at hand. This is done by breaking down each piece that makes up the whole and assists educators in facilitating learning within learning or a learning experience. A visual representation can express complex concepts or content in a clear or understandable manner to aid in learning.

An employee evaluation is novel and unique because the assignment is to evaluate three of a learner's actual team members or employees. The employee evaluation provides a device upon which to complete the learning session. This is not a simulation. A learner will complete an actual employee evaluation on three real employees in his/her personal work environment. This is a relevant content learning resource that will be covered during the course, and the employee evaluation is expected to be utilized post-course in the continued evaluation of the learner's employees. A learner gains knowledge and a further or greater understanding or comprehension, then practices proper utilization of the employee evaluation in a fail-safe environment to develop the needed skillset to perform this action post-course in the work environment.

The Dynamic Leadership 9-box grid is a learning resource and succession planning tool. It should be noted that 9-boxes are commonly used across any industry; therefore, this element will not be discussed in detail. Management routinely places employees somewhere in the 9-box grid, but that is all and that is not enough. How participants get the information in the 9-box grid within this learning curriculum is novel. How participants get to that specific data is unique and revolutionary. Then what participants do about succession planning afterwards is a novel technique. A 9-box grid should be objectively done or data driven. Once a leader understands who talent is, what they are good at, and what they are not good at, the leader understands what they are working with in terms of employees. They can accurately determine employees' capabilities or potential. Within the learning curriculum, participants learn and practice proper utilization of the 9-box grid and accompanying worksheets, and then upon returning to their actual work environment have career conversations. Applying new learning, participants comprehend where their employees want to go. Utilizing the 9-box grid facilitates learning as to how to complete a data driven 9-box grid. This activity illustrates layering within learning, content, and activities. Participants become actively engaged in evaluation of their real-life employees from their work environment to determine, based on data and key learnings, where each employee belongs in the 9-box. The goal is to remove subjectivity or conjecture from talent management. This 9-box grid accomplishes that. When utilized with one or more appropriate worksheets, the 9-box grid and accompanying learning resources are a novel and worthwhile process. Within this curriculum, potential is going much deeper than the traditional 9-box grid in which companies rate employee potential and performance. Until this learning experience curriculum, determinations of potential have been very subjective to a manager and what he/she thinks of the person being evaluated. Decisions are subjectively decided on how far an employee can get within the organization, within a given period of time, based on if the manager or leader thinks the person can get there. By understanding the level their people are taken to within this course, each participant's individual 9-box grid is much less subjective. It is based on data. It is based on real-life conversations with an employee within their work environment. These participants understand not only what their employees want to do, but how they operate. Learners know what those key behavior traits are. When you get to that deep of a level and understanding, assessment of where their employees can go is not only based on that, but it is based on real data, real conversations about where the employees want to go. They know their employees' aspirations. As a result of utilization of this data driven 9-box grid, a leader and an organization would expect to see less fluctuation in a 9-box year over year. People should not be sliding all over the 9-box grid. Evaluating talent potential should be objective. Leaders will get better information upfront utilizing this Dynamic Leadership 9-box grid, thereby decreasing the subjectivity of where employees are placed in the 9-box. Simply putting somebody in the 9-box grid is irrelevant if the leader does not use that information to take some sort of action. The next skill participants learn is once you have the 9-box grid and they are confident it is right because of everything they have learned in this course. Now what do they do about it? They must determine how they still grow their talent, how to deal with performance issues, how to step back and take a broader view of their team, or how they execute a specific plan given the information they have collected. Learners should complete an accompanying activity to evaluate how the talent they have today, based on the Dynamic Leadership 9-box grid, will support the business needs of critical roles. In this activity, participants determine the critical roles on their team, and plan ahead to who on their team would fill that vacancy over a given period of time using the Dynamic Leadership 9-box grid as the guide to employee potential. Participants build on that activity and related learning to then outline the next actions required for each critical role on their team. At the conclusion of this combined activity, participants will have assessed their employee's performance and potential, defined a succession plan for critical roles, and defined clear actions necessary to either close gaps where there may not be viable talent or define actions for developing their talent to reach those critical roles. This exemplifies layering on content and an interactive learning experience. Utilizing a data driven 9-box grid as a learning resource tool in a manner that is easy to visually understand, appealing to the audience, and allows for a complex topic, like assessing talent performance and potential, to be simplified for learning purposes into a relevant grid that is easy for participants to follow. Practical learning applying the 9-box grid and accompanying tools provides participants the opportunity to practice evaluating their talent, creating a succession plan given the talent they have today, and developing an action plan that will produce obtainable business results. Alternatively, these tools can be utilized separately, independently, or not delivered at all.

A model is a learning resource or educational tool that can allow a complex topic to be simplified into a comprehensible learning aid. A model is designed, developed, created and executed as a visual representation created to enhance the learner's focus, attention, or learning. Its design should be crisp and concise. Design a model that gets across the point. Determine how to relay that mental image most effectively as a visual representation. A model should be constructed in a manner that is visually appealing or memorable to the audience. Determine if you have included the relevant points. A model can also be a diagram, but need not be. A model can utilize one or more components of the design process, in whole or in part, or another appropriate process. As a learning resource, a model should provide flow, enhance learning, or increase retention. Once developed, a model should be executed to exhibit a coordinated flow within one or more educational tools or learning resources. A model can be utilized as an independent study aid or can be used within another mechanism or learning resource. A model should utilize the standard method/process. It should be organized, concise, and exhibit coordinated flow within educational tools. A model should be informative and innovative. It should be novel when practicable. The design and display of a model affects its benefit. A model is a building block that lays the groundwork for learning that unfolds within the upcoming lessons. Layering on content should be identifiable. When a model includes a comparison, start with a side by side written comparison. Only a descriptive word or two is necessary. You already have the vision. Determine how to relay that mental image most effectively as a visual representation. Determine if relevant classifications have been included. Determine how to reflect these classifications or this information in an interesting or memorable way. Ensure elements are defined accurately and factually. Confirm the best descriptor is chosen to convey the element. Verify one or more items are not lost as the model evolves. A simple mistake can change the whole model or make it ineffective. Safeguard all the pieces are contained in the model. Design a view that gets across the point. Examples can be a circular diagram split in two to illustrate two categories or comparison elements listed as though mirrored images with one on each side of the circle in the same proximal area so the eye easily catches both while processing the model. Applying the Learn/Practice/Assess Protocol and layering on content wherein the model is part of that layered content aids participants in their learning experience. A model can be used as content building information. It can act as an entry point to begin a conversation with the learners. Once learners have a good understanding of the differences outlined in the model, they can engage in discussions and activities to learn why this model, while reflective, is or is not sufficient. Upon conclusion of learning about an insufficient model, participants will be looking for an alternative model that better aligns with their personal needs. A model can be a representative model illustration. When layering on content within a model, incorporate important components of an earlier model into subsequent models. This is a different model than an earlier model, but it can tie back in with that earlier model. Alternatively, a model can be created using the course creation outline as illustrated in FIG. 4 without utilizing other or additional phases within the design process.

A flowchart is a diagram and a learning resource. It is provided as a visual representation created to enhance one or more of a learner's understanding, knowledge, focus, attention, or learning. Its design should be crisp and concise. A flowchart diagram should be course specific, educational, or unique. Some concepts are just too important not to have a visual representation to reinforce facilitator-led dialogue, activities, discussions, or other learning resources. A flowchart can direct attention to the point the learning curriculum is trying to get across or to reinforce content and concepts. An educator could spend several valuable minutes explaining what is evident within a diagram as learners visualize the learning content within the diagram clearly displayed for them. A learner's view will coalesce to evolving or new thought processes when able to visualize a concept. A flowchart diagram illustrates and outlines the important aspects of learning in a manner that is visually appealing to the audience. A flowchart allows for a complex topic with multiple content areas and processes to be simplified for learning purposes. Course specific considerations within the standard method/process should be incorporated into a flowchart. A flowchart diagram can achieve a plurality of the goals outlined within the framework of the standard method/process. A flowchart should follow the curriculum creation steps outline and form as illustrated in FIG. 4, as this flowchart diagram is a learning resource, and the curriculum creation steps outline and form was specifically developed for the creation of learning resources. This can ensure a cohesive learning experience with learning resources that flow or enhance learning. Alternatively, following the curriculum design process is not mandatory. A flowchart is passive content unless an activity is added, wherein it would become active content. A flowchart can enable learners to comprehend often misunderstood concepts or to learn the difference and importance of each. A flowchart should be a course specific learning resource for use within the curriculum.

A cycle flowchart or cycle model flowchart is a type of flowchart, diagram, and learning resource. It is visual representation used as a mechanism to show a concept that is hard to mentally comprehend with words alone. It is a valuable tool to show a visual representation of an involved concept or considerable concept in a medium that is easy for learners to comprehend and process. Without seeing a visualization, many learners would never consider new thinking or alternatives. This learning tool compliments or reinforces the content a learner is receiving and often gets the point across faster and better than other methods of educating on a given subject, content, or concept. The written or verbal content needed to get the point across or accurately to explain the subject of the cycle model flowchart would be considerable and can be boring. A cycle model flowchart is a visual representation that facilitates learning. In the design process of a cycle model flowchart, a plurality of plausible scenarios should be provided. This will enable learners to ascertain quickly and easily what the available possibilities are. To create a flowchart model diagram, apply the base learning resources guidelines. Determine applicable plausible scenarios and key stages. Create an outline of key stages. Ensure there are no duplications. Begin your cycle flowchart with a core concept or major topic area as the start of the cycle. Determine what the core elements of your subject area are. Choose easily recognizable titles of the core levels of your subject area. Add these core elements or levels to your diagram under the initial core subject and draw arrows indicating the flow throughout this stage of the process. With each core level or element of your subject area, list the possible advancement potential. Add these possible advancement potentials to your model flowchart diagram under the correlating core levels or elements listed above and draw arrows indicating the flow throughout this stage of the process. With each core level of your subject area, list the possible advancement potential. Add these possibilities to your diagram under the correlating higher level and draw arrows indicating the flow throughout this stage of the process. Determine if there are additional possibilities within this level of the cycle and add any applicable additional possibilities for the diagram under the correlating higher level. Draw arrows indicating the flow throughout this stage of the process. Continue this process adding each to the flowchart diagram with corresponding arrows indicating the flow until there are no additional applicable possibilities. Then return to the top and complete the process in its entirety. A cycle diagram is not complete until it fully gets the point for which it is developed across. A cycle flowchart diagram can enable a complex topic with multiple content areas and processes to be simplified for learning purposes into a diagram that is easy for participants to follow. Important aspects of the cycle flowchart diagram should be presented in a manner that is visually appealing. If it is determined additional visual representation is needed, changing the look and feel of it can keep learners engaged.

A facilitator guide, instructional manual, or teacher's edition text is a learning resource. Utilizing the design process can facilitate a smooth transition between course, learning resources, and materials. The facilitator guide should coordinate with other learning resources or tools within the course. As an example, the facilitator guide can mirror the participant workbook pages and multimedia tool slides or images, wherein the learning resources appear in close proximity within the pages of the facilitator guide. This will produce a better learning product that has smooth flow. The facilitator guide enables the educator to have key learning resources readily available in one tool. The facilitator guide should be built to support learning that is in the participant workbook. This is because the participant workbook has been determined to be the cornerstone learning product of the learning experience within our illustrated example. Everything that is in the facilitator guide is there to facilitate learning or as a support piece put in place to enhance learning in conjunction with the participant workbook. The facilitator guide is a tool to assist the educator in delivering a superior curriculum or learning experience that achieves its pre-determined goal. It can give educators the tools at their fingertips to deliver a learning experience. The facilitator guide should combine all course learning resources into a cohesive instructional manual. Interspersing contents of the participant workbook and the facilitator guide, or other learning resources within the same page or pages of the facilitator guide, along with instructions, hints, notes, or other aids supports facilitation of a consistent and unified learning product. Its organization and solid framework can enable the course to be executed in a way that aids educators in imparting knowledge so learners understand content, concepts, or subject matter. The pages of the facilitator guide follow the timeline of learning as presented during the course. Every page of the participant workbook and the multimedia tool should be contained within the facilitator guide. It may be a multimedia tool with instructions, a participant workbook page with instructions, a multimedia tool and participant workbook page with instructions, or another appropriate configuration. This enables the educator to focus on facilitating learning. Everything the educator is expected to do or accomplish is in one framework. There is no need to be referring to a screen or monitor because the tools are concisely in one tool. The facilitator guide is an educator's instruction manual. Each participant workbook page or multimedia tool slide or image should have an accompanying instruction section. If other learning resources are used that are not in the participant workbook or the multimedia tool, each should have a place within the facilitator guide. A key purpose of the facilitator guide is to direct the educator to where the course is going next. All learning resources should be within the facilitator guide. There should be a heading on each page, so it is quickly and easily visible as the educator peruses the page. Remember, educators are engaged with learners imparting knowledge or facilitating learning. The purpose is to provide easy access and visibility within the facilitator guide so the educator can spend every possible minute facilitating learning or providing a learning experience for learners. There should be an Instruction section for each page or slide within the facilitator guide. Each Instruction section within the facilitator guide should contain a slide number if it is coordinating with the multimedia tool or page number if it is coordinating with the participant workbook. Instructions advise educators what is expected of them. Instructions keep educators apprised of what their role is in each piece of the curriculum or keep them on task. In creating a facilitator guide, a heading should appear on each page of the facilitator guide. “Introduction” can appear at the top of the first page. Below that should be an introductory slide from the multimedia tool. Below that is the instruction section with its content. The setup should include the slide number, time allotted, instruction in each instruction section. There should be a Notes section with blank lines in each instruction section for the educator's personal notes. Whether the Notes section is utilized is at the educator's discretion. There may be Note(s) if deemed it would assist the educator or Option if it is a section of the curriculum in which the educator may adapt the curriculum; however, not each instruction section should contain a Note or Option, because not all sections will need to provide more information, or adaptation is not recommended or not permitted. Time allotted is important for keeping the course on schedule or ensuring all content determined necessary to be presented fits within the available timeline. This is also valuable in determining the active/passive content delivery ratio, which requires achievement of applicable active/passive ratios of content delivery in order to reach or exceed the threshold of being a learning experience or an interactive learning experience. The Note area should succinctly lay out a significant expectation of the role of an educator or provide direction. Instructions can suggest an opening. Instruction can instruct the educator to ask a question, acknowledge examples, make a statement, read a slide or image, or other instructions as deemed appropriate. Expectations of the educator's actions and facilitation should be clear and evident. Many slide instructions can be as simple as to read an agenda, slide, definition, or other direction. It can be to read slide and allow participants to answer a question, read a slide to introduce an activity, or other direction. Educators are always aware where the course is at and where it is heading when using a well-designed facilitator guide. Note can serve to advise what will occur within another learning resource or that a slide has animation. Instructions can advise the educator to share knowledge. Each educator will have his/her own examples based on their real-life experiences. There should be adaptation within the curriculum wherein the educator is given the ability and coached to share knowledge and personal experiences actively engaging the facilitator and the participants in the learning experience. Option should promote adaptation by suggestions. A note can advise that an activity can be done independently or as a table exercise. It is at the educator's discretion to decide. Time constraints can play a role in that determination.

A learning resource can incorporate any of the above elements or considerations, or can determine other appropriate criteria, upon which the learning resource will be constructed. Choices and options enable a learning resource to remain relevant, engaging, and each to have a new or unique feel that can engage learners. The above specific examples are for illustrative purposes only and are not to be construed as limiting learning resources within the present subject matter.

The content creator should be determined based upon the requirements and responsibilities for the subject curriculum or learning area. Great care must be taken in selecting a content creator. The content creator will create the course, process, and devices. Collaboration with educators and team members is necessary. A content creator should not be an unknown person from an outside company, hired to create your vision without input. The generic educational product that would be generated could be a mutation of the traditional content already in existence. Content creator can own all stages from design process to implementation.

Practical learning is a method of enabling one or more learners, who are also participants. to practice a newly acquired skill using real situations that are currently relevant for each of them. Practical learning is a positive reinforcement to ensure learning, knowledge transfer, or lessening of a knowledge gap. Practical learning is active content and active learning. Practical learning is the “practice” element within the Learn/Practical/Assess Protocol. It also plays a key role in active/passive content ratios. Just as layering on content occurs as participants learn additional content, a concept can be presented on which participants practice active learning. Participants can assess challenges they are personally experiencing in the work environment or relevant environment, which are the symptoms. Finding and the root cause is necessary. Practical learning simulations actively engage participants in their learning or learning experience. A simulation could be each crafting his/her own questions that can be used for career conversations in a personal work environment. Multiple practical learnings with deviations in content and outcome serve as reinforcement of learning or knowledge transfer. A participant's personal evaluation vests them in the process or can lessen a knowledge gap. Practical learning can be a table discussion with two or more learners on an activity. Practical learning can impart lasting knowledge or skills.

Participants evaluate themselves and their employees, evaluate their personal work environment or relevant environment, and their personal impact within that work or relevant environment. People learn more when they can relate to it, when it is personal to them, when they have a problem, or an issue and they are personally working to resolve it. They retain more when they are engaged or the information is interesting, memorable, or different from the norm. Develop a course with these considerations in mind. Within the leadership and talent curriculum, management members need to be developed into leaders, and specifically people leaders who have direct reports or influence the lives of others. Alternatively, the content subject, environment, impact, or other considerations can be supplied within the curriculum that the learners will base their determinations and learning upon.

The learning curriculum should be developed in a way that allows learners the opportunity to take in complex ideas or concepts, and absorb it, then can practice that learning. Optimally, participants are given the opportunity to work through ways to resolve a real problem or issue they experience in their actual work environment in a fail-safe environment. Think of it as an experiment as the developing phase occurs. Participants think they might know how to fix the problem or issue. They come together. They do an activity. They get to test it out. Participants actively learn what will or will not work. So that when they leave the educational course, they know the “how.” That is, the how to go and execute. The curriculum should be developed with the Learn/Practice/Assess Protocol in mind. The more the curriculum adheres to the Learn/Practice/Assess Protocol, the better the educational product will be. The Learn/Practice/Assess Protocol can and should adhere to the active/passive content ratio rule to ensure it is a learning experience; however, following a content ratio rule is not mandatory. The Learn/Practice/Assess Protocol can adhere to the 70/30 rule to ensure it is an interactive learning experience. This Learn/Practice/Assess Protocol should be used throughout the course in one or more mechanisms. Content delivery and execution delivery intersect and interconnect. Development should pay close attention to these fundamental educational curriculum directives.

The standard method/process should be consistently followed throughout the curriculum development and may be deemed mandatory. The standard method/process, including one or more of active learning, learning experience, or interactive learning experience should be employed throughout the curriculum development, including learning resources. Course specific content, concepts, and subject matter within the standard method/process that should be utilized throughout the course include actions and activities, specifically designed and developed so the learners can learn the key concepts and content. Learning continues and is always followed with practice and assess before moving to the next key topic or content. Participants bring in their own personal work issues and leave with real solutions.

There are many alternative ways that my design process of a learning experience curriculum for facilitating learning can be implemented. Parts and elements within the present subject matter can be added, deleted, modified, or changed. Key elements or phases may include fewer or more components. Factors can be added, eliminated, or duplicated. Fewer or more stages or phases can be deemed appropriate. The stages or phases may include fewer or more sections, layout, topics, delivery modes, or contents. The stages or phases can be adopted, in whole or in part, as deemed appropriate. One or more phases can be utilized, and other phases disregarded. Different titles or terminology could be given to similar actions. Layout and order can be modified or changed. Content, concepts, and topics can be modified, changed, added or deleted. Content or learning resources can be constructed using one or more of design process tools in their entirety or by selecting and using only specific applicable sections. The present subject matter is illustrated as a live, educator-led course; however, it could be conducted or implemented in a variety of manners. The execution or facilitation of this learning experience curriculum could be conducted or presented in a formal classroom, computer-based program, software application, workshop, seminar, management training session, Webinar, pre-recorded, multimedia tool, retreat, training, instructional program, or other learning environment. The curriculum could be presented without regard to active learning, learning experience, or interactive learning experience. The present subject matter can be implemented by HR for a plurality of purposes including leadership and talent management, closing a knowledge gap, benchmarking, or as a metric for measuring talent, capability, as well as a plurality and variety of additional benefits.

The curriculum design phase process can be utilized in building an educational or learning program independently or in conjunction with one or more phases. The goal within design phase could determine actively engaging students is not a consideration or requisite. The design phase could include more, less, or different stages or sections. Defining scope can determine relevant considerations as deemed appropriate, including or excluding elements within the design phase, in whole or in part, as deemed appropriate. A standard method/process could be excluded from the design process. Course, curriculum, content, and apparatus not available in the market could be excluded from the design process. Course objectives could exclude reducing or lessening a knowledge gap or other benefit.

Core content could utilize different factors or include other elements. There could be more core content or less core content determined to be necessary. Determinations as to appropriate key topics or key content can be based on other considerations. Elements can be added, deleted, or altered. Key elements can be added, deleted, or modified. The development design process may include fewer or more sections, layout, topics, delivery modes or contents. Different titles or terminology could be given to similar actions. Active content and passive content could not be a determinant in the curriculum. Chunking, layering, and segmenting can be sectioning differently or not sectioned and constructed as a unit. The content creator can choose not to collaborate with others in developing content. The curriculum could be examined without reviewing the course from the mindset of participants. Content can be left within the curriculum without regard to meet an objective or value of the content. Educators or trainers can be expected to find their own way to remove challenges or barriers without the necessity of revamping content or learning resources. The development phase can determine course content by defining scope and designing course can use the same, similar, or different factors. Decisions as to determining the knowledge gap, target audience, learning scope, standard method/process, priority based on impact, or other criteria as deemed appropriate can be made as a standalone educational product. Alternatively, the design, development, execution, and creation of a curriculum can be accomplished using one or more of the design phase, development phase, execution phase, or creation phase, in whole or in part, without utilizing other design, development, execution, or creation tools.

There are many alternative ways that my curriculum design process, layering content process, Learn/Practical/Assess Protocol, content ratio factors, practical learning card game, or course evaluation can be implemented or utilized. The curriculum design phase, curriculum development phase, curriculum delivery phase, or curriculum creation steps outline and form can be implemented or utilized. Either all, or any combination thereof above can aid in the design, development, execution, or creation of content or devices. The processes, systems, and contents herein are beneficial and provide value for all age and intelligence levels. This can include elementary, high school, college, or adult courses, sessions, trainings, or seminars. Private, public, governmental, or nonprofit organizations can benefit by utilizing the processes and systems herein. There are many ways these processes and systems can be implemented. Alternatively, the content creator may develop a course based on predetermined factors, such as the standard method/process, course objectives, layering on content, or other factors as deemed appropriate. Elements deemed appropriate for inclusion can be decided based on the criteria as deemed appropriate without regard for determinations made in one or more phases or stage or considerations therein. Alternatively, the process and devices or learning resources that are part of the curriculum can be independent or individual. The principles and guidelines can serve as the framework for building up the coursework and materials within the design process. Principles and guidelines can serve as the framework for building up the coursework and materials within the course delivery process so that it segues from one key concept, key topic, key content, activity, discussion, or other mechanism to the next, thus creating a cohesiveness or smooth flow that facilitates learning. The active/passive content ratios could not be a factor in the curriculum design process or implementation of the course. The curriculum can adopt a ratio that differs from the 70 percent active content or 30 percent passive content as per the 70/30 rule. Threshold ratios could be less or nonexistent. A ratio that differs from the substantial active content and minimal passive content delivery ratio can be adopted.

As an alternative embodiment, a design phase, development phase, execution phase, creation phase, or learning resources can each be utilized as an independent or standalone process or device. Alternatively, one or more processes or devices could be utilized separately, independently, or not implemented or presented at all. Learning resources need not be a counterpart or accompaniment to the curriculum. Curriculum can be built on one learning style. As an alternative embodiment, the curriculum design process can be utilized as a standalone process. The framework can be built on key questions. Based upon these key elements, topic, content, and delivery can be designed for the purpose of learning curriculum execution. The delivery mode of learn, practice, and assess can be interspersed within the confines of the curriculum methods and apparatus. The designation of thresholds should be measured at the section/topic level and the course level. As an alternative embodiment, the curriculum can be built without regard to protocols and rules that validate learning as a learning experience or interactive learning experience. Curriculum can be built without concern for an appropriate balance between a learning resource and the various aspects or without being based on an appropriate efficacy outcome. Teaching content may be deemed appropriate rather than facilitating learning.

Alternatively, structure, organization, and implementation of the curriculum can determine flow of learning without following the standard method/process. Defining scope could be determined to be a later step in the curriculum design phase. Focus of the subject matter to be determined as a step in the design phase could be important or not. A learning objective or efficacy outcome could not be a factor in the curriculum design process. The present subject matter is illustrated as a live, educator-led course. It could be conducted or implemented in a variety of manners. The facilitation or implementation of a curriculum or a learning experience curriculum could be conducted or presented in a classroom, computer-based program, software application, workshop, seminar, management training session, Webinar, pre-recorded, multimedia tool, retreat, training, instructional program or other learning environment. Alternatively, the learning experience or interactive learning experience could be negated and instead similar content, concepts, or learning resources utilized in what is considered a traditional training or educational setting. Active learning, practical learning, a learning experience, or an interactive learning experience could be deemed to not be necessary and learning or teaching be deemed sufficient or adequate. Application of age appropriate or adult learning best practices could not be a factor in the curriculum design process or implementation.

As an alternative embodiment, the curriculum can be taught and the student or attendee can practice the content without assessing comprehension, understanding, or knowledge transfer. Content can be taught in one section without providing an opportunity to practice or assess new learning between each or more than one key topic or key content. Alternatively, participants can be provided an opportunity to apply new learning without concern that it facilitates learning or reduce a knowledge gap. Active learning can be deemed unnecessary to the curriculum. As an alternative embodiment, single factors, such as layering on contact, Learn/Practice/Assess Protocol, application of a relevant or work environment, or issue/real solution can be taught individually, in part, or in varying ways without applying said factors as a part of a whole.

Portions of the standard method/process elements can be incorporated into a curriculum disregarding active learning, learning experience, or interactive learning experience. Alternatively, the standard method/process could be the foundation upon which a curriculum must be built upon. Regardless of the key topic or the subject of a learning course, a determination must be made as to the type of learning that will be utilized for the educational course. First hurdle will be deciding if the course will be a training, teaching, seminar, or other event wherein attendees are provided information and possibly aids, or if it will be a learning wherein pertinent or relevant content on a given key topic is presented in a format that facilitates learning on the part of students. The way the course is executed can be determined not to have a major impact on learning. The curriculum could be designed without regard for prerequisites or the need to achieve requisites. Alternatively, educational content could be constructed without regard for priority based on impact or content can be presented as deemed appropriate. The educational content or training could be devised without regard for providing core content or sectioning content into key topics or key content. Learning resources and the way the course is implemented can be independent of each other. Course objectives and desired outcome could be excluded from the design process. Alternatively, support materials or learning resources could be created totally separately or independently. Further, the curriculum can be built for the masses, rather than personal to each learner, or only selective elements can apply within a curriculum that is personal to learners.

Alternatively, procedures herein should be followed when developing multiple tools or learning resources for the same course. In our illustrated figures, examples would include the participant workbook, games, simulations, facilitator guide, multimedia tool, and others. It will save considerable time to apply the same elements within the curriculum design process or curriculum creation steps outline and form among learning resources or study aids. This ensures a smooth flow and that the same considerations are addressed in each learning resource or educational tool. This is a viable option when developing a series, or when the curriculum creation steps outline and form can be easily manipulated, to achieve the purpose of the curriculum to be developed. Participant workbook outline can be an independent, standalone outline. The scenario can be generic that students or trainees are instructed to apply their relevant environment or an environment the curriculum presents. Instead of providing learning and knowledge sharing and expecting trainees to apply each's self-determination to their own real solution, the format can be changed or modified. The subject matter can focus on issues other than those trainees or students are experiencing in their real-life environment. Decisions trainees or students make relating to a given subject matter need not be based on their real-life situation or relevant environment.

Alternatively, it is possible to utilize an already established design phase, development phase, or execution phase, in whole or in part, creating curriculum, learning resources, or educational tools laid out in the curriculum design process, curriculum creation steps outline, development phase diagram, curriculum delivery phase, or other established curriculum creation tool that adequately addresses guidelines, framework, or outline of a curriculum that is applicable to the curriculum to be developed and delivered is appropriate. To be beneficial in aiding in the creation, alterations should be minimal. Ensure the already established component addresses relevant considerations before deciding to forego any element. This procedure should be followed when developing multiple tools or learning resources for the same course. It will save considerable time to apply the same elements within the curriculum design process or curriculum creation steps outline and form for all applicable learning resources or study aids. This ensures a smooth flow and that the same considerations are addressed in each learning resource. This is a viable option when developing a series, or when the curriculum creation steps outline and form, or other appropriate tool can be easily manipulated to achieve the purpose of the curriculum to be developed.

Alternatively, the curriculum cannot include core content and concepts, instead assuming trainees or students already have the requisite knowledge needed to build teaching upon. There are many alternative ways the educational tool or learning resource can be implemented. Different or other factors can be deemed key. More key factors or less can be deemed appropriate. The visual representation could take a different form. Delivery form can be different. Passive content could become active content by adding an action or activity to it. Content types could be changed. Other terminology could replace current terminology. There are many alternative ways a flowchart can be implemented. Stages may be grouped or titled differently. Stages can be added, deleted, or changed. The flowchart may include fewer or more factors. The physical appearance of the learning resource or the information contained within it can physically appear differently. A primary educational tool can be deemed unnecessary. Content and learning resources can be designed, developed, executed, or created simultaneously. Visual representations can look differently or be presented in an alternative form. Predetermined mechanisms can be based on different or other criteria and take a different form, or appearance or can be transformed into a different learning resource or educational tool. Cross-referencing learning resources can be determined not to be necessary. A multimedia tool can include sound. Slides or images within the multimedia tool or presentation can look differently, advance with or without action, be automatic or manually advance. Activities can be added, deleted, modified, or not included within the curriculum. Support materials or learning resources could be created totally separately or independently. Tools and learning resources should be cross-referenced with other learning resources later in the creation and build of learning resources or support materials to ensure consistency.

Alternatively, the design process of a learning experience curriculum can be utilizing for initiatives or further courses including HR transformation, emerging leader, executional excellence, customer service, succession planning, employee engagement surveys, data analytics, or other content deemed appropriate or can be based upon surveys, research, data, analytics, or other methodology.

These ramifications, and others listed within the present subject matter, may be applicable to other figures, embodiments, or ramifications and should be considered as presented in each. Although the present subject matter has been described in detail, those skilled in the art will understand that various changes, substitutions, and alterations herein may be made without departing from the spirit and scope of the present subject matter in its broadest form. Those skilled in the art will understand that the principles of the present subject matter may be implemented in any suitably arranged process or apparatus. The particular embodiments disclosed above are illustrative only, as the present claimed subject matter may be modified and practiced in different but equivalent manners apparent to those skilled in the art having the benefit of the teachings herein.

Furthermore, no limitations are intended to the details of construction or design herein shown, other than as described in the claims below. It is therefore evidence that the particular illustrative embodiments disclosed above may be altered or modified and all such variations are considered within the scope and spirit of the present claimed subject matter. Thus, the scope should be construed broadly as set forth in the appended claims and determined not by the embodiments illustrated, but by the appended claims and their legal equivalents. Accordingly, the protection sought herein is as set forth in the claims below.

1. A process of layering content, the method comprising:
adopting one or more predefined or predetermined topics, subject areas, content areas, learning areas, or other information as deemed appropriate;
utilizing said layering content can be the foundational process upon which practical learning or a curriculum is created;
determining appropriate blocks or pieces of information to be presented at a given time, wherein content or subject matter should be divided into digestible or absorbable pieces of information or learning sections;
introducing one or more learners to a piece of information based on a topic or subject;
imparting small pieces of information or knowledge that should be relevant;
educating as to different or new content, concepts, or behaviors as feasible, wherein different or new content, concepts, or behaviors should be fundamental to how people learn or facilitate new learning;
enabling learning of a key core concept or key core content if needed;
facilitating learning of a subject matter or concept;
building upon knowledge learned, wherein one or more learners should understand or comprehend new knowledge before additional information or more complexity is added, and wherein proceeding to add information once one or more learners understand or comprehend new learning of the concept, content, or subject matter previously presented should continue;
utilizing a systematic method of creating or executing learning variations can support knowledge building;
layering content should be utilized within a design process, curriculum, and practical learning, wherein interspersing said layering content can occur within a plurality of mechanisms, including active content, subject matter, practical learning, or learning resources;
grouping content or subject matter, wherein a coordinated flow from one block of information to the next can occur;
adding more information, wherein learning can increase or be enhanced, and wherein once one or more learners understand or comprehend that portion or piece of information the next piece of information can be presented, and wherein the next piece of information builds upon the new knowledge attained in the previous block or piece of information; and further wherein information added should be propitious, digestible, or absorbable;
adding information or said layering on content should occur during learn, practice, and assess modes, wherein said layering on content or adding information is a learn portion of a Learn/Practical/Assess Protocol;
adding information or building on new information should continue through a topic, section, chapter, or other segment of content or learning, wherein after an addition of new learning or information there should be an action in which learners participate, and wherein said Learn/Practice/Assess Protocol should be adopted or followed;
building on information by adding new or additional information can be repeated as many times as necessary to adequately address a concept or content;
utilizing one or more applicable modes;
reviewing the culmination of said layered content or appropriate pieces of information within or concluding said topic, section, chapter, or other segment with one or more learners can ensure one or more learners comprehend how the pieces of information fit together or why that knowledge is important;
advancing educational curriculum to the next said topic, section, chapter, or other segment;
said process of layering content should transpire until the course concludes.

2. A method of creating a design process of a learning experience curriculum for facilitating learning, the process comprising:
defining learning scope;
determining an auspicious efficacy outcome if appraised to add value;
creating or adopting one or more applicable phases, stages, or parts;
delineating learning experience curriculum, wherein learning experience curriculum includes content and learning resources, and wherein the delineation can include curriculum structure, organization, or implementation;
establishing one or more appropriate mechanisms;
ascertaining a felicitous balance among one or more aspects of learning experience curriculum;
ordering content, educator method of instruction, learner performance, or a combination thereof;
outlining curriculum criteria;
drafting or editing learning experience curriculum, wherein more than one draft or edit can occur but is not mandatory;
drafting course agenda;
making adjustments to learning experience curriculum or said agenda if necessary;
implementing a test run or making adjustments to curriculum as needed;
devising a training process or program for educators;
making available or providing one or more templates for learners' use or benefit if practicable;
implementing curriculum;
deploying or presenting the learning program or curriculum in an appropriate class setting.

3. The method of claim 2, comprising the further step of incorporating said process of layering content within said design process of a learning experience curriculum if deemed appropriate.

4. The method of claim 2, comprising the further step of integrating or putting one or more applicable elements of a Learn/Practice/Assess Protocol into operation or practical use within said design process of a learning experience curriculum.

5. The method of claim 2, comprising the further step of adopting or applying applicable elements within a standard method/process within said design process of a learning experience curriculum.

6. The method of claim 2, comprising the further step of determining or establishing active content or passive content relevance within said design process of a learning experience curriculum.

7. The method of claim 2, comprising the further step of integrating practical learning within said design process of a learning experience curriculum when propitious.

8. The method of claim 2, comprising the further steps of creating or adopting, in whole or in part, one or more of applicable curriculum design phase, development phase, delivery or execution phase, creation phase, or other applicable phase or stage as deemed appropriate within said design process of a learning experience curriculum.

9. The method of claim 2, comprising the further step of making available or providing an applicable template for learner's use or benefit within said design process of a learning experience curriculum.

10. The method of claim 2, comprising the steps of devising a curriculum design phase within said design process of a learning experience curriculum, further comprising:
defining scope;
designing learning experience curriculum or other criteria as deemed appropriate;
resolving said topics to be included or excluded;
selecting said content for inclusion;
resolving core content or core concepts that should be delivered or presented;
designing said content, structure, organization, or implementation of a learning experience curriculum;
formulating an appropriate mechanism for executing a curriculum or learning;
delineating a course review process;
removing a barrier or challenge if necessary;
implementing said curriculum design phase, in full or in part, within one or more phases of the overall said design process of a learning experience curriculum.

11. The method of claim 2, comprising the steps of devising a curriculum development phase within said design process of a learning experience curriculum, further comprising:
incorporating one or more applicable learning types;
including one or more of chunking, layering, segmenting, drafting, editing, or other appropriate criteria;
creating or executing learning variations, wherein learning variations should be systematic;
interspersing learning resources with content;
developing said content or learning resources via a plurality of mechanisms or devices;
limiting passive content as practical;
adopting or implementing said topic based on said design process of a learning experience curriculum for facilitating learning or other appropriate criteria, wherein said topic can independently stand on its own;
using one framework consistently throughout one or more aspects of a learning experience curriculum when feasible;
creating a learning experience curriculum that can have a coordinated flow;
building on the core message;
ensuring said content is in the correct order;
providing educators with necessary tools;
developing said content, structure, organization, or implementation;
deducing or developing one or more course objectives;
developing an organized, methodical, or propitious manner of executing a learning experience curriculum;
eliminating a barrier, challenge, or stumbling block in the way of an educator facilitating learning, or removing content that is not necessary or does not add value;
implementing said curriculum development phase, in full or in part, within one or more phases of the overall design process of a learning experience curriculum as deemed applicable.

12. The method of claim 2, comprising the steps of devising a curriculum delivery or execution phase within said design process of a learning experience curriculum, further comprising:
including predetermined factors;
building out said topic, wherein said topic can start with the end result in mind;
devising said content, components, layout, or structure of one or more said topics; wherein structure of one or more said topics should have varying content types or delivery modes;
encompassing one or more learning types;
employing a content ratio rule if deemed appropriate;
building the structure of one or more said topics, wherein predetermined factors or elements are a consideration, and wherein one or more said topics that must be addressed can be included, and further wherein said content, components, or layout of the structure should be a factor or element;
adopting or determining a delivery method;
building one or more content areas, wherein one or more content areas include active content or passive content, and wherein one or more content areas can include one or more of content types, content modes, or delivery modes, and further wherein content types, content modes, or delivery modes should be varied;
building one or more content areas, wherein one or more content areas can include chunking or other criteria as deemed appropriate;
resolving which topics should be excluded in a program of study or learning experience curriculum when a topic is too large to undertake during the timeframe of the course session, or is of less importance, or can have a lesser impact;
building one or more content areas within a subject topic methodically or in an organized manner, wherein each subject area can be connected to a previous learning before moving to the next topic or content area;
dividing or separating content that can be comprised of one or more content sections into content components based on applicable considerations;
determining content for exclusion as needed;
building a core content or core concept that must be delivered if necessary;
using a systematic method or organized manner of creating or executing learning variations;
building a learning experience curriculum to have learning resources interspersed within said layered content;
building one or more areas of content or learning resources via a plurality of mechanisms and devices;
ensuring building blocks of learning and knowledge sharing continue within a learning experience curriculum, wherein said topic can independently stand on its own;
building learning mechanisms that can provide a methodical way of executing a learning experience curriculum;
building a foundation or framework upon which a learning experience curriculum or devices can result in a consistent or unified educational product;
returning to earlier developed course content can ensure a learning experience curriculum continues building on a core message;
ensuring said content appears in the correct order is advised;
removing stumbling blocks, barriers, or challenges if found to make that portion of content or information difficult to facilitate learning, wherein devising another way to teach the concept or content removed can resolve the issue or can facilitate learning;
providing educators with the necessary tools to facilitate learning or provide a beneficial learning experience to one or more learners;
building content for learning within a learning experience curriculum that can be utilized post-course in a learner's relevant environment should be an objective or goal;
drafting learning experience curriculum materials, wherein editing said draft occurs thereafter, and wherein during said drafting or editing procedure there can be multiple revisions or edits of said drafts, and further wherein multiple drafts or edits are not mandatory;
ensuring subject matter or content within said curriculum execution phase can be integrated or put into practice;
reviewing a learning experience curriculum, wherein content, even good content, that does not meet one or more intended course objectives or does not add value should be deleted;
reviewing a learning experience curriculum can be done from the mindset of learners, wherein review can lead to changes, adaptations, additions, or deletions;
implementing said curriculum execution phase, in full or in part, within one or more phases of the overall design process of a learning experience curriculum as deemed applicable.

13. The method of claim 2, wherein a course specific curriculum delivery phase for leadership and talent adopts one or more phases within said design process of a learning experience curriculum, further comprising the steps of:
adopting or utilizing appropriate predetermined elements or criteria;
defining course specific considerations, wherein said course specific considerations can be based on one or more course objectives, subject matter to be delivered, design process determinants, efficacy outcome, or other factors as deemed appropriate, and wherein the appropriate efficacy outcome is an outcome resulting from said course specific learning experience curriculum;
building said course specific learning experience curriculum, wherein subject matter upon which course specific considerations will be based is leadership and talent;
building said course specific learning experience curriculum, wherein predetermined criteria can be adopted, and wherein course specific considerations, subject matter, or one or more course objectives can be included;
implementing said course specific said curriculum execution phase, in full or in part, within one or more phases of said design process of a learning experience curriculum as deemed appropriate.

14. The method of claim 2, comprising the steps of building a curriculum creation phase within said design phase of a learning experience curriculum, further comprising:
adopting or utilizing appropriate predetermined criteria;
creating a curriculum creation steps outline, wherein said curriculum creation steps outline can include one or more processes, steps or actions;
including within said curriculum creation steps outline one or more of defining course, educational tool, multimedia tool, agenda, or other learning resource or process as deemed appropriate;
including one or more factors, wherein factors can include identifying knowledge gap hindering performance, determining target audience, selecting appropriate method/process, selecting critical topics that should be addressed to close knowledge gap, defining learning scope, or identifying a course objective unless predetermined criteria is adopted;
creating the educational tool process can include one or more steps or actions;
creating learning objectives for said topic;
defining concepts for said topic;
conducting research or benchmarking to identify existing content that may be available in the market can be beneficial;
determining desired length of course;
adopting or regulating active/passive content ratio if deemed necessary;
outlining chunking of content if necessary;
determining auspicious order or flow of materials;
drafting said content outline;
creating support materials or learning resources;
creating first draft or edit of an educational tool, wherein there can be more than one draft or edit, and wherein more than one draft or edit is not mandatory;
making necessary adjustments to core content as needed, wherein necessary adjustments to core content can include content flow or support materials;
reviewing second draft of educational tool for edits when necessary;
completing final draft of educational tool;
creating a multimedia tool process can involve one or more steps or actions;
selecting or creating said multimedia tool;
completing draft and edit of the first draft;
cross-referencing educational tool and multimedia tool for consistency is advised;
reviewing second draft of multimedia tool for edits as needed;
completing final draft;
drafting course agenda;
calculating estimated delivery time of learning experience curriculum based on finalized content;
making adjustments to content, agenda, or both elements if needed or to fit into time allotted for course if necessary;
finalizing course agenda;
implementing the curriculum creation phase, in whole or in part, within one or more phases of said design process of a learning experience curriculum as deemed appropriate.

15. The method of claim 2, wherein said curriculum creation phase of a participant workbook or educational tool adopts one or more phases within said design process of a learning experience curriculum, comprising the steps of:
adopting, applying, or implementing appropriate one or more phases within said design process of a learning experience curriculum, in whole or in part;
creating a list of potential topics, wherein potential topics should be listed based on priority based on impact, and wherein adopting a predetermined potential topic list is appropriate;
creating learning objectives;
defining concepts or content;
drafting content outline;
creating first draft of participant workbook or educational tool;
editing said first draft of participant workbook or educational tool, wherein drafts and edits continue until the final said educational tool is complete, and wherein additional drafts and edits are not mandatory;
determining or creating support materials for outlined content;
making adjustments to content if necessary, wherein support materials, learning resources, or content flow can be included;
reviewing second draft of participant workbook or educational tool for edits if necessary, wherein additional drafts or edits can occur but are not mandatory;
completing final draft of participant workbook or educational tool;
implementing participant workbook or educational tool within a learning experience curriculum.

16. A process of practical learning within a curriculum for facilitating learning, comprising:
creating practical learning within a curriculum can utilize said layering content as the foundational process;
developing said practical learning to correlate with content of a curriculum, wherein new learning or new skillset can be put to use post-course;
building content and concepts wherein students should be introduced to knowledge and learning content, and wherein one or more learners are facilitated in constructing a personal understanding or comprehension of a curriculum or subject area, and further wherein a learner makes an educated or informed decision;
reinforcing learning or new knowledge through reflection on doing, wherein a student learns with understanding;
supplementing knowledge building with an activity engaging a learner in learning that can be individual;
providing a learner with learning opportunities that can enable the learner to acquire a self-awareness of an issue or deficiency area, wherein a learner can put one's theory as to utilization or implementation of new knowledge into practice in a fail-safe learning environment.
ensuring new experiences or extended learning can take place in a fail-safe learning environment, wherein an educator can provide coaching to facilitate a learner achieving a self-determined goal or make an educated or informed decision;
transferring knowledge highlighting key learnings from said practical learning activity or session as said practical learning activity or session proceeds or sharing knowledge as to said practical learning activity's relevance as it relates to said topic of study or curriculum should occur.

17. The process of claim 16, comprising the steps of adopting or implementing said Learn/Practice/Assess Protocol within said process of practical learning within a curriculum for facilitating learning, further comprising:
adhering to said Learn/Practice/Assess Protocol should occur within a curriculum;
comprising one or more elements of learn, practice, and assess;
applying said Learn/Practice/Assess Protocol can occur between or among varying learning resources;
layering content, teaching, or training within said Learn/Practice/Assess Protocol provides the learn element or factor;
following said learn within said Learn/Practice/Assess Protocol, practice takes place;
concluding a section, topic, chapter, or sufficient piece of information that has employed one or more said learn portions or one or more said practice sessions, a learner should analyze or evaluate comprehension of new learning or appraise one's success in implementing new learning within said assess portion of said Learn/Practice/Assess Protocol;
facilitating one or more learners discovering or devising a self-determined solution based on an educated or informed decision in a fail-safe learning environment;
practicing within said Learn/Practice/Assess Protocol can be practical learning, activity, or other act in which a learner becomes an active participant in one's learning, or a learner is actively completing or doing an act or action;
learning is enhanced when adhering to said Learn/Practice/Assess Protocol, wherein learning of a concept or content builds upon knowledge learned, and wherein students can learn content or information, practice skills or complete an action based on new knowledge before additional information or more complexity is added;
presenting said layered on content within a curriculum should be followed by an activity, active content, or practice, wherein once learners understand or comprehend that portion of content the next piece of said layered content can be presented, and wherein the next piece of said layered content builds upon new knowledge attained in a previous block of said layered content;
building content and concepts wherein students should be introduced to knowledge and learning content, and wherein one or more learners are facilitated in constructing a personal understanding or comprehension of a learning experience curriculum or subject area, and further wherein a learner makes an informed or educated decision;
layering on content should occur during said learn, said practice, and said assess modes, wherein information can proceed to be added once learners understand the concept presented, have practiced it, and comprehend new learning from previous layered content or information;
facilitating learning as layering on content and practice progresses;
layering content continues through said topic, section, chapter, or other segment of content or learning, wherein after each layered content there should be an action in which learners participate to reinforce learning.

18. The process of claim 16, comprising the steps of incorporating a learner's relevant environment or real-life experiences within said process of practical learning within a curriculum for facilitating learning, further comprising:
imparting learning or new knowledge upon which a learner should provide and apply one's own real-world experience, elements, or factors as the basis upon which to evaluate practical learning, lessons, or curriculum, wherein a learner applies real-world practice to formulate one's own learning and takeaways, and wherein a learner puts into practical use applicable learning of one's real-life environment to formulate a real solution to a given issue, concern, or scenario based upon application of said practical learning;
presenting a question, statement, scenario, or other learning technique upon which a learner is instructed to relate content or learning and apply one's relevant environment, real-life situation, or personal experience as the basis or subject of said practical learning;
learning should be based on the curriculum and integrating one or more of a learner's personal real-life experiences, relevant environment, or other appropriate considerations, wherein one or more of a learner's relevant environment, work environment, real issue, personal concern, professional concern, opportunity area a learner faces, employee or individual a learner impacts, person who is in charge of or leads a learner or one or more workers, cohorts, or other applicable person or consideration can be provided as examples of appropriate considerations in facilitating engagement or learning, and wherein a learner's real-life experiences, relevant environment, or considerations should be the scenario upon which new learning is evaluated, or one or more activities, scenarios, simulations, selections, decisions, games, or other learning will be based, and further wherein a learner can relate to new learning, the learning becomes personal to a learner, or an issue a learner personally is experiencing or has experienced can be addressed as a learner progresses through the curriculum to formulate a real solution to a given issue, concern, or scenario based upon application of said practical learning;
encouraging a learner to integrate aspects of one or more considerations, issues, concerns, or real-life experiences into said practical learning activity or session can enhance learning, engagement, or retention.

19. The process of claim 16, comprising the steps of one or more learners actively engaging in personal learning within or via said process of practical learning within a curriculum for facilitating learning, further comprising:
acquiring knowledge should be based on connected facts or skills;
integrating one or more personal real-life environments, experiences, or considerations into said practical learning session, and further wherein a learner will apply applicable learning to one's real-life environment to formulate a real solution to a given issue, concern, scenario, or simulation based upon application of said practical learning;
practicing new learning or skillset;
engaging actively in one's individual learning;
integrating one or more personal considerations, concerns, or issues;
providing one's own scenario in which to evaluate curriculum lessons or learning resources, wherein learning can occur through a series of one or more exercises, simulations, or activities that are based on real people, experiences, or circumstances in one's real-world or experiences or relevant environment, and wherein discovering or developing a resolution based on an informed or educated decision can occur;
putting one's theory as to utilization or implementation of new knowledge into practice;
making determinations or selections in said practical learning activity should be based on new learning received during a curriculum, wherein a person who impacts a learner, an individual a learner impacts, cohorts, or other applicable person is the subject upon which one or more selections, decisions, or determinations will be based, and further wherein subject matter or decisions are based on a real-life situation or said relevant environment applying real-world practice to formulate one's own key learning and takeaways.
practicing a newly acquired skill using real situations that are currently relevant;
participating in a new experience or extended learning within a fail-safe learning environment;
applying applicable learning to one's real-life environment to formulate said real solution to an issue or concern based upon new learning within the curriculum, application of said practical learning activity and a learner providing one's own scenario or actor in an area of activity in order to perform curriculum lessons or learning resources activities;
achieving self-determined goals in a fail-safe learning environment, wherein new learning within a curriculum is applied.

20. The method of claim 16, comprising the steps of developing an apparatus for creating a practical learning card game and method of playing a practical learning card game within said process of practical learning within a learning experience curriculum, further comprising:
containing at least one game card, wherein at least one game card comprises a plurality of individual game cards containing text imprinted thereon;
consisting of a set of game cards per participant containing a plurality of individual game cards, each at least one game card having a back cover and a face side;
branding standard indicia on individual game cards, said back cover either containing an image or not containing an image, such that each of a plurality of individual game cards contains said back cover that is uniform so that a plurality of individual game cards is indistinguishable from other individual game cards by observing the said back cover of at least one game card;
incorporating artwork displaying on course materials on said back cover of a plurality of individual game cards can be appropriate;
adding relevant information on said back cover;
displaying a copyright notice if deemed appropriate on said back cover or said face side of a plurality of individual game cards;
imprinting further information, a course-specific or relevant question, or a statement on said face side of a plurality of individual game cards;
imprinting in text a correlating response to further information, course specific or relevant question, or statement text on said face side of a plurality of individual game cards; wherein a plurality of individual game cards has a unique face side of the cards so that no two face side of cards of a plurality of individual game cards are identical;
ensuring said practical learning game including a plurality of individual game cards is a counterpart or accompaniment to an educational curriculum;
layering content between content and said practical learning card game;
cross-referencing said practical learning card game including a plurality of individual game cards against other curriculum learning resources can ensure a curriculum exhibits a coordinated flow;
making adjustments as needed;
providing a kit for said practical learning card game, comprising a set of said practical learning game cards and packaging material or storage mechanism for storing said practical learning card game components.
providing a flat playing surface;
placing said set of game cards face side down on a flat playing surface for each participant, wherein said set of game cards containing a plurality of individual game cards implemented for one or more players to each play a single player card game;
coordinating said practical learning card game with content or a learning resource within a learning experience curriculum;
predetermining number of sequential rounds comprising a card game;
instructing one or more learners visually, audibly, or a combination thereof as to how to carry out said practical learning card game activity;
ensuring one or more learners comprehend the activity format, wherein educator coaching can occur;
acknowledging a learner should personally decide whether to place game cards face side up or face side down, wherein a learner will decide whether game cards will be held in hand or remain on the flat playing surface;
facilitating one or more learners carrying out said practical learning activity by asking a question or making a statement upon which one or more learners are to respond by utilizing said set of cards, wherein a learner determines the scenario, actor, or players that are subject of each round upon which a learner will base one's evaluation or response by stacking appropriate game cards;
instructing one or more participants to make selections in said practical learning card game activity based on a learner's leader, manager, boss, or other germane source;
facilitating a learner basing selections or determinations on actual real-life people or situations the learner is experiencing or has experienced;
applying real-world practice to formulate one's own key learning and takeaways. relating subject matter or decisions a learner makes based on said relevant environment or real-life situation;
beginning first round with one or more learners concurrently evaluating game playing cards against criteria or scenario as provided by an educator, wherein a learner will select to place the first card in an applicable stack or to discard the first card by placing it aside;
setting aside remaining cards that a learner deems not applicable;
giving one or more learners time to sort through the cards or select or determine their choices;
continuing the round until all cards of a plurality of playing cards have been stacked or played, wherein there is no wrong or incorrect response;
advising one or more learners to make note of the size of the stack of cards or the number of game cards chosen or selected in each round;
being mindful of time allotted for a round or the amount of time a round is taking;
returning game cards into a stack in preparation for the next round;
transferring knowledge highlighting key learnings from said practical learning card game activity as said practical learning card game activity proceeds;
layering content within said practical learning card game;
beginning second or subsequent rounds follow the steps or procedure as transpired in the first round from beginning to transferring knowledge, wherein this procedure should be followed until all subsequent rounds are completed;
providing one or more preferred methods of learning within said practical learning card game;
culminating rounds to form a practical learning summary that is unique for each participant;
tying said practical learning card game to key learning;
sharing knowledge as to said practical learning card game activity's relevance as it relates to said topic of study or learning experience curriculum.
